SEQUENCE LISTING (10 sequences)

SEQ ID NO: 1 - protein, 497 aa, Oryza sativa
MEGVGGGGGGEEWLRPMDAEQLRECGHRMVDFVADYYKSIEAFPVLSQVQPGYLKEVLPDSAPRQPDTLDSLFDDIQQKIIPGVTHWQSPNYFAYYPSNSSTAGFLGEMLSAAFNIVGFSWITSPAATELEVIVLDWFAKMLQLPSQFLSTALGGGVIQGTASEAVLVALLAARDRALKKHGKHSLEKLVVYASDQTHSALQKACQIAGIFSENVRVVIADCNKNYAVAPEAVSEALSIDLSSGLIPFFICATVGTTSSSAVDPLPELGQIAKSNDMWFHIDAAYAGSACICPEYRHHLNGVEEADSFNMNAHKWFLTNFDCSLLWVKDRSFLIQSLSTNPEFLKNKASQANSVVDFKDWQIPLGRRFRSLKLWMVLRLYGVDNLQSYIRKHIHLAEHFEQLLLSDSRFEVVTPRTFSLVCFRLVPPTSDHENGRKLNYDMMDGVNSSGKIFLSHTVLSGKFVLRFAVGAPLTEERHVDAAWKLLRDEATKVLGKMV

SEQ ID NO: 2 - protein, 575 aa, Modestobacter marinus
MTGHMTPEQFRQHGHEVVDWIADYWERIGSFPVRSQVSPGDVRASLPPTAPEQGEPFSAVLADLDRVVLPGVTHWQHPGFFGYFPANTSGPSVLGDLVSAGLGVQGMSWVTSPAATELEQHVMDWFADLLGLPESFRSTGSGGGVVQDSSSGANLVALLAALHRASKGATLRHGVRPEDHTVYVSAETHSSMEKAARIAGLGTDAIRIVEVGPDLAMNPRALAQRLERDVARGYTPVLVCATVGTTSTTAIDPLAELGPICQQHGVWLHVDAAYAGVSAVAPELRALQAGVEWADSYTTDAHKWLLTGFDATLFWVADRAALTGALSILPEYLRNAATDTGAVVDYRDWQIELGRRFRALKLWFVVRWYGAEGLREHVRSHVALAQELAGWADADERFDVAAPHPFSLVCLRPRWAPGIDADVATMTLLDRLNDGGEVFLTHTTVDGAAVLRVAIGAPATTREHVERVWALLGEAHDWLARDFEEQAAERRAAELREREAAEEQLRARREAEAAAAAATEAPVEPAAEEPEQLVVPPVEVPAVETPAAWDESATQVAAQTDLHADPAPQPADGQG

SEQ ID NO: 3 - protein, 481 aa, Streptomyces sviceus
MPDLEPDEFRRQGHQLVDWVARYRTSLPSLHVRPKVVPGSVKAQLPRELPEQPSQALGDDLIALLNDVVVPSSLHWQHPGFFGYFPANASLLSLLGDIASGGIGAQGMLWSTSPAGTEIEQVLLDGLADALGLGREFTFAGGGGGSLQDSASSASLAALLAALQRSNPDWREHGVDGTETVYVTAETHSSLAKAVRVAGLGARALRIVPFTQGTLSMSADALADMLAKDTAAGKRPVMVCPTVGTTGTGAIDPVREVALAARTYEAWVHVDAAWAGVAALCPEFRWLLDGVNLVDSFCTDAHKWFYTAFDASFMWVRDARALPTALSITPEYLRNAATESGEVIDYRDWQVPLGRRMRALKIWSVVHGAGLEGLRESIRGHVAMANSLAGRIESESGFALATPPSLALVCLYLVDQEGRPDDAATKAAMEAVNAEGHSFLTHTSVNGHFAIRVAIGATTTLPDHIDTLWDSLCKAARQSGG

SEQ ID NO: 4 - protein, 470 aa, Pseudomonas putida
MTPEQFRQYGHQLIDLIADYRQTVGERPVMAQVEPGYLKAALPATAPQQGEPFAAILDDVNNLVMPGLSHWQHPDFYGYFPSNGTLSSVLGDFLSTGLGVLGLSWQSSPALSELEETTLDWLRQLLGLSGQWSGVIQDTASTSTLVALISARERATDYALVRGGLQAEPKPLIVYVSAHAHSSVDKAALLAGFGRDNIRLIPTDERYALRPEALQAAIEQDLAAGNQPCAVVATTGTTTTTALDPLRPVGEIAQANGLWLHVDSAMAGSAMILPECRWMWDGIELADSVVVNAHKWLGVAFDCSIYYVRDPQHLIRVMSTNPSYLQSAVDGEVKNLRDWGIPLGRRFRALKLWFMLRSEGVDALQARLRRDLDNAQWLAGQVEAAAEWEVLAPVQLQTLCIRHRPAGLEGEALDAHTKGWAERLNASGAAYVTPATLDGRWMVRVSIGALPTERGDVQRLWARLQDVIKG

SEQ ID NO: 5 - protein, 384 aa, Propionibacterium sp.
MGMDISSRPVEWASLSEITASDVSFEGGAIFNSICTRPHPLAAQVMADNLHLNAGDGRLFPSVARCESEITNFLGGLMGLPRAVGMCTSGATEANLIAVHSAIENWRRKGGQGRPQVILGRGGHFSFDKISVLLGVELVLAWSDIDTLKVDPESVSELISPRTALIVATAGSSETGAVDDVEWLSRVALSKGVPLHVDAASGGLLIPFLRDLGGALPDIGFRNDGVTTIAIDPHKFGSAPIPSGHLVAREWTWIEGLRTESHYQGTARHLTFLGTRSGGSILATYALFGHLGEKGLRGMAEQLKALRSHLVDRLRKAGATLAYVPELMVVALKADSDAVKVLERRGIFTSYAKRLGYLRIVVQLHMSEGQVDGLVDALLMEGIV

SEQ ID NO: 6 - protein, 361 aa, Enterococcus faecium
TKLQNNELKRGWGHIVADGSLANLEGLWYARNIKSLPLAMKEVTPELVAGKSDWELMNLSTEEIMNLLDSVPEKIDEIKAHSARSGKHLEKLGKWLVPQTKHYSWLKAADIIGIGLDQVIPVPVDHNYRMDINELEKIVRGLAAEKTPILGVVGVVGSTEEGAIDGIDKIVALRRVLEKDGIYFYLHVDAAYGGYGRAIFLDEDNNFIPFEDLKDVHYKYNVFTENKDYILEEVHSAYKAIEEAESVTIDPHKMGYVPYSAGGIVIKDIRMRDVISYFATYVFEKGADIPALLGAYILEGSKAGATAASVWAAHHVLPLNVTGYGKLMGASIEGAHRFYNFLKDLSFKVGTKNRSSSITTH

SEQ ID NO: 7 - protein, 363 aa, Methanosphaerula palustris
MLNKGLAEEELFSFLSKKREEDLCHSHILSSMCTVPHPIAVKAHLMFMETNLGDPGLFPGTASLERLLIERLGDLFHHREAGGYATSGGTESNIQALRIAKAQKKVDKPNVVIPETSHFSFKKACDILGIQMKTVPADRSMRTDISEVSDAIDKNTIALVGIAGSTEYGMVDDIGALATIAEEEDLYLHVDAAFGGLVIPFLPNPPAFDFALPGVSSIAVDPHKMGMSTLPAGALLVREPQMLGLLNIDTPYLTVKQEYTLAGTRPGASVAGALAVLDYMGRDGMEAVVAGCMKNTSRLIRGMETLGFPRAVTPDVNVATFITNHPAPKNWVVSQTRRGHMRIICMPHVTADMIEQFLIDIGE

SEQ ID NO: 8 - protein, 432 aa, Petroselinum crispum
EFRRQGHLMIDFLADYYRKVENYPVRSQVSPGYLREILPESAPYNPESLETILQDVQTKIIPGITHWQSPNFFAYFPSSGSTAGFLGEMLSTGFNVVGFNWMVSPAATELENVVTDWFGKMLQLPKSFLFSGGGGGVLQGTTCEAILCTLVAARDKNLRQHGMDNIGKLVVYCSDQTHSALQKAAKIAGIDPKNFRAIETSKSSNFKLCPKRLESAILYDLQNGLIPLYLCATVGTTSSTTVDPLPALTEVAKKYKLWVHVDAAYAGSACICPEFRQYLDGVENADSFSLNAHKWFLTTLDCCCLWVRDPSALIKSLSTYPEFLKNNASETNKVVDYKDWQIMLSRRFRALKLWFVLRSYGVGQLREFIRGHVGMAKYFEGLVGMDNRFEVVAPRLFSMVCFRIKPSAMIGKNDEDEVNEINRKLLESVNDS

SEQ ID NO: 9 - protein, 396 aa, Methanocaldococcus jannaschii
MRNMQEKGVSEKEILEELKKYRSLDLKYEDGNIFGSMCSNVLPITRKIVDIFLETNLGDPGLFKGTKLLEEKAVALLGSLLNNKDAYGHIVSGGTEANLMALRCIKNIWREKRRKGLSKNEHPKIIVPITAHFSFEKGREMMDLEYIYAPIKEDYTIDEKFVKDAVEDYDVDGIIGIAGTTELGTIDNIEELSKIAKENNIYIHVDAAFGGLVIPFLDDKYKKKGVNYKFDFSLGVDSITIDPHKMGHCPIPSGGILFKDIGYKRYLDVDAPYLTETRQATILGTRVGFGGACTYAVLRYLGREGQRKIVNECMENTLYLYKKLKENNFKPVIEPILNIVAIEDEDYKEVCKKLRDRGIYVSVCNCVKALRIVVMPHIKREHIDNFIEILNSIKRD

SEQ ID NO: 10 - protein, 531 aa, Papaver somniferum
MGSLNTEDVLENSSAFGVTNPLDPEEFRRQGHMIIDFLADYYRDVEKYPVRSQVEPGYLRKRLPETAPYNPESIETILQDVTTEIIPGLTHWQSPNYYAYFPSSGSVAGFLGEMLSTGFNVVGFNWMSSPAATELESVVMDWFGKMLNLPESFLFSGSGGGVLQGTSCEAILCTLTAARDRKLNKIGREHIGRLVVYGSDQTHCALQKAAQVAGINPKNFRAIKTFKENSFGLSAATLREVILEDIEAGLIPLFVCPTVGTTSSTAVDPISPICEVAKEYEMWVHVDAAYAGSACICPEFRHFIDGVEEADSFSLNAHKWFFTTLDCCCLWVKDPSALVKALSTNPEYLRNKATESRQVVDYKDWQIALSRRFRSLKLWMVLRSYGVTNLRNFLRSHVKMAKTFEGLICMDGRFEITVPRTFAMVCFRLLPPKTIKVYDNGVHQNGNGVVPLRDENENLVLANKLNQVYLETVNATGSVYMTHAVVGGVYMIRFAVGSTLTEERHVIYAWKILQEHADLILGKFSEADFSS

(19) United States
(12) Patent Application Publication
(10) Pub. No.: US 2021/0256394 A1
(43) Pub. Date: Aug. 19, 2021

(54) METHODS AND SYSTEMS FOR THE OPTIMIZATION OF A BIOSYNTHETIC PATHWAY

(71) Applicant: Zymergen Inc., Emeryville, CA (US)

(72) Inventors: Stepan TYMOSHENKO, Emeryville, CA (US); Oliver LIU, San Francisco, CA (US)

(21) Appl. No.: 17/175,120

(22) Filed: Feb. 12, 2021

Related U.S. Application Data
(60) Provisional application No. 62/977,056, filed on Feb. 14, 2020.

(51) Int. Cl. G06N 3/12; G06N 20/00

(52) U.S. Cl. CPC G06N 3/123; G06N 20/00

(57) ABSTRACT

The present disclosure provides methods and systems for identifying variants of a given target protein or target gene that perform the same function and/or improve the phenotypic performance of a host cell transformed with such a variant. To enhance the diversity of identified candidate sequences, the methods may implement the use of a metagenomic database and/or machine learning methods. The methods and systems may be implemented in optimizing a biosynthetic pathway, e.g., to improve the production of a target molecule of interest.

### CROSS-REFERENCE TO RELATED APPLICATIONS

This application claims the benefit of priority to U.S. Provisional Application No. 62/977,056, filed on Feb. 14, 2020, the contents of which are herein incorporated by reference in their entirety.

### STATEMENT REGARDING FEDERALLY SPONSORED RESEARCH

This invention was made with United States Government support under Agreement No. HR0011-15-9-0014, awarded by DARPA The Government has certain rights in the invention.

### INCORPORATION OF THE SEQUENCE LISTING

The contents of the text file submitted electronically herewith are incorporated herein by reference in their entirety: A computer readable format copy of the Sequence Listing (filename: ZYMR_045_01US_SeqList_ST25.txt, date recorded: Feb. 12, 2021, file size: 38.3 kilobytes).

### FIELD OF THE DISCLOSURE

The present disclosure generally relates to methods for the improvement of genetic engineering. Given a target protein, the disclosed methods may be used for the identification of proteins that perform the same function with improved phenotypic performance and/or genetically dissimilar proteins that perform the same function as the target protein. The methods may employ the use of a metagenomics database. Methods according to the present disclosure may be used to create a new biosynthetic pathway, or to optimize a biosynthetic pathway.

### BACKGROUND

Numerous scientific disciplines rely on bioengineering to manipulate cells to produce desired molecules by, for example, modifying the cell's genome. Such cells may themselves be unicellular organisms (e.g., bacteria) or components of multicellular host organisms, or may be mutated variants of cells found in nature. Existing methods may be used to identify a molecule of interest and a set of reactions leading to its formation. Thereafter, however, the process to engineer a cell to make the desired molecule typically requires altering the metabolism of the host cell by inserting, deleting, or regulating one or more genes that correspond to proteins that perform an enzymatic catalytic function of a given reaction or reactions or that perform other functions relevant to the production of the desired target molecule. Selection of protein sequences (e.g., enzymes) that have the necessary function, or underlying DNA sequences for coding those protein sequences, from the multitude of all their known and predicted variants is often a hard-to-scale, error-prone process. Furthermore, the identification of improved and/or alternative protein variants is limited by existing technologies, such as BLAST, which heavily select for protein variants sharing a high degree of sequence similarity. This selection process in turn selects for protein variants that are more closely genetically related.

There is an ongoing and unmet need for methods that can identify distantly related and/or phenotypically improved variants of a given protein sequence.

### BRIEF SUMMARY

In another aspect, the present disclosure provides a method of identifying distantly related orthologs of a target protein, said method comprising the steps of:

a) accessing a training data set comprising a genetic sequence input variable and a phenotypic performance output variable;

i) wherein the genetic sequence input variable comprises one or more amino acid sequences of proteins capable of performing the same function as the target protein, and

ii) wherein the phenotypic performance output variable comprises one or more phenotypic performance features that are associated with the one or more amino acid sequences;

b) developing a first predictive machine learning model that is populated with the training data set;

c) applying, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model;

d) removing from the pool of candidate sequences any sequence that is predicted to perform a different function than the target protein function by a second predictive machine learning model with a second confidence score if the ratio of the first confidence score to the second confidence score falls beyond a preselected threshold, thereby producing a filtered pool of candidate sequences;

e) clustering the pool of candidate sequences or the filtered pool of candidate sequences after step (d) and selecting a subset of representative candidate sequences comprising one or more candidate sequences from one or more clusters;

f) manufacturing one or more host cells to each express a sequence from amongst the representative candidate sequences from step (e);

g) measuring the phenotypic performance of the manufactured host cell(s) of step (f), and

h) selecting a candidate sequence capable of performing the same function as the target protein, based on the phenotypic performance of the manufactured host cell expressing said candidate sequence, thereby identifying a distantly related ortholog of the target protein.

In another aspect, the present disclosure provides a method of identifying distantly related orthologs of a target protein, said method comprising the steps of:

a) accessing a training data set comprising a genetic sequence input variable and a phenotypic performance output variable;

i) wherein the genetic sequence input variable comprises one or more amino acid sequences of proteins capable of performing the same function as the target protein, and

ii) wherein the phenotypic performance output variable comprises one or more phenotypic performance features that are associated with the one or more amino acid sequences;

b) developing a first predictive machine learning model that is populated with the training data set;

c) applying, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model;

d) removing from the pool of candidate sequences any sequence that is predicted to perform a different function than the target protein function by a second predictive machine learning model with a second confidence score if the ratio of the first confidence score to the second confidence score falls beyond a preselected threshold, thereby producing a filtered pool of candidate sequences;

e) optionally clustering the pool of candidate sequences or the filtered pool of candidate sequences after step (d) and selecting a subset of representative candidate sequences comprising one or more candidate sequences from one or more clusters, thereby identifying distantly related orthologs of the target protein.

In some embodiments, the metagenomic database comprises amino acid sequences from at least one uncultured microorganism.

In some embodiments, step (d) comprises analyzing candidate sequences by a plurality of predictive machine learning models to produce a corresponding plurality of control confidence scores.

In some embodiments, the best score among the control confidence scores is the second confidence score for purposes of calculating the ratio of the first confidence score to the second confidence score.

In some embodiments, the confidence score is a bit score or is the log₁₀(e-value).

In some embodiments, candidate sequences are removed if the ratio of the first confidence score to the second confidence score is less than 0.7, 0.8, or 0.9.

In some embodiments, candidate sequences are removed if they are more likely to perform a different function than the target protein function, as predicted by the second predictive machine learning model.

In some embodiments, the clustering of step (e) is based on sequence similarities between candidate sequences.

In some embodiments, the method further comprises adding to the training data set of step (a):

i) at least one of the candidate sequence(s) that were expressed in the host cell(s) of step (f), and

ii) the phenotypic performance measurement(s) corresponding to the at least one candidate sequence of (i), as measured in step (g), thereby creating an updated training data set.

In some embodiments, the following step occurs before step (h):

repeating steps (a)-(g) with the updated training data set.

In some embodiments, the metagenomic library of step (c), comprises amino acid sequences from at least one organism that is different from the organism from where the target protein was originally obtained.

In some embodiments, the manufacturing of step (f) comprises: replacing an endogenous protein-encoding gene in a host cell, wherein said endogenous protein-coding gene is known to perform the same function as the target protein.

In some embodiments, the endogenous protein-coding gene encodes for the target protein.

In some embodiments, the manufacturing of step (f) comprises manufacturing the cells to comprise at least two sequences from amongst the representative candidate sequences from step (e).

In some embodiments, the distantly related ortholog shares less than 90%, 80%, 70%, 60% 50%, 40%, 30%, or 20% sequence identity with the amino acid sequence of the target protein.

In some embodiments, the manufactured host cell expressing the selected candidate sequence exhibits improved phenotypic performance compared to a control host cell expressing the target protein.

In some embodiments, the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.

In some embodiments, the stress factor is selected from pH, temperature, osmotic pressure, substrate concentration, product concentration, and byproduct concentration.

In some embodiments, the manufactured host cell expressing the selected candidate sequence exhibits at least a 10%, 20%, 30%, 40%, 50%, 60%, 70%, 80%, 90%, or 100% improved phenotypic performance.

In some embodiments, the training data set comprises amino acid sequences of proteins that have either been:

i) empirically shown to perform the same function as the target protein; or

ii) predicted with a high degree of confidence through other mechanisms to perform the same function as the target protein.

In some embodiments, the first predictive machine learning model and/or the second predictive machine learning model is a hidden Markov model (HMM).

In another aspect, the present disclosure provides a method of identifying a candidate amino acid sequence for enabling a desired function in a host cell, said method comprising the steps of:

a) accessing a training data set comprising a genetic sequence input variable and a phenotypic performance output variable;

i) wherein the genetic sequence input variable comprises one or more amino acid sequences of proteins capable of enabling the desired function in at least one organism, and

ii) wherein the phenotypic performance output variable comprises one or more phenotypic performance features that are associated with the one or more amino acid sequences;

b) developing a first predictive machine learning model that is populated with the training data set;

c) applying, using a computer processor, the first predictive machine learning model to a metagenomic library containing amino acid sequences from one or more organisms to identify a pool of candidate sequences within the library, wherein said candidate sequences are predicted with respective first confidence scores to enable the desired function by the first predictive machine learning model;

d) removing from the pool of candidate sequences, any sequence that is predicted to perform a different function than the desired function by a second predictive machine learning model with a second confidence score if the ratio of the first confidence score to the second confidence score falls beyond a preselected threshold, thereby producing a filtered pool of candidate sequences;

e) clustering the pool of candidate sequences or the filtered pool of candidate sequences after step (d) and selecting a subset of representative candidate sequences comprising one or more candidate sequences from one or more clusters;

f) manufacturing one or more host cells to each express a sequence from amongst the representative candidate sequences from step (e);

g) measuring the phenotypic performance of the manufactured host cell(s) of step (f), and

h) selecting a candidate sequence capable of performing the desired function, based on the phenotypic performance of the manufactured host cell expressing said candidate sequence, thereby identifying the candidate amino acid sequence for enabling the desired function.

In another aspect, the present disclosure provides a method of identifying a candidate amino acid sequence for enabling a desired function in a host cell, said method comprising the steps of:

a) accessing a training data set comprising a genetic sequence input variable and a phenotypic performance output variable;

i) wherein the genetic sequence input variable comprises one or more amino acid sequences of proteins capable of enabling the desired function in at least one organism, and

ii) wherein the phenotypic performance output variable comprises one or more phenotypic performance features that are associated with the one or more amino acid sequences;

b) developing a first predictive machine learning model that is populated with the training data set;

c) applying, using a computer processor, the first predictive machine learning model to a metagenomic library containing amino acid sequences from one or more organisms to identify a pool of candidate sequences within the library, wherein said candidate sequences are predicted with respective first confidence scores to enable the desired function by the first predictive machine learning model;

d) removing from the pool of candidate sequences, any sequence that is predicted to perform a different function than the desired function by a second predictive machine learning model with a second confidence score if the ratio of the first confidence score to the second confidence score falls beyond a preselected threshold, thereby producing a filtered pool of candidate sequences;

e) optionally clustering the pool of candidate sequences or the filtered pool of candidate sequences after step (d) and selecting a subset of representative candidate sequences comprising one or more candidate sequences from one or more clusters, thereby identifying the candidate amino acid sequence for enabling a desired function.

In some embodiments, the metagenomic library of step (c), comprises amino acid sequences from at least one uncultured microorganism.

In some embodiments, step (d) comprises analyzing candidate sequences by a plurality of predictive machine learning models to produce a corresponding plurality of control confidence scores.

In some embodiments, the best score among the control confidence scores is the second confidence score for purposes of calculating the ratio of the first confidence score to the second confidence score.

In some embodiments, the confidence score is a bit score or is the log₁₀(e-value).

In some embodiments, candidate sequences are removed if the ratio of the first confidence score to the second confidence score is less than 0.7, 0.8, or 0.9.

In some embodiments, candidate sequences are removed if they are more likely to perform a different function than the target protein function, as predicted by the second predictive machine learning model.

In some embodiments, the clustering of step (e) is based on sequence similarities between candidate sequences.

In some embodiments, the method further comprises adding to the training data set of step (a):

i) at least one of the candidate sequence(s) that were expressed in the host cell(s) of step (f), and

ii) the phenotypic performance measurement(s) corresponding to the at least one candidate sequence of (i), as measured in step (g), thereby creating an updated training data set.

In some embodiments, the following step occurs before step (h): repeating steps (a)-(g) with the updated training data set.

In some embodiments, the metagenomic library of step (c) comprises amino acid sequences from at least one organism that has no sequences derived from it in the training data set.

In some embodiments, the manufacturing of step (f) comprises: replacing an endogenous protein-encoding gene in a host cell, wherein said endogenous protein-coding gene is known to enable the desired function.

In some embodiments, the endogenous protein-coding gene is comprised in the training data set.

In some embodiments, the manufacturing of step (f) comprises manufacturing the cells to express at least two sequences from amongst the representative candidate sequences from step (e).

In some embodiments, the candidate sequence selected in step (h) shares less than 90%, 80%, 70%, 60% 50%, 40%, 30%, or 20% sequence identity with any amino acid sequence in the training data set.

In some embodiments, the manufactured host cell expressing the selected candidate sequence exhibits improved phenotypic performance compared to a control host cell expressing any amino acid sequence from the training data set.

In some embodiments, the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.

In some embodiments, the stress factor is selected from pH, temperature, osmotic pressure, substrate concentration, product concentration, and byproduct concentration.

In some embodiments, the manufactured host cell expressing the selected candidate sequence exhibits at least a 10%, 20%, 30%, 40%, 50%, 60%, 70%, 80%, 90%, or 100% improved phenotypic performance.

In some embodiments, the training data set comprises amino acid sequences of proteins that have either been:

i) empirically shown to enable the desired function as the target protein; or

ii) predicted with a high degree of confidence through other mechanisms to perform the desired function.

In some embodiments, the first predictive machine learning model and/or the second predictive machine learning model is a hidden Markov model (HMM).

In another aspect, the present disclosure provides a system for identifying a candidate amino acid sequence for enabling a desired function in a host cell, the system comprising:

one or more processors; and

one or more memories storing instructions, that when executed by at least one of the one of more processors, cause the system to:

a) access a training data set comprising a genetic sequence input variable and a phenotypic performance output variable;

i) wherein the genetic sequence input variable comprises one or more amino acid sequences of proteins capable of enabling the desired function in at least one organism, and

ii) wherein the phenotypic performance output variable comprises one or more phenotypic performance features that are associated with the one or more amino acid sequences;

b) develop a first predictive machine learning model that is populated with the training data set;

c) apply the first predictive machine learning model to a metagenomic library containing amino acid sequences from one or more organisms to identify a pool of candidate sequences within the library, wherein said candidate sequences are predicted with respective first confidence scores to enable the desired function by the first predictive machine learning model;

d) remove from the pool of candidate sequences, any sequence that is predicted to perform a different function than the desired function by a second predictive machine learning model with a second confidence score if the ratio of the first confidence score to the second confidence score falls beyond a preselected threshold, thereby producing a filtered pool of candidate sequences;

e) cluster the pool of candidate sequences or the filtered pool of candidate sequences after step (d) and selecting a subset of representative candidate sequences comprising one or more candidate sequences from one or more clusters;

f) manufacture one or more host cells to each express a sequence from amongst the representative candidate sequences from step (e);

g) measure the phenotypic performance of the manufactured host cell(s) of step (f), and

h) select a candidate sequence capable of performing the desired function, based on the phenotypic performance of the manufactured host cell expressing said candidate sequence, thereby identifying the candidate amino acid sequence for enabling the desired function.

In some embodiments, the metagenomic library comprises amino acid sequences from at least one uncultured microorganism.

In some embodiments, step (d) comprises analyzing candidate sequences by a plurality of predictive machine learning models to produce a corresponding plurality of control confidence scores.

In some embodiments, the best score among the control confidence scores is the second confidence score for purposes of calculating the ratio of the first confidence score to the second confidence score.

In some embodiments, the confidence score is a bit score or is the log₁₀(e-value).

In some embodiments, candidate sequences are removed if the ratio of the first confidence score to the second confidence score is less than 0.7, 0.8, or 0.9.

In some embodiments, candidate sequences are removed if they are more likely to perform a different function than the target protein function, as predicted by the second predictive machine learning model.

In some embodiments, the clustering of step (e) is based on sequence similarities between candidate sequences.

In some embodiments, the one of more processors, cause the system to further add to the training data set of step (a):

i) at least one of the candidate sequence(s) that were expressed in the host cell(s) of step (f), and

ii) the phenotypic performance measurement(s) corresponding to the at least one candidate sequence of (i), as measured in step (g), thereby creating an updated training data set.

In some embodiments, the one of more processors, cause the system to carry out the following step occurs before step (h): repeat steps (a)-(g) with the updated training data set.

In some embodiments, the metagenomic library of step (c) comprises amino acid sequences from at least one organism that has no sequences derived from it in the training data set.

In some embodiments, the manufacturing of step (f) comprises: replacing an endogenous protein-encoding gene in a host cell, wherein said endogenous protein-coding gene is known to enable the desired function.

In some embodiments, the endogenous protein-coding gene is comprised in the training data set.

In some embodiments, the manufacturing of step (f) comprises manufacturing the cells to express at least two sequences from amongst the representative candidate sequences from step (e).

In some embodiments, the candidate sequence selected in step (h) shares less than 90%, 80%, 70%, 60% 50%, 40%, 30%, or 20% sequence identity with any amino acid sequence in the training data set.

In some embodiments, the manufactured host cell expressing the selected candidate sequence exhibits improved phenotypic performance compared to a control host cell expressing any amino acid sequence from the training data set.

In some embodiments, the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.

In some embodiments, the stress factor is selected from pH, temperature, osmotic pressure, substrate concentration, product concentration, and byproduct concentration.

In some embodiments, the manufactured host cell expressing the selected candidate sequence exhibits at least a 10%, 20%, 30%, 40%, 50%, 60%, 70%, 80%, 90%, or 100% improved phenotypic performance.

In some embodiments, the training data set comprises amino acid sequences of proteins that have either been:

i) empirically shown to enable the desired function as the target protein; or

ii) predicted with a high degree of confidence through other mechanisms to perform the desired function.

In some embodiments, the first predictive machine learning model and/or the second predictive machine learning model is a hidden Markov model (HMM).

In another aspect, the present disclosure provides a system for identifying distantly related orthologs of a target protein, said system comprising:

one or more processors; and

one or more memories storing instructions, that when executed by at least one of the one of more processors, cause the system to:

a) access a training data set comprising a genetic sequence input variable and a phenotypic performance output variable;

i) wherein the genetic sequence input variable comprises one or more amino acid sequences of proteins capable of performing the same function as the target protein, and

ii) wherein the phenotypic performance output variable comprises one or more phenotypic performance features that are associated with the one or more amino acid sequences;

b) develop a first predictive machine learning model that is populated with the training data set;

c) apply, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model;

d) remove from the pool of candidate sequences, any sequence that is predicted to perform a different function than the target protein function by a second predictive machine learning model with a second confidence score if the ratio of the first confidence score to the second confidence score falls beyond a preselected threshold, thereby producing a filtered pool of candidate sequences;

e) cluster the pool of candidate sequences or the filtered pool of candidate sequences after step (d) and selecting a subset of representative candidate sequences comprising one or more candidate sequences from one or more clusters;

f) manufacture one or more host cells to each express a sequence from amongst the representative candidate sequences from step (e);

g) measure the phenotypic performance of the manufactured host cell(s) of step (f), and

h) select a candidate sequence capable of performing the same function as the target protein, based on the phenotypic performance of the manufactured host cell expressing said candidate sequence, thereby identifying a distantly related ortholog of the target protein.

In some embodiments, the metagenomic library comprises amino acid sequences from at least one uncultured microorganism.

In some embodiments, step (d) comprises analyzing candidate sequences by a plurality of predictive machine learning models to produce a corresponding plurality of control confidence scores.

In some embodiments, the best score among the control confidence scores is the second confidence score for purposes of calculating the ratio of the first confidence score to the second confidence score.

In some embodiments, the confidence score is a bit score or is the log₁₀(e-value).

In some embodiments, candidate sequences are removed if the ratio of the first confidence score to the second confidence score is less than 0.7, 0.8, or 0.9.

In some embodiments, candidate sequences are removed if they are more likely to perform a different function than the target protein function, as predicted by the second predictive machine learning model.

In some embodiments, the clustering of step (e) is based on sequence similarities between candidate sequences.

In some embodiments, the one of more processors, cause the system to further add to the training data set of step (a):

i) at least one of the candidate sequence(s) that were expressed in the host cell(s) of step (f), and

ii) the phenotypic performance measurement(s) corresponding to the at least one candidate sequence of (i), as measured in step (g), thereby creating an updated training data set.

In some embodiments, the one of more processors, cause the system to carry out the following step occurs before step (h): repeat steps (a)-(g) with the updated training data set.

In some embodiments, the metagenomic library of step (c) comprises amino acid sequences from at least one organism that is different from the organism from where the target protein was originally obtained.

In some embodiments, the manufacturing of step (f) comprises: replacing an endogenous protein-encoding gene in a host cell, wherein said endogenous protein-coding gene is known to perform the same function as the target protein.

In some embodiments, the endogenous protein-coding gene encodes for the target protein.

In some embodiments, the manufacturing of step (f) comprises manufacturing the cells to express at least two sequences from amongst the representative candidate sequences from step (e).

In some embodiments, the distantly related ortholog shares less than 90%, 80%, 70%, 60% 50%, 40%, 30%, or 20% sequence identity with the amino acid sequence of the target protein.

In some embodiments, the manufactured host cell expressing the selected candidate sequence exhibits improved phenotypic performance compared to a control host cell expressing the target protein.

In some embodiments, the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.

In some embodiments, the stress factor is selected from pH, temperature, osmotic pressure, substrate concentration, product concentration, and byproduct concentration.

In some embodiments, the manufactured host cell expressing the selected candidate sequence exhibits at least a 10%, 20%, 30%, 40%, 50%, 60%, 70%, 80%, 90%, or 100% improved phenotypic performance.

In some embodiments, the training data set comprises amino acid sequences of proteins that have either been:

i) empirically shown to perform the same function as the target protein; or

ii) predicted with a high degree of confidence through other mechanisms to perform the same function as the target protein.

In some embodiments, the first predictive machine learning model and/or the second predictive machine learning model is a hidden Markov model (HMM).

### BRIEF DESCRIPTION OF THE SEVERAL VIEWS OF THE DRAWINGS

FIG. 1 shows a flowchart depicting the steps of an exemplary method for identifying variants of a target protein, as described in Example 1.

FIG. 2 shows a generalized flowchart depicting possible steps of an exemplary method according to the present disclosure.

FIG. 3 shows a bar diagram demonstrating the breakdown of search methods used to select protein variants for each protein target, as described in Example 1.

FIG. 4 provides an illustrative example of the sequence clustering that may be included in a method of the present disclosure.

FIG. 5 shows RFP expression levels produced from insertion of an RFP gene into neutral insertion points in the host strain genome used in Example 1. Positive control (first column) corresponds to known successful insertion and expression of the RFP gene; negative control (last column) corresponds to the unaltered strain not expressing RFP.

FIG. 6 shows the productivity and yield of transformed host cells tested in a high throughput screen. The dotted line encircles the seven lead sequences observed to improve yield to the greatest extent without negatively affecting cell productivity.

FIG. 7 shows the yield of host cells comprising the seven lead sequence variants identified in Example 1.

FIG. 8 shows the yield of cells transformed with the lead sequences across different parental background strains.

FIG. 9 shows a phylogenetic tree demonstrating the sequence diversity of candidate sequences identified using exemplary methods disclosed herein.

FIG. 10 shows a sequence similarity network for the sequences found in a metagenomic database by BLAST and an exemplary machine learning model (in this case HMM) according to the present disclosure. Each circle represents an amino acid sequence found by BLAST (light shading) or the HMM (darker shading and *). Triangular and diamond-shaped nodes represent BLAST-query sequences. The two oversized circle nodes denote the sequences that improved at least one target phenotype. The presence of edges between nodes denotes similarity with the bit-score of at least 310 (estimated by BLAST) that corresponds to ˜50% sequence identity or higher. The BLAST results in light shading are highly similar and found in two groups of similar sequences in the top left of the figure.

FIG. 11A-B illustrate an exemplary system and components thereof for carrying out methods as disclosed herein. FIG. 11A provides an exemplary system of the present disclosure. FIG. 11B illustrates an example of a computer system that may be used to execute instructions stored in a non-transitory computer readable medium (e.g., memory) in accordance with some embodiments of the disclosure.

FIG. 12 is a flow diagram illustrating the operation of some embodiments of the disclosure. Steps 3(a),(b) may be performed either before or after steps 3(c),(d).

FIG. 13A-H illustrate an example of identifying at least one sequence to enable tyrosine decarboxylase activity, according to embodiments of the disclosure. FIG. 13A discloses SEQ ID NOS 1-6, respectively, in order of appearance. FIG. 13B shows an example output file of an alignment of training data set sequences for tyrosine decarboxylase and discloses SEQ ID NOS 7-10, respectively, in order of appearance. FIG. 13C shows a snippet of an output file of a Hidden Markov Model (using the HMMER tool) constructed from the multi-sequence alignment file shown in FIG. 13B, from which a skilled artisan can determine the degree of confidence that an amino acid within the sequence is related to the desired tyrosine decarboxylase activity (function). FIG. 13D shows a pictorial representation of the same statistical model for tyrosine decarboxylase activity, where the height of the each amino acid annotation represents the propensity of that particular amino acid in that position (represented on the x axis) to be related to the desired function of the overall enzyme. FIG. 13E shows a snippet of example output file of sequence hits after comparing the candidate sequences with the HMM model for tyrosine decarboxylase. In this example file, the confidence of a particular enzyme sequence from a database matching to the HMM of tyrosine decarboxylase is enumerated by the E-value metric. FIG. 13F shows an example of the processed table of candidate sequences from the raw output file for FIG. 13E that extracts the identifier of the sequence from the search database and the E-value of the match to the tyrosine decarboxylase HMM model sorted in ascending order of E-value. FIG. 13G (left table) shows a snippet of the raw output file resulting from clustering all HMM sequence hits for tyrosine decarboxylase. FIG. 13G shows the example output files after the sequence clustering step. On the left is the raw output file, while the right table shows the example processed table output of sub-selected sequences where only the sequence with lowest e-value is selected from each cluster, after clustering step 3(a). The table shows the identifiers of those enzymes, the e-value of the sequence matching to the HMM for tyrosine decarboxylase, and the cluster number in which it fell, which is generated by parsing the output file in the left table of the figure. The right table shows the sorted sequences by increasing e-value (i.e., decreasing confidence). FIG. 13H shows a snippet of an example output file of filtering clustered hits against other Hidden Markov Models representing a varied array of reaction activities. The model identifiers represent KEGG orthology groups.

FIG. 14 depicts one embodiment of the automated system of the present disclosure. The present disclosure teaches use of automated robotic systems with various modules capable of cloning, transforming, culturing, screening and/or sequencing host organisms.

FIG. 15 depicts the DNA assembly and transformation steps of one of the embodiments of the present disclosure. The flow chart depicts the steps for building DNA fragments, cloning said DNA fragments into vectors, transforming said vectors into host strains, and looping out selection sequences through counter selection.

### DETAILED DESCRIPTION

The present disclosure provides novel methods for the identification of protein variants of a target protein or variants of a target gene that perform the same function as the target protein or target gene and may improve the phenotypic performance of a host cell.

### Definitions

This disclosure refers to a part, such as a protein, as being “engineered” into a host cell when the genome of the host cell is modified (e.g., via insertion, deletion, replacement of genes, including insertion of a plasmid coded for production of the part) so that the host cell produces the protein (e.g., an enzyme). If, however, the part itself comprises genetic material (e.g. a nucleic acid sequence acting as an enzyme), the “engineering” of that part into the host cell refers to modifying the host genome to embody that part itself

As used herein, the “confidence score” is a measure of the confidence assigned to a classification or classifier. For example, a confidence score may be assigned to the identification of an amino acid sequence as encoding a protein that performs the function of a target protein. Confidence scores include bit scores and e-values, among other. A “bit score” provides the confidence in the accuracy of a prediction. “Bits” refers to information content, and a bit score generally indicates the amount of information in the hit. A higher bit score indicates a better prediction, while a low score indicates lower information content, e.g., a lower complexity match or worse prediction. An “e-value” as used herein refers to a measure of significance assigned to a result, e.g., the identification of a sequence in a database predicted to encode a protein having the same function as a target protein. An e-value generally estimates the likelihood of observing a similar result within the same database. The lower the e-value, the more significant the result is.

A “Hidden Markov Model” or “HMM” as used herein refers to a statistical model in which the system being modeled is assumed to be a Markov process with unobservable (i.e. hidden) states. As applied to amino acid sequences, an HMM provides a way to mathematically represent a family of sequences. It captures the properties that sequences are ordered and that amino acids are more conserved at some positions than others. Once an HMM is constructed for a family of sequences, new sequences can be scored against it to evaluate how well they match and how likely they are to be a member of the family.

As used herein the term “sequence identity” refers to the extent to which two optimally aligned polynucleotides or polypeptide sequences are invariant throughout a window of alignment of residues, e.g. nucleotides or amino acids. An “identity fraction” for aligned segments of a test sequence and a reference sequence is the number of identical residues which are shared by the two aligned sequences divided by the total number of residues in the reference sequence segment, i.e. the entire reference sequence or a smaller defined part of the reference sequence. “Percent identity” is the identity fraction times 100. Comparison of sequences to determine percent identity can be accomplished by a number of well-known methods, including for example by using mathematical algorithms, such as, for example, those in the BLAST suite of sequence analysis programs.

In some embodiments, identity of related polypeptides or nucleic acid sequences can be readily calculated by any of the methods known to one of ordinary skill in the art. The “percent identity” of two sequences (e.g., nucleic acid or amino acid sequences) may, for example, be determined using the algorithm of Karlin and Altschul Proc. Natl. Acad. Sci. USA 87:2264-68, 1990, modified as in Karlin and Altschul Proc. Natl. Acad. Sci. USA 90:5873-77, 1993. Such an algorithm is incorporated into the NBLAST® and XBLAST® programs (version 2.0) of Altschul et al., J. Mol. Biol. 215:403-10, 1990. BLAST® protein searches can be performed, for example, with the XBLAST program, score=50, wordlength=3 to obtain amino acid sequences homologous to the proteins described herein. Where gaps exist between two sequences, Gapped BLAST® can be utilized, for example, as described in Altschul et al., Nucleic Acids Res. 25(17):3389-3402, 1997. When utilizing BLAST® and Gapped BLAST® programs, the default parameters of the respective programs (e.g., XBLAST® and NBLAST®) can be used, or the parameters can be adjusted appropriately as would be understood by one of ordinary skill in the art.

Another local alignment technique which may be used, for example, is based on the Smith-Waterman algorithm (Smith, T. F. & Waterman, M. S. (1981) “Identification of common molecular subsequences.” J. Mol. Biol. 147:195-197). A general global alignment technique which may be used, for example, is the Needleman-Wunsch algorithm (Needleman, S. B. & Wunsch, C. D. (1970) “A general method applicable to the search for similarities in the amino acid sequences of two proteins.” J. Mol. Biol. 48:443-453), which is based on dynamic programming.

More recently, a Fast Optimal Global Sequence Alignment Algorithm (FOGSAA) was developed that purportedly produces global alignment of nucleic acid and amino acid sequences faster than other optimal global alignment methods, including the Needleman-Wunsch algorithm. In some embodiments, the identity of two polypeptides is determined by aligning the two amino acid sequences, calculating the number of identical amino acids, and dividing by the length of one of the amino acid sequences. In some embodiments, the identity of two nucleic acids is determined by aligning the two nucleotide sequences and calculating the number of identical nucleotide and dividing by the length of one of the nucleic acids.

For multiple sequence alignments, computer programs including Clustal Omega® (Sievers et al., Mol Syst Biol. 2011 Oct. 11; 7:539) may be used. Unless noted otherwise, the term “sequence identity” in the claims refers to sequence identity as calculated by Clustal Omega® using default parameters.

As used herein, a residue (such as a nucleic acid residue or an amino acid residue) in sequence “X” is referred to as corresponding to a position or residue (such as a nucleic acid residue or an amino acid residue) “a” in a different sequence “Y” when the residue in sequence “X” is at the counterpart position of “a” in sequence “Y” when sequences X and Y are aligned using amino acid sequence alignment tools known in the art, such as, for example, Clustal Omega or BLAST®.

When percentage of sequence identity is used in reference to proteins it is recognized that residue positions which are not identical often differ by conservative amino acid substitutions, where amino acid residues are substituted for other amino acid residues with similar chemical properties (e.g., charge or hydrophobicity) and therefore do not change the functional properties of the molecule. Sequences which differ by such conservative substitutions are said to have “sequence similarity” or “similarity.” Means for making this adjustment are well-known to those of skill in the art. Typically this involves scoring a conservative substitution as a partial rather than a full mismatch, thereby increasing the percentage sequence identity. Thus, for example, where an identical amino acid is given a score of 1 and a non-conservative substitution is given a score of zero, a conservative substitution is given a score between zero and 1. The scoring of conservative substitutions is calculated, e.g., according to the algorithm of Meyers and Miller, Computer Applic. Biol. Sci., 4:11-17 (1988). Similarity is more sensitive measure of relatedness between sequences than identity; it takes into account not only identical (i.e. 100% conserved) residues but also non-identical yet similar (in size, charge, etc.) residues. % similarity is a little tricky since its exact numerical value depends on parameters such as substitution matrix one uses (e.g. permissive BLOSUM45 vs. stringent BLOSUM90) to estimate it.

The methods and systems of the present disclosure can be used to identify sequences that are homologous to one or more target genes/proteins. As used herein, homologous sequences are sequences (e.g., at least 5%, at least 10%, at least 15%, at least 20%, at least 25%, at least 30%, at least 35%, at least 40%, at least 45%, at least 50%, at least 55%, at least 60%, at least 65%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% percent identity, including all values in between), and (b) carry out the same or similar biological function.

In some embodiments, the present disclosure teaches methods and systems for identifying homolog or ortholog of a target protein or gene. As used herein in the terms “target protein” or “target gene” refers to a starting gene or protein (e.g., nucleic acid or amino acid sequence) for which homologs or orthologs are sought. In some embodiments, the target gene/protein is identified as a target for improvement in an organism. In some embodiments, the target gene/protein represents biosynthetic bottleneck for the production of a desired product. In some embodiments the target gene/protein is incorporated into a training data set for the predictive machine learning models of the present disclosure. In some embodiments, the training data set may include additional sequences that exhibit the same function as the target gene/protein.

As used herein, the term “ortholog” refers to a nucleic acid or protein that is homologous to a target sequence, and from different species. As used herein, the term “distantly related orthologs” refers to an ortholog that: (a) shares less than 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% sequence identity with a target protein/gene (including all ranges and subranges therebetween), while (b) performing the same function as the target protein/gene.

The present disclosure teaches methods and systems for identifying homologs and orthologs of target genes/proteins, wherein said homologs and orthologs perform the same function as the target gene/protein. As used herein, the term “same function” refers to interchangeable genes or proteins, such that the newly identified homolog or ortholog can replace the original target gene/protein while maintaining at least some level of functionality. In some embodiments, an enzyme capable of catalyzing the same reaction as the target enzyme will be considered to perform the same function. In some embodiments, a transcription factor capable of regulating the same gene as the target transcription factor will be considered to perform the same function. In some embodiments, a small RNA capable of complexing with the same (or equivalent) nucleic acid as the target small RNA will be considered to perform the same function.

Performing the “same function” however, does not necessarily require the newly identified homolog or ortholog to perform all of the functions of the target gene/protein, nor does it preclude the newly identified homolog from being able to perform additional functions beyond those of the target gene/protein. Thus, in some embodiments, a newly identified homolog or ortholog may have, for example, a smaller pool of usable reactants, or may produce additional products, when compared to the target enzyme.

Persons having skill in the art will also understand that the term “the same function” may, in some embodiments, also encompass congruent, but not identical functions. For example, in some embodiments, a homolog or ortholog identified though the methods and systems of the present disclosure may perform the same function in one organism, but not be capable of performing the same function in another organism. One illustrative example of this scenario is an ortholog subunit of a multi-subunit enzyme, which is capable of performing the same function when expressed with other compatible subunits of one organism, but not be directly combinable with subunits from different organisms. Such a subunit would still be considered to perform the “same function.” Techniques for determining whether an identified gene/protein performs the same function as the target gene/product are discussed in detail in the present disclosure.

The term “polypeptide” or “protein” or “peptide” is specifically intended to cover naturally occurring proteins, as well as those which are recombinantly or synthetically produced. It should be noted that the term “polypeptide” or “protein” may include naturally occurring modified forms of the proteins, such as glycosylated forms. The terms “polypeptide” or “protein” or “peptide” as used herein are intended to encompass any amino acid sequence and include modified sequences such as glycoproteins.

The term “prediction” is used herein to refer to the likelihood, probability or score that a protein will perform a given function, and also the extent to which, or efficiency with which, it performs that function. Example predictive methods of the present disclosure can be used to identify variants of a target protein that are genetically dissimilar and/or have one or more improved phenotypical features.

The terms “training data”, “training set” or “training data set” refers to a data set for which a classification may be known. In some embodiments, training sets comprise input and output variables and can be used to train the model. The values of the features for a set can form an input vector, e.g., a training vector for a training set. Each element of a training vector (or other input vector) can correspond to a feature that includes one or more variables. For example, an element of a training vector can correspond to a matrix. The value of the label of a set can form a vector that contains strings, numbers, bytecode, or any collection of the aforementioned datatypes in any size, dimension, or combination. In some embodiments, the “training data” is used to develop a machine learning predictive model capable of identifying other sequences likely to exhibit the same function as a target gene/protein. In some embodiments, the training data set includes a genetic sequence input variable with one or more genetic sequences (e.g., nucleotides or amino acids) encoding proteins capable of performing the same function as the target protein. In some embodiments, the training data set can also contain sequences that are labeled as not performing the same function.

In some embodiments, the training data set also includes a “phenotypic performance output variable”. In some embodiments, the “phenotypic output variable” can be binary (e.g., indicating whether an associated sequence exhibits the same function or not). In some embodiments, the phenotypic output variable can indicate a level of certainty about a stated function, such as indicating whether same function has been experimentally validated as positive or negative, or is predicted based on one or more other factors. In some embodiments, the phenotypic output variable is not stored as data but is merely the fact of performing a given function. For example, a training data set may comprises sequences known or predicted to perform a target function. In such embodiments, the genetic input variables are the sequences and the phenotypic performance output variables are the fact of performing the function or being predicted to perform the function. Thus, in some embodiments, inclusion in the list implies a phenotypic performance variable indicating that the sequences perform the same function.

In some embodiments, the phenotypic output variable can also comprise additional information, such additional information about the phenotypic performance associated with particular sequences. In some embodiments, the phenotypic performance output variable comprises information about a gene/protein selected from the group consisting of volumetric productivity, specific productivity, yield or titer, of a product of interest produced by a host cell expressing said gene/protein. In some embodiments the improved host cell property is volumetric productivity. In some embodiments the improved host cell property is specific productivity. In some embodiments the improved host cell property is yield. In some embodiments, the phenotypic performance output variable can comprise information about productivity or increased tolerance to a stress factor. In some embodiments, the stress factor is selected from pH, temperature, osmotic pressure, substrate concentration, product concentration, and byproduct concentration.

As used herein the terms “cellular organism”, “microorganism”, or “microbe” should be taken broadly. These terms are used interchangeably and include, but are not limited to, the two prokaryotic domains, Bacteria and Archaea, as well as certain eukaryotic fungi and protists. In some embodiments, the disclosure refers to the “microorganisms” or “cellular organisms” or “microbes” of lists/tables and figures present in the disclosure. This characterization can refer to not only the identified taxonomic genera of the tables and figures, but also the identified taxonomic species, as well as the various novel and newly identified or designed strains of any organism in said tables or figures. The same characterization holds true for the recitation of these terms in other parts of the Specification, such as in the Examples.

In some embodiments, the present disclosure discloses a metagenomic database comprising the genetic sequence of at least one uncultured microbe or microorganism. As used herein, the term “uncultured microbe” “uncultured cell” or “uncultured organism” refers to a cell that has not been adapted to grow in the laboratory. In some embodiments the uncultured microbes/cells/organism has not been previously sequenced, or the genomic sequence is not publicly available.

The term “prokaryotes” is art recognized and refers to cells which contain no nucleus or other cell organelles. The prokaryotes are generally classified in one of two domains, the Bacteria and the Archaea. The definitive difference between organisms of the Archaea and Bacteria domains is based on fundamental differences in the nucleotide base sequence in the 16S ribosomal RNA.

The term “Archaea” refers to a categorization of organisms of the division Mendosicutes, typically found in unusual environments and distinguished from the rest of the prokaryotes by several criteria, including the number of ribosomal proteins and the lack of muramic acid in cell walls. On the basis of ssrRNA analysis, the Archaea consist of two phylogenetically-distinct groups: Crenarchaeota and Euryarchaeota. On the basis of their physiology, the Archaea can be organized into three types: methanogens (prokaryotes that produce methane); extreme halophiles (prokaryotes that live at very high concentrations of salt (NaCl); and extreme (hyper) thermophilus (prokaryotes that live at very high temperatures). Besides the unifying archaeal features that distinguish them from Bacteria (i.e., no murein in cell wall, ester-linked membrane lipids, etc.), these prokaryotes exhibit unique structural or biochemical attributes which adapt them to their particular habitats. The Crenarchaeota consists mainly of hyperthermophilic sulfur-dependent prokaryotes and the Euryarchaeota contains the methanogens and extreme halophiles.

“Bacteria” or “eubacteria” refers to a domain of prokaryotic organisms. Bacteria include at least 11 distinct groups as follows: (1) Gram-positive (gram+) bacteria, of which there are two major subdivisions: (1) high G+C group (Actinomycetes, Mycobacteria, Micrococcus, others) (2) low G+C group (Bacillus, Clostridia, Lactobacillus, Staphylococci, Streptococci, Mycoplasmas); (2) Proteobacteria, e.g., Purple photosynthetic and non-photosynthetic Gram-negative bacteria (includes most “common” Gram-negative bacteria); (3) Cyanobacteria, e.g., oxygenic phototrophs; (4) Spirochetes and related species; (5) Planctomyces; (6) Bacteroides, Flavobacteria; (7) Chlamydia; (8) Green sulfur bacteria; (9) Green non-sulfur bacteria (also anaerobic phototrophs); (10) Radioresistant micrococci and relatives; (11) Thermotoga and Thermosipho thermophiles.

A “eukaryote” is any organism whose cells contain a nucleus and other organelles enclosed within membranes. Eukaryotes belong to the taxon Eukarya or Eukaryota. The defining feature that sets eukaryotic cells apart from prokaryotic cells (the aforementioned Bacteria and Archaea) is that they have membrane-bound organelles, especially the nucleus, which contains the genetic material, and is enclosed by the nuclear envelope.

The terms “genetically modified host cell,” “recombinant host cell,” and “recombinant strain” are used interchangeably herein and refer to host cells that have been genetically modified by the cloning and transformation methods of the present disclosure. Thus, the terms include a host cell (e.g., bacteria, yeast cell, fungal cell, CHO, human cell, etc.) that has been genetically altered, modified, or engineered, such that it exhibits an altered, modified, or different genotype and/or phenotype (e.g., when the genetic modification affects coding nucleic acid sequences of the microorganism), as compared to the naturally-occurring organism from which it was derived. It is understood that in some embodiments, the terms refer not only to the particular recombinant host cell in question, but also to the progeny or potential progeny of such a host cell

The term “wild-type microorganism” or “wild-type host cell” describes a cell that occurs in nature, i.e. a cell that has not been genetically modified.

The term “genetically engineered” may refer to any manipulation of a host cell's genome (e.g. by insertion, deletion, mutation, or replacement of nucleic acids).

The term “control” or “control host cell” refers to an appropriate comparator host cell for determining the effect of a genetic modification or experimental treatment. In some embodiments, the control host cell is a wild type cell. In other embodiments, a control host cell is genetically identical to the genetically modified host cell, save for the genetic modification(s) differentiating the treatment host cell. In some embodiments, the present disclosure teaches the use of parent strains as control host cells (e.g., the S₁ strain that was used as the basis for the strain improvement program). In other embodiments, a host cell may be a genetically identical cell that lacks a specific promoter or SNP being tested in the treatment host cell.

The term “yield” is defined as the amount of product obtained per unit weight of raw material and may be expressed as g product per g substrate (g/g). Yield may be expressed as a percentage of the theoretical yield. “Theoretical yield” is defined as the maximum amount of product that can be generated per a given amount of substrate as dictated by the stoichiometry of the metabolic pathway used to make the product.

The term “titre” or “titer” is defined as the strength of a solution or the concentration of a substance in solution. For example, the titre of a product of interest (e.g. small molecule, peptide, synthetic compound, fuel, alcohol, etc.) in a fermentation broth is described as g of product of interest in solution per liter of fermentation broth (g/L).

### Methods for Identifying Protein & Gene Variants

Provided herein are descriptions of various models, techniques, and tools that may be used to perform the disclosed methods and in the implementation of the disclosed systems. The following descriptions are intended to illustrate, but not limit, the methods and systems of the present disclosure.

### Selection of Target Protein or Target Gene

The present methods and systems may be used to improve or otherwise alter the production of a target molecule of interest by a host cell. In some embodiments, the methods and systems identify target proteins or genes that enable a desired function in a host cell. The methods and systems may do so by identifying variants of a target protein or target gene involved, directly or indirectly, in the synthesis of the target molecule of interest. In some embodiments, the target protein or gene may be any protein that affects the production of the molecule of interest.

In some embodiments, the target protein or target gene is directly involved in the synthesis of the target molecule or otherwise directly responsible for enabling the desired function. In some embodiments, the target protein is an enzyme and the target gene is the DNA or RNA sequence encoding for said enzyme. For the purposes of this disclosure, any reference to a target protein also includes within its scope a target gene that performs a function relevant to the production of the molecule of interest. In some embodiments, the target protein is an enzyme that catalyzes a reaction producing an intermediate in the target molecule reaction pathway. In some embodiments, the target protein is an enzyme that catalyzes a reaction producing the target molecule. In some embodiments, the target protein encodes for a protein that imparts host cells with improved resistance to pests, or environmental factors.

In some embodiments, the target protein or target gene is indirectly involved in the synthesis of the target molecule. In some embodiments, the target protein or target gene performs a function that allows for the improved production of the target molecule. In some embodiments, the target protein is a membrane protein, such as a pump or channel. In some embodiments, the target protein is a structural protein. In some embodiments, the target protein is involved in energy production. In some embodiments, the target protein/gene is involved in metabolism. In some embodiments, the target protein is a digestive enzyme. In some embodiments, the target protein is a signaling protein. In some embodiments, the target protein is involved in storage. In some embodiments, the target protein is involved in transport. In some embodiments, the target protein is involved in providing an essential metabolite for the production of the molecule of interest. In some embodiments, the target protein is involved in disposal of undesirable or toxic byproducts produced during production of the target molecule. In some embodiments, the target protein is a regulatory factor controlling production of the desired metabolite or the regulation of the desired functions (e.g., resistance, biomass production, etc.).

In some embodiments, the target genes are untranslated genes, such as a gene encoding a functional RNA sequence. In some embodiments, a target gene encodes a tRNA, rRNA, or small RNA. In some embodiments, target genes include, but are not limited to, deoxyribonucleic acids (DNAs), ribonucleic acids (RNAs), artificially modified nucleic acids, combinations or modifications thereof. In some embodiments, target genes include nucleic acid aptamers, aptazymes, ribozymes, deoxyribozymes, nucleic acid probes, small interfering RNAs (siRNAs), micro RNAs (miRNAs), short hairpin RNAs (shRNAs), antisense nucleic acids, aptamer inhibitors, precursors of any of the above and/or combinations or modifications thereof. Target genes may also include binding regions, such as transcriptional and translational regulation regions, regulatory elements, introns, pseudogenes, repeat sequences, transposons, viral elements, and telomeres. In some embodiments, target genes may be selected from operators, enhancers, silencers, promoters, and insulators.

The target protein or target gene may be selected based upon the reactions, reaction pathways, and other reaction data associated with the production of the target molecule of interest. In some embodiments, after selection of the target molecule of interest, a reaction database may be used to identify proteins involved in the production of the molecule. The target protein or target gene may be any protein or gene associated with the production of the target molecule of interest, whether directly or indirectly. In some embodiments, the target protein or target gene may be identified as a potential bottleneck, e.g., involved in the production of an intermediate, or in providing a necessary resource, in a rate-limiting fashion. In some embodiments, the target protein or target gene may be identified based on empirical evidence, e.g., data showing the relative rate of production of reaction intermediates. In some embodiments, the target protein or target gene may be identified based on knowledge in the art, e.g., knowledge of the common rate-limiting steps or potential bottlenecks in the production of a given target molecule.

In some embodiments, the target protein is selected from a starting reaction set specifying reactions that lead to the formation of the molecule of interest. The reaction set may comprise one or more reactions that are indicated in at least one database as catalyzed by one or more corresponding catalysts, e.g., enzymes. The reaction set may comprise one or more reactions that are indicated in at least one database as facilitated by the function of a protein, e.g., a membrane protein. In some embodiments, the proteins identified in the reaction set may be proteins available for introduction into a host cell. In some embodiments, a target protein or target gene may be introduced into the host either by engineering the target protein into the host (e.g., by modifying the host genome, adding a plasmid) or via uptake of the target protein or target gene from the growth medium in which the host is grown. The present disclosure refers to a part, such as a target protein or target gene, as being “engineered” into a host cell when the genome of the host cell is modified (e.g., via insertion, deletion, replacement of genes, including insertion of a plasmid coded for production of the part) so that the host cell produces the target protein (e.g., an enzyme protein, membrane protein, transport protein, etc.) or target gene (e.g., DNA, RNA, etc.). If, however, the part itself comprises genetic material (e.g. a nucleic acid sequence acting as an enzyme), the “engineering” of that part into the host cell refers to modifying the host genome to embody that part itself.

If there is evidence that at least one amino acid sequence is known for a target protein (e.g., found in one of the databases described herein or found in a metagenomic database) to perform a specific function in any host, then skilled artisans would be able to derive the corresponding genetic sequence used to code the amino acid sequence, and modify the host genome accordingly. Similarly, knowledge of the nucleic acid sequence of a gene can lead to the corresponding amino acid sequence of the translated protein through application of known codon tables. Thus, in some embodiments, the target protein sequence may be represented as a protein amino acid sequence or genetically as DNA or RNA, and may be native or heterologous. A target gene may be represented as a DNA or RNA sequence, depending on its particular role.

### Databases for Use in the Methods and Systems of the Present Disclosure

The present methods involve the use of a sequence database and/or additional databases in order to search for variants of a target protein or target gene that perform the same function as the target protein or target gene. As used herein, any reference to sequences is understood to refer to either nucleic acid or amino acid sequences, unless particularly specified, or otherwise obvious from the context. As understood by a person of skill in the art, a nucleic acid sequence may be translated into an amino acid sequence and an amino acid sequence may be used to generate possible nucleic acid sequences encoding such.

In some embodiments, the present disclosure teaches using various databases to identify target genes and proteins for improvement/modification. In some embodiments, sequence databases can also be searched for protein/gene variants using the machine learning models of the present disclosure. In some embodiments, the databases of the present disclosure are used to identify other genes/proteins known to play the same function as the target gene or known to enable a desired function, for use in the training data sets and models of the present disclosure.

In some embodiments, the methods and systems make use of sequence, reaction, and/or molecular databases. The databases may include public databases such as UniProt, PDB, Brenda, BKMR, and MNXref, as well as custom databases, e.g., databases including molecules and reactions generated via synthetic biology experiments.

In some embodiments, the method employs a sequence database. Numerous expansive gene, DNA, RNA, and protein sequence databases are available for use in the methods and systems of the present disclosure. See, e.g., Baxevanis & Bateman, Curr Protoc Bioinform 2015; 50:1.1.1-1.1.8, incorporated by reference herein in its entirety. Exemplary databases include GenBank, the annotated database of all publicly available DNA and protein sequences, maintained by the NCBI. UniProt and its associated tools, such as UniProtKB, Swiss-Prot, TrEMBL, UniParc, UniRef, and UniMes may be employed in the present methods and systems. Specific databases are also available for particular organisms, such as the Mouse Genome Informatics (MGI) website, WormBase, The Arabidopsis Information Resource (TAIR), the Rat Genome Database (RGD), ZFIN, the Saccharomyces Genome Database (SGD), and the DCFI Gene Index Databases. Also available for use in the present methods and systems are the Online Mendelian Inheritance in Man (OMIM) database, the Human Gene Mutation Database (HGMD), EMBL, DBJ, dbSNP, the MalaCards resource, the Mitomap resource, the Mitomaster resource, ChemAbstracts, InterPro, Pfam, SMART, PROSITE, Propom, PRINTS, TIGRFAMs, PIR-SuperFamily and SUPERFAMILY. Other information resources may also be employed in the present methods and systems, such as Entrez, the Protein Data Bank, MetaCyc, iHOP, MEROPS and Proteinpedia. In some embodiments, the methods and systems may make use of the Kyoto Encyclopedia of Genes and Genomes (KEGG). In some embodiments, the method makes use of and/or the server employed by the system is coupled to an orthology database, such as the KEGG orthology database. The database(s), e.g., UniProt, may also include data on whether a molecule may be introduced into a host cell via uptake of the molecule from a growth medium in which the host is grown.

### Metagenomic Libraries (Databases)

In some embodiments the present disclosure teaches applying machine learning models to identify target protein and gene variants or to enable desired functions. In some embodiments, the sequence database for use in the present methods and systems is a metagenomic library (database). As used herein, the terms metagenomic database and metagenomic library are used interchangeably. In some embodiments, the metagenomic library is a digital metagenomic library. For the purposes of this disclosure, a metagenomic library is defined in the following ways:

1) A physical or digital sequence library that comprises the genomes of uncultured species (e.g., a library derived from environmental samples without an intervening culturing step). In some embodiments, the uncultured species are from yeast, fungus, bacterium, archae, protist, virus, parasite or algae species. The uncultured species may be obtained from any source, e.g., soil, gut, aquatic habitat. In some embodiments, a library is considered a metagenomics library if a majority of the sequences within the assembled library are from uncultured organisms, and if the library meets other size limitations. In some embodiments, the physical and/or digital sequence library of the present disclosure is representative of the environmental sample from which it was extracted, and is not an agglomeration of existing small (e.g., less than 100 organism) assemblies. Any exogenously added/spiked sequence beyond that sourced from the environmental sample may be considered outside of the library of the present disclosure.

2) A physical or digital sequence library that meets the definition of point 1 above, and further wherein a majority of the sequences within the library are from uncultured organisms. In some embodiments, a digital metagenomics library is considered to contain a majority of sequences from uncultured organisms if it is produced by sequencing physical libraries where a majority of the organisms in the library are uncultured. In some embodiments, a digital metagenomics library is considered to contain a majority of sequences from uncultured organisms if it is produced by sequencing physical libraries where none of the organisms were cultured prior to sequencing. In some embodiments, a library is considered a metagenomics library if substantially all of the sequences within the assembled library are from uncultured organisms, and if the library meets other size limitations. As used in this context, the term “substantially all” refers to a library wherein at least 90% of the assembled sequences are from uncultured organisms

3) A physical or digital sequence library that meets the definition of points 1 and/or 2 above, and further comprises more than one uncultured species' genome. In some embodiments the metagenomic library comprises the genomes of at least 100, 500, 1000, 10⁴, 10⁵, 10⁶, 10⁷ or more uncultured species. In some embodiments, the number of assembled genomes in a digital metagenomics library (“DML”) is calculated by dividing the total assembled sequence in the DML and dividing it by the average size of genomes of the kind of organisms expected to be present in the genome. In some embodiments, the number of assembled genomes in a digital metagenomics library is assessed by counting the number of unique 16s rRNA sequences in the DML. In some embodiments, the number of assembled genomes in a digital metagenomics library is assessed by counting the number of unique Internal transcribed spacers (ITS) in the DML.

4) A digital sequence library that meets the definition of one or more of points 1-3 above, and wherein the digital metagenomics library is at least about 50 Mb, 60 Mb, 70 Mb, 80 Mb, 90 Mb, 100 Mb, 110 Mb, 120 Mb, 130 Mb, 140 Mb, 150 Mb, 160 Mb, 170 Mb, 180 Mb, 190 Mb, 200 Mb, 210 Mb, 220 Mb, 230 Mb, 240 Mb, 250 Mb, 260 Mb, 270 Mb, 280 Mb, 290 Mb, 300 Mb, 310 Mb, 320 Mb, 330 Mb, 340 Mb, 350 Mb, 360 Mb, 370 Mb, 380 Mb, 390 Mb, 400 Mb, 410 Mb, 420 Mb, 430 Mb, 440 Mb, 450 Mb, 460 Mb, 470 Mb, 480 Mb, 490 Mb, 500 Mb, 550 Mb, 600 Mb, 650 Mb, 700 Mb, 750 Mb, 800 Mb, 850 Mb, 900 Mb, 950 Mb, 1000 Mb, 1050 Mb, 1100 Mb, 1150 Mb, 1200 Mb, 1250 Mb, 1300 Mb, 1350 Mb, or 1400 Mb in size. Assembled sequence is the additive lengths of all contigs in the DML.

Due to their universal distribution, including in the most extreme environments, microorganisms are known for being able to perform unique enzymatic functions and/or protein function in unique fashions, and in conditions compatible with commercial industrial processes. However, the promising approach of exploiting these microbial functions has historically been limited by the technological obstacles of isolation and in vitro culture of diverse microbial species. Most microorganisms developing in complex natural environments (soils and sediments, aquatic environments, digestive systems) have not been cultivated because their optimal culturing conditions are unknown or too difficult to reproduce. Numerous scientific works demonstrate that only between 0.1 and 1% of bacterial diversity, for example, has been isolated and cultivated (Amann et al., Microb. Rev. 1995; 59:143-169). Even though existing searches for novel biocatalytic pathways within collections of microbial strains have proven to be effective under certain circumstances, such studies nevertheless have the disadvantage of only exploiting a small part of the possible spectrum of microbial biodiversity.

New approaches have been developed in order to overcome the limitations of in vitro culture of novel microbial species. Metagenomics involves the direct extraction of DNA from environmental samples. Metagenomics has been used, e.g., for identifying new bacterial phyla (Pace, Science, 1997; 276:734-740). Metagenomic approaches may be based upon the specific cloning of genes recognized for their phylogenetic interest, such as for example 16S rRNA. Other developments have been implemented in order to identify new enzymes of environmental or industrial interest (U.S. Pat. No. 6,441,148, incorporated by reference herein). In such approaches, the development of a metagenomic database may start with a selection of the desired genes. This selection may be made by a PCR approach, generally before the cloning step. In some embodiments, the metagenome may be used as a whole, without selection of specific desired genes. Thus, no selection and no identification is made before the genome of the uncultured species is added to the metagenomic sequence database. This approach gives access to the whole genetic potential of the microbial community being explored. Metagenomic databases have been made from both soil and marine environments (reviewed in Daniel, Nature Rev 2005; 3:470-478; DeLong, Nature Rev 2005; 3:459-469, each incorporated by reference herein in its entirety). In addition, Venter and colleagues reported the first example of the use of the “whole-genome shotgun sequencing” approach to marine microbial populations collected from the Sargasso Sea (Venter et al, Science 2004; 304:66-74).

Metagenomic databases can be analyzed for novel genes and pathways with sequence-based techniques or through activity screening involving analyses of expression of novel phenotypic traits in surrogate hosts. In the methods and systems of the present disclosure, a metagenomic database may be mined for novel protein sequences, molecular systems, natural product clusters, or enzymes. The present methods and systems thereby provide access to previously inaccessible diversity, allowing for the investigation and use of the 95-99% of biodiversity that cannot be cultured.

In some embodiments, metagenomic libraries involves the direct extraction of DNA from environmental samples. Another advantage of metagenomic libraries is that they can be enriched for organisms that are more likely to comprise genes capable of imparting host cells with the desired phenotype. For example, genes related to osmotic (salt) tolerance may be enriched in metagenomic databases produced from microbial samples gathered from osmotic stress conditions, such as high salinity soil. Genes associated with nitrogen fixation may be enriched in metagenomic databases produced from microbial samples gathered from adjacent soil or tissue of roots of selected plants. Thus, the methods and systems of the present disclosure benefit from the wide diversity of sequences available through metagenomic databases, and from the potential for enriching such databases for the desired end use.

Microorganisms play an essential role in the function of ecosystems and are well represented quantitatively. Environmental samples, such as soil samples, food samples, or biological tissue samples can contain extremely large numbers of organisms and, consequently, generate a large set of genomic data. For example, it is estimated that the human body, which relies upon bacteria for modulation of digestive, endocrine, and immune functions, can contain up to 100 trillion organisms. In addition, it is estimated that one gram of soil can contain between 1,000 and 10,000 different species of bacteria with between 10⁷ and 10⁹ cells, including cultivatable and non-cultivatable bacteria. Reproducing this whole diversity in metagenomic DNA libraries requires the ability to generate and manage a large number of clones. In some embodiments, the metagenomic database may comprise at least one, several dozen, hundreds of thousands, or even several million recombinant clones which differ from one another by the DNA which they have incorporated. In some embodiments, the metagenomic library may be constructed from metagenomic fragments and/or assembled into contigs, as described in U.S. Pat. Nos 8,478,544, 10,227,585, and 9,372,959, each incorporated by reference in its entirety herein. In some embodiments, the metagenomic sequences may be assembled into whole genomes. In some embodiments, the metagenomic library may be optimized to comprise an average size of the cloned metagenomic inserts to facilitate the search for microbial biosynthesis pathways, because these pathways are often organized in clusters in the microorganism's genome. The larger the cloned fragments of DNA (larger than 30 Kb), the more the number of clones to be analyzed is limited and the greater the possibility of reproducing complete metabolic pathways. Given a large number of recombinant clones to be studied, high density hybridization systems (high density membranes or DNA chips) may be employed, such as for the characterization of bacterial communities (for a review, see Zhou et al., Curr. Opin. Microbial. 2003; 6:288-294, incorporated herein by reference).

Relevant to the construction of a metagenomic database is the quantification of different functional genes (Cho et al., 2003), the study of functional genes and their diversity (Wu et al., 2001, Appl. Environ. Microbiol., 67: 5780-5790), the direct detection of 16S rRNA genes (Small et al., 2001), and the use of metagenomics in combination with DNA chips (Sebat et al., 2003, Appl. Environ. Microbiol., 69: 4927-4934) for the identification of clones containing DNA from non-cultivatable microorganisms and their selection for additional analysis. Metagenomic studies have related, for example, to the direct detection of chitinase (Cottrell et al., 1999, Appl. Environ. Microbiol., 65: 2553-2557), lipase (Henne et al., 2000, Appl. Environ. Microbiol., 66: 3113-3116), DNA, and amylase (Rondon et al., 2000, Appl. Environ. Microbiol., 66: 2541-2547) activity.

In some embodiments, the present disclosure teaches whole-genome sequencing of the organisms described herein. For example, in some embodiments, the present disclosure teaches how to create metagenomic libraries for analysis by predictive machine learning models. In other embodiments, the present disclosure also teaches sequencing of plasmids, PCR products, and other oligos as quality controls to the methods of the present disclosure. Sequencing methods for large and small projects are well known to those in the art.

In some embodiments, any high-throughput technique for sequencing nucleic acids can be used in the methods of the disclosure. In some embodiments, the present disclosure teaches whole genome sequencing. In other embodiments, the present disclosure teaches amplicon sequencing ultra-deep sequencing to identify genetic variations. In some embodiments, the present disclosure also teaches novel methods for library preparation, including tagmentation (see WO/2016/073690). DNA sequencing techniques include classic dideoxy sequencing reactions (Sanger method) using labeled terminators or primers and gel separation in slab or capillary; sequencing by synthesis using reversibly terminated labeled nucleotides, pyrosequencing; 454 sequencing; allele specific hybridization to a library of labeled oligonucleotide probes; sequencing by synthesis using allele specific hybridization to a library of labeled clones that is followed by ligation; real time monitoring of the incorporation of labeled nucleotides during a polymerization step; polony sequencing; and SOLiD sequencing.

In one aspect of the disclosure, high-throughput methods of sequencing are employed that comprise a step of spatially isolating individual molecules on a solid surface where they are sequenced in parallel. Such solid surfaces may include nonporous surfaces (such as in Solexa sequencing, e.g. Bentley et al, Nature, 456: 53-59 (2008) or Complete Genomics sequencing, e.g. Drmanac et al, Science, 327: 78-81 (2010)), arrays of wells, which may include bead- or particle-bound templates (such as with 454, e.g. Margulies et al, Nature, 437: 376-380 (2005) or Ion Torrent sequencing, U.S. patent publication 2010/0137143 or 2010/0304982), micromachined membranes (such as with SMRT sequencing, e.g. Eid et al, Science, 323: 133-138 (2009)), or bead arrays (as with SOLiD sequencing or polony sequencing, e.g. Kim et al, Science, 316: 1481-1414 (2007)).

In another embodiment, the methods of the present disclosure comprise amplifying the isolated molecules either before or after they are spatially isolated on a solid surface. Prior amplification may comprise emulsion-based amplification, such as emulsion PCR, or rolling circle amplification. Also taught is Solexa-based sequencing where individual template molecules are spatially isolated on a solid surface, after which they are amplified in parallel by bridge PCR to form separate clonal populations, or clusters, and then sequenced, as described in Bentley et al (cited above) and in manufacturer's instructions (e.g. TruSeq™ Sample Preparation Kit and Data Sheet, Illumina, Inc., San Diego, Calif, 2010); and further in the following references: U.S. Pat. Nos. 6,090,592; 6,300,070; 7,115,400; and EP0972081B1; which are incorporated by reference.

In one embodiment, individual molecules disposed and amplified on a solid surface form clusters in a density of at least 10⁵ clusters per cm²; or in a density of at least 5×10⁵ per cm²; or in a density of at least 10⁶ clusters per cm². In one embodiment, sequencing chemistries are employed having relatively high error rates. In such embodiments, the average quality scores produced by such chemistries are monotonically declining functions of sequence read lengths. In one embodiment, such decline corresponds to 0.5 percent of sequence reads have at least one error in positions 1-75; 1 percent of sequence reads have at least one error in positions 76-100; and 2 percent of sequence reads have at least one error in positions 101-125.

Persons having skill in the art will be aware of the relationship between DNA, RNA, and protein sequences, and will thus be able to readily convert DNA sequence data to create metagenomic libraries with RNA or protein information. In some embodiments, the metagenomic libraries of the present disclosure comprise DNA sequences obtained from cellular populations. Thus, in some embodiments, metagenomic libraries comprise information obtained from direct DNA sequencing. In some embodiments, the metagenomic libraries comprise transcribed RNAs that are either directly measured, or predicted based on DNA sequence. Thus, in some embodiments metagenomic libraries can be searched for siRNAs, miRNAs, rRNAs, and aptamers. In some embodiments, metagenomic libraries comprise amino acid protein sequence data, either measured, or predicted based on measured DNA sequences. For example, metagenomic libraries may comprise a list of predicted or validated protein sequences that are accessible to the machine learning models described in the present disclosure.

### Methods of Producing Metagenomics Libraries—Library Prep and Sequencing

In some embodiments, the genetic information in the metagenomic library is prepared for sequencing. Numerous kits for making sequencing libraries from DNA are available commercially from a variety of vendors. Kits are available for making libraries from microgram down to picogram quantities of starting material. Higher quantities of starting material however require less amplification and can thus better library complexity.

With the exception of Illumina's Nextera prep, library preparation generally entails: (i) fragmentation, (ii) end-repair, (iii) phosphorylation of the 5′ prime ends, (iv) A-tailing of the 3′ ends to facilitate ligation to sequencing adapters, (v) ligation of adapters, and (vi) optionally, some number of PCR cycles to enrich for product that has adapters ligated to both ends. The primary differences in an Ion Torrent workflow are the use of blunt-end ligation to different adapter sequences.

To facilitate multiplexing, different barcoded adapters can be used with each sample. Alternatively, barcodes can be introduced at the PCR amplification step by using different barcoded PCR primers to amplify different samples. High quality reagents with barcoded adapters and PCR primers are readily available in kits from many vendors. However, all the components of DNA library construction are now well documented, from adapters to enzymes, and can readily be assembled into “home-brew” library preparation kits.

An alternative method is the Nextera DNA Sample Prep Kit (Illumina), which prepares genomic DNA libraries by using a transposase enzyme to simultaneously fragment and tag DNA in a single-tube reaction termed “tagmentation.” The engineered enzyme has dual activity; it fragments the DNA and simultaneously adds specific adapters to both ends of the fragments. These adapter sequences are used to amplify the insert DNA by PCR. The PCR reaction also adds index (barcode) sequences. The preparation procedure improves on traditional protocols by combining DNA fragmentation, end-repair, and adaptor-ligation into a single step. This protocol is very sensitive to the amount of DNA input compared with mechanical fragmentation methods. In order to obtain transposition events separated by the appropriate distances, the ratio of transposase complexes to sample DNA can be important. Because the fragment size is also dependent on the reaction efficiency, all reaction parameters, such as temperatures and reaction time, should be tightly controlled for optimal results.

A number of DNA sequencing techniques are known in the art, including fluorescence-based sequencing methodologies (See, e.g., Birren et al., Genome Analysis Analyzing DNA, 1, Cold Spring Harbor, N.Y.). In some embodiments, automated sequencing techniques understood in that art are utilized. In some embodiments, parallel sequencing of partitioned amplicons can be utilized (PCT Publication No WO2006084132). In some embodiments, DNA sequencing is achieved by parallel oligonucleotide extension (See, e.g., U.S. Pat. Nos. 5,750,341; 6,306,597). Additional examples of sequencing techniques include the Church polony technology (Mitra et al., 2003, Analytical Biochemistry 320, 55-65; Shendure et al., 2005 Science 309, 1728-1732; U.S. Pat. Nos. 6,432,360, 6,485,944, 6,511,803), the 454 picotiter pyrosequencing technology (Margulies et al., 2005 Nature 437, 376-380; US 20050130173), the Solexa single base addition technology (Bennett et al., 2005, Pharmacogenomics, 6, 373-382; U.S. Pat. Nos. 6,787,308; 6,833,246), the Lynx massively parallel signature sequencing technology (Brenner et al. (2000). Nat. Biotechnol. 18:630-634; U.S. Pat. Nos. 5,695,934; 5,714,330), and the Adessi PCR colony technology (Adessi et al. (2000). Nucleic Acid Res. 28, E87; WO 00018957).

Next-generation sequencing (NGS) methods share the common feature of massively parallel, high-throughput strategies, with the goal of lower costs in comparison to older sequencing methods (see, e.g., Voelkerding et al., Clinical Chem., 55: 641-658, 2009; MacLean et al, Nature Rev. Microbiol, 7-287-296; each herein incorporated by reference in their entirety). NGS methods can be broadly divided into those that typically use template amplification and those that do not. Amplification-requiring methods include pyrosequencing commercialized by Roche as the 454 technology platforms (e.g., GS 20 and GS FLX), the Solexa platform commercialized by Illumina, and the Supported Oligonucleotide Ligation and Detection (SOLiD) platform commercialized by Applied Biosystems. Non-amplification approaches, also known as single-molecule sequencing, are exemplified by the HeliScope platform commercialized by Helicos Biosciences, and emerging platforms commercialized by VisiGen, Oxford Nanopore Technologies Ltd., Life Technologies/Ion Torrent, and Pacific Biosciences, respectively.

In pyrosequencing (U.S. Pat. Nos. 6,210,891; 6,258,568), template DNA is fragmented, end-repaired, ligated to adaptors, and clonally amplified in-situ by capturing single template molecules with beads bearing oligonucleotides complementary to the adaptors. Each bead bearing a single template type is compartmentalized into a water-in-oil microvesicle, and the template is clonally amplified using a technique referred to as emulsion PCR. The emulsion is disrupted after amplification and beads are deposited into individual wells of a picotitre plate functioning as a flow cell during the sequencing reactions. Ordered, iterative introduction of each of the four dNTP reagents occurs in the flow cell in the presence of sequencing enzymes and luminescent reporter such as luciferase. In the event that an appropriate dNTP is added to the 3′ end of the sequencing primer, the resulting production of ATP causes a burst of luminescence within the well, which is recorded using a CCD camera. It is possible to achieve read lengths greater than or equal to 400 bases, and 106 sequence reads can be achieved, resulting in up to 500 million base pairs (Mb) of sequence.

In the Solexa/Illumina platform (Voelkerding et al, Clinical Chem., 55-641-658, 2009; MacLean et al, Nature Rev. Microbiol, 7⋅′ 287-296; U.S. Pat. Nos. 6,833,246; 7,115,400; 6,969,488), sequencing data are produced in the form of shorter-length reads. In this method, single-stranded fragmented DNA is end-repaired to generate 5′-phosphorylated blunt ends, followed by Klenow-mediated addition of a single A base to the 3′ end of the fragments. A-addition facilitates addition of T-overhang adaptor oligonucleotides, which are subsequently used to capture the template-adaptor molecules on the surface of a flow cell that is studded with oligonucleotide anchors. The anchor is used as a PCR primer, but because of the length of the template and its proximity to other nearby anchor oligonucleotides, extension by PCR results in the “arching over” of the molecule to hybridize with an adjacent anchor oligonucleotide to form a bridge structure on the surface of the flow cell. These loops of DNA are denatured and cleaved. Forward strands are then sequenced with reversible dye terminators. The sequence of incorporated nucleotides is determined by detection of post-incorporation fluorescence, with each fluorophore and block removed prior to the next cycle of dNTP addition. Sequence read length ranges from 36 nucleotides to over 50 nucleotides, with overall output exceeding 1 billion nucleotide pairs per analytical run.

Sequencing nucleic acid molecules using SOLiD technology (Voelkerding et al, Clinical Chem., 55-641-658, 2009; U.S. Pat. Nos. 5,912,148; 6,130,073) also involves fragmentation of the template, ligation to oligonucleotide adaptors, attachment to beads, and clonal amplification by emulsion PCR. Following this, beads bearing template are immobilized on a derivatized surface of a glass flow-cell, and a primer complementary to the adaptor oligonucleotide is annealed. However, rather than utilizing this primer for 3′ extension, it is instead used to provide a 5′ phosphate group for ligation to interrogation probes containing two probe-specific bases followed by 6 degenerate bases and one of four fluorescent labels. In the SOLiD system, interrogation probes have 16 possible combinations of the two bases at the 3′ end of each probe, and one of four fluors at the 5′ end. Fluor color, and thus identity of each probe, corresponds to specified color-space coding schemes. Multiple rounds (usually 7) of probe annealing, ligation, and fluor detection are followed by denaturation, and then a second round of sequencing using a primer that is offset by one base relative to the initial primer. In this manner, the template sequence can be computationally re-constructed, and template bases are interrogated twice, resulting in increased accuracy. Sequence read length averages 35 nucleotides, and overall output exceeds 4 billion bases per sequencing run. In certain embodiments, nanopore sequencing is employed (see, e.g., Astier et al., J. Am. Chem. Soc. 2006 Feb. 8; 128(5):1705-10). The theory behind nanopore sequencing has to do with what occurs when a nanopore is immersed in a conducting fluid and a potential (voltage) is applied across it. Under these conditions a slight electric current due to conduction of ions through the nanopore can be observed, and the amount of current is exceedingly sensitive to the size of the nanopore. As each base of a nucleic acid passes through the nanopore, this causes a change in the magnitude of the current through the nanopore that is distinct for each of the four bases, thereby allowing the sequence of the DNA molecule to be determined.

The Ion Torrent technology is a method of DNA sequencing based on the detection of hydrogen ions that are released during the polymerization of DNA (see, e.g., Science 327(5970): 1190 (2010); U.S. Pat. Appl. Pub. Nos. 20090026082, 20090127589, 20100301398, 20100197507, 20100188073, and 20100137143). A microwell contains a template DNA strand to be sequenced. Beneath the layer of microwells is a hypersensitive ISFET ion sensor. All layers are contained within a CMOS semiconductor chip, similar to that used in the electronics industry. When a dNTP is incorporated into the growing complementary strand a hydrogen ion is released, which triggers a hypersensitive ion sensor. If homopolymer repeats are present in the template sequence, multiple dNTP molecules will be incorporated in a single cycle. This leads to a corresponding number of released hydrogens and a proportionally higher electronic signal. This technology differs from other sequencing technologies in that no modified nucleotides or optics are used. The per base accuracy of the Ion Torrent sequencer is \tilde{ }99.6% for 50 base reads, with \tilde{ }100 Mb generated per run. The read-length is 100 base pairs. The accuracy for homopolymer repeats of 5 repeats in length is \tilde{ }98%. The benefits of ion semiconductor sequencing are rapid sequencing speed and low upfront and operating costs.

In some embodiments, the present disclosure teaches use of long-assembly sequencing technology. For example, in some embodiments, the present disclosure teaches PacBio sequencing and/or Nanopore sequencing.

PacBio SMRT technology is based on special flow cells harboring individual picolitre-sized wells with transparent bottoms. Each of the wells, referred to as zero mode waveguides (ZMW), contain a single fixed polymerase at the bottom (Ardui, S., Race, V., de Ravel, T., Van Esch, H., Devriendt, K., Matthijs, G., et al. (2018b). Detecting AGG interruptions in females with a FMR1 premutation by long-read single-molecule sequencing: a 1 year clinical experience. Front. Genet. 9:150). This allows a single DNA molecule, which is circularized in the library preparation (i.e., the SMRTbell), to progress through the well as the polymerase incorporates labeled bases onto the template DNA. Incorporation of bases induces fluorescence that can be recorded in real-time through the transparent bottoms of the ZMW (Pollard, M. O., Gurdasani, D., Mentzer, A. J., Porter, T., and Sandhu, M. S. (2018). Long reads: their purpose and place. Hum. Mol. Genet. 27, R234-R241. The average read length for SMRT was initially only ˜1.5 Kb, and with reported high error rate of ˜13% characterized by false insertions (arneiro, M. O., Russ, C., Ross, M. G., Gabriel, S. B., Nusbaum, C., and DePristo, M. A. (2012). Pacific biosciences sequencing technology for genotyping and variation discovery in human data. BMC Genomics 13:375.; Quail, M. A., Smith, M., Coupland, P., Otto, T. D., Harris, S. R., Connor, T. R., et al. (2012). A tale of three next generation sequencing platforms: comparison of Ion Torrent, Pacific Biosciences and Illumina MiSeq sequencers. BMC Genomics 13:341.). Since its introduction, the read length and throughput of SMRT technology have substantially increased. Throughput can reach >10 Gb per SMRT cell for the Sequel machine, while the average read length for both RSII and Sequel is >10 kb with some reads spanning >100 kb (van Dijk, E. L., Jaszczyszyn, Y., Naquin, D., and Thermes, C. (2018). The third revolution in sequencing technology. Trends Genet. 34, 666-681.).

Nanopore sequencing by ONT was introduced in 2015 with a portable MinION sequencer, which was followed by more high-throughput desktop sequencers GridION and PromethION. The basic principle of nanopore sequencing is to pass a single strand of DNA molecule through a nanopore which is inserted into a membrane, with an attached enzyme, serving as a biosensor (Deamer, D., Akeson, M., and Branton, D. (2016). Three decades of nanopore sequencing. Nat. Biotechnol. 34, 518-524). Changes in electrical signal across the membrane are measured and amplified in order to determine the bases passing through the pore in real-time. The nanopore-linked enzyme, which can be either a polymerase or helicase, is bound tightly to the polynucleotide controlling its motion through the pore (Pollard, M. O., Gurdasani, D., Mentzer, A. J., Porter, T., and Sandhu, M. S. (2018). Long reads: their purpose and place. Hum. Mol. Genet. 27, R234-R241). For nanopore sequencing, there is no clear-cut limitation for read length, except the size of the analyzed DNA fragments. On average, ONT single molecule reads are >10 kb in length but can reach ultra-long for some individual reads lengths of >1 Mb surpassing SMRT (Jain, M., Koren, S., Miga, K. H., Quick, J., Rand, A. C., Sasani, T. A., et al. (2018). Nanopore sequencing and assembly of a human genome with ultra-long reads. Nat. Biotechnol. 36, 338-345). Also, the throughput per run of ONT GridION and PromethION sequencers are higher than for PacBio (up to 100 Gb and 6 Tb per run, respectively) (van Dijk, E. L., Jaszczyszyn, Y., Naquin, D., and Thermes, C. (2018). The third revolution in sequencing technology. Trends Genet. 34, 666-681).

In some embodiments, the present disclosure teaches hybrid approaches to sequencing the metagenomic library. That is, in some embodiments, the present disclosure teaches sequencing with two or more sequencing technologies (e.g., one short read and one long read). In some embodiments, access to long read sequencing can improve subsequent assembly of the library by providing a reference sequence for DNA regions where the assembly would not otherwise proceed with just the short reads.

### Methods of Producing Digital Metagenomics Libraries—Post-Sequencing Processing and Sequential Assembly

In some embodiments, the present disclosure teaches a sequential sequence assembly method to produce long-assembly sequenced metagenomic libraries. Sequence assembly describes the process of piecing together the various sequence reads obtained from the sequencing machine into longer reads representing the original DNA molecule. Assembly is particularly relevant for short-read NGS platforms, where sequences range in the 50-500 base range.

In some embodiments, sequences obtained from the sequencing step can be directly assembled. In some embodiments, the sequences from the sequencing step undergo some processing according to the sequencing manufacturer's instructions, or according to methods known in the art. For example, in some embodiments, the reads from pooled samples are trimmed to remove any adaptor/barcode sequences and quality filtered. In some embodiments, sequences from some sequencers (e.g., Illumina®) are processed to merge paired end reads. In some embodiments, contaminating sequences (e.g. cloning vector, host genome) are also removed. In some embodiments, the methods of the present disclosure are compatible with any applicable post-NGS sequence processing tool. In some embodiments, the sequences of the present disclosure are processed via BBTools (BBMap—Bushnell B.—sourceforge.net/projects/bbmap/).

Sequence assembly techniques can be widely divided into two categories: comparative assembly and de novo assembly. Persons having skill in the art will be familiar with the fundamentals of genome assemblers, which include the overlap-layout-consensus, alignment-layout-consensus, the greedy approach, graph-based schemes and the Eulerian path (Bilal Wajid, Erchin Serpedin, Review of General Algorithmic Features for Genome Assemblers for Next Generation Sequencers, Genomics, Proteomics & Bioinformatics, Volume 10, Issue 2, 2012, Pages 58-73).

According to some embodiments, the assembly of metagenomic library sequences may be a de novo assembly that is assembled using any suitable sequence assembler known in the art including, but not limited to, ABySS, ALLPATHS-LG, AMOS, Arapan-M, Arapan-S, Celera WGA Assembler/CABOG, CLC Genomics Workbench & CLC Assembly Cell, Cortex, DNA Baser, DNA Dragon, DNAnexus, Edena, Euler, Euler-sr, Forge, Geneious, Graph Constructor, IDBA, IDBA-UD, LIGR Assembler, MaSuRCA, MIRA, NextGENe, Newbler, PADENA, PASHA, Phrap, TIGR Assembler, Ray, Sequecher, SeqMan NGen, SGA, SGARCGS, SOPRA, SparseAssembler, S SAKE, SOAPdenovo, SPAdes, Staden gap4 package, Taipan, VCAKE, Phusion assembler, QSRA, and Velvet.

A non-limiting list of sequence assemblers available to date is provided in Table 1.

TABLE 1
Non-limiting List of de novo Sequence Assemblers.

| | | Technologies | |
|---|---|---|---|
| Name | Type | and algorithm | Reference/Link |
| ABySS | (large) | Solexa, SOLiD | ABySS 2.0: resource-efficient assembly of large |
| | genomes | De Bruijn | genomes using a Bloom filter. Jackman S D, |
| | | graph (DBG) | Vandervalk B P, Mohamadi H, Chu J, Yeo S, |
| | | | Hammond S A, Jahesh G, Khan H, Coombe L, |
| | | | Warren R L, Birol I. Genome Research, 2017 27: 768- |
| | | | 777 |
| ALLPATHS-LG | (large) | Solexa, | Gnerre S et al. 2010. High-quality draft assemblies of |
| | genomes | SOLiD (DBG) | mammalian genomes from massively parallel |
| | | | sequence data. Proceedings of the National Academy |
| | | | of Sciences December 2010, 201017351 |
| AMOS | genomes | Sanger, 454 | //sourceforge.net/proj ects/amos/ |
| Arapan-M | Medium | All | Sahli and Shibuya. An algorithm for classifying DNA |
| | Genomes (e.g. | | reads. 2012 International conference on Bioscience, |
| | E. coli) | | Biochemistry and Bioinformatics. IPCBEE vol. |
| | | | 31(2012) |
| Arapan-S | Small | All | Sahli M, Shibuya T. Arapan-S: a fast and highly |
| | Genomes | | accurate whole-genome assembly software for viruses |
| | (Viruses and | | and small genomes. BMC Res Notes. 2012; 5: 243. |
| | Bacteria) | | Published 2012 May 16. |
| Celera WGA | (large) | Sanger, 454, | Koren S, Miller J R, Walenz B P, Sutton G. An |
| Assembler/ | genomes | Solexa | algorithm for automated closure during |
| CABOG | | overlap-layout- | assembly. BMC Bioinformatics. 2010; 11: 457. |
| | | consensus (OLC) | Published 2010 Sep. 10. |
| CLC Genomics | genomes | Sanger, 454, | Wingfield B D, Ambler J M, Coetzee M P, et al. IMA |
| Workbench & | | Solexa, SOLiD | Genome-F 6: Draft genome sequences of Armillaria |
| CLC Assembly | | OLC | fuscipes, Ceratocystiopsis minuta, Ceratocystis |
| Cell | | | adiposa, Endoconidiophora laricicola, E. polonica and |
| | | | Penicillium freii DAOMC 242723. IMA Fungus. |
| | | | 2016; 7(1): 217-227. |
| | | | //digitalinsights.qiagen.com |
| Cortex | genomes | Solexa, SOLiD | Whole Genome Sequencing for High-Resolution |
| | | | Investigation of Methicillin Resistant |
| | | | Staphylococcus aureus Epidemiology and Genome |
| | | | Plasticity SenGupta D J, Cummings L, Hoogestraat |
| | | | D R, Butler-Wu S M, Shendure J, Cookson B T, |
| | | | Salipante S J JCM doi:10.1128/JCM.00759-14 |
| DNA Baser | genomes | Sanger, 454 | www.DnaBaser.com |
| DNA Dragon | genomes | Illumina, SOLiD, | Yörük, E, Sefer, Ö. (2018). FcMgv1, FcStuA AND |
| | | Complete | FcVeA based genetic characterization in Fusarium |
| | | Genomics, 454. | culmorum (W. G. Smith). Trakya University Journal |
| | | Sanger | of Natural Sciences, 19 (1), 63-69. |
| | | | www.dna-dragon.com/ |
| Edena | genomes | Illumina | Analysis of the salivary microbiome using culture- |
| | | OLC | independent techniques. Lazarevic V, Whiteson K, |
| | | | Gaia N, Gizard Y, Hernandez D, Farinelli L, Osteras |
| | | | M, Francois P, Schrenzel J. |
| | | | J Clin Bioinforma. 2012 Feb. 2; 2: 4. |
| Euler-sr | genomes | 454, Solexa | Chaisson and Pevzner. Short read fragment assembly |
| | | | of bacterial genomes. Genome Res. 2008. 18: 324- |
| | | | 330 |
| Forge | (large) | 454, Solexa, | DiGuistini, S., Liao, N. Y., Platt, D. et al. De |
| | genomes, EST, | SOLID, Sanger | novo genome sequence assembly of a filamentous |
| | metagenomes | | fungus using Sanger, 454 and Illumina sequence |
| | | | data. Genome Biol 10, R94 (2009). |
| | | | https://doi.org/10.1186/gb-2009-10-9-r94 |
| Geneious | genomes | Sanger, 454, | www.geneious.com/features/assembly-mapping/ |
| | | Solexa, Ion | |
| | | Torrent, Complete | |
| | | Genomics, | |
| | | PacBio, Oxford | |
| | | Nanopore, | |
| | | Illumina | |
| IDBA (Iterative | (large) | Sanger, 454, | Peng, Y., et al. (2010) IDBA- A Practical Iterative de |
| De Bruijn graph | genomes | Solexa | Bruijn Graph De Novo Assembler. RECOMB. |
| short read | | | Lisbon. |
| Assembler) | | | |
| MaSuRCA | (large) | Sanger, Illumina, | Zimin, A. et al. The MaSuRCA genome Assembler. |
| (Maryland Super | genomes | 454 | Bioinformatics (2013). |
| Read - Celera | | hybrid approach | doi:10.1093/bioinformatics/btt476 |
| Assembler) | | | |
| MIRA | genomes, | Sanger, 454, | Chevreux et al. (2004) Using the miraEST Assembler |
| (Mimicking | ESTs | Solexa | for Reliable and Automated mRNA Transcript |
| Intelligent Read | | | Assembly and SNP Detection in Sequenced ESTs |
| Assembly) | | | Genome Research 2004. 14: 1147-1159. |
| NextGENe | (small | 454, Solexa, | Manion et al. De novo assemblv of short sequence |
| | genomes?) | SOLiD | reads with nextgene ™ software & condensation tool. |
| | | | Application |
| | | | note//softgenetics.com/PDF/DenovoAssembly_SSR_AppNote.pdf |
| Newbler | genomes, | 454, Sanger | Margulies M et al. Genome sequencing in |
| | ESTs | (OLC) | microfabricated high-density picolitre |
| | | | reactors. Nature. 2005 Sep. 15; 437(7057): 376-80. |
| PADENA | genomes | 454, Sanger | Thareja, G.; Kumar, V.; Zyskowski, M.; Mercer, S. |
| | | | and Davidson, B. (2011). PadeNA: A PARALLEL |
| | | | DE NOVO ASSEMBLER. In Proceedings of the |
| | | | International Conference on Bioinformatics Models, |
| | | | Methods and Algorithms - Volume 1: |
| | | | BIOINFORMATICS, (BIOSTEC 2011) |
| PASHA | (large) | Illumina | Liu, Y., Schmidt, B. & Maskell, D. L. Parallelized |
| | genomes | | short read assembly of large genomes using de Bruijn |
| | | | graphs. BMC Bioinformatics 12, 354 (2011) |
| Phrap | genomes | Sanger, 454, | Bastide and Mccombie, Assembling Genomic DNA |
| | | Solexa | sequences with PHRAP. Current protocols in |
| | | (OLC) | Bioinformatics. Vol 17(1) March 2007. |
| TIGR Assembler | genomic | Sanger | Sutton G G, White O, Adams M D, Kerlavage A R |
| | | | (1995) TIGR Assembler: A new tool for assembling |
| | | | large shotgun sequencing projects. Genome Science |
| | | | and Technology 1: 9-19. |
| Ray | genomes | Illumina, mix of | Boisvert et al. Ray Meta: scalable de novo |
| | | Illumina and 454, | metagenome assembly and profiling. Genome |
| | | paired or not | Biology (BioMed Central Ltd). 13: R122, Published: |
| | | | 22 Dec. 2012 |
| Sequencher | genomes | traditional and | Bromberg C. Gene Codes Corporation; 1995. |
| | | next generation | Sequenche |
| | | sequence data | |
| SeqMan NGen | (large) | Illumina, ABI | Leldmeyer B et al. Short read Illumina data for the de |
| | genomes, | SOLiD, Roche | novo assembly of a non-model snail species |
| | exomes, | 454, Ion Torrent, | transcriptome (Radix balthica, Basommatophora, |
| | transcriptomes, | Solexa, Sanger | Pulmonata), and a comparison of assembler |
| | metagenomes, | | performance. BMC Genomics. 2011; 12: 317. |
| | ESTs | | Published 2011 Jun. 16. |
| | | | www.dnastar.com/t-products-seqman-ngen.aspx |
| SGA | (large) | Illumina, Sanger | Simpson J T and Durbin R. Efficient de novo |
| | genomes | (Roche 454?, Ion | assembly of large genomes using compressed data |
| | | Torrent?) | structures. Genome Res. 2012; 22(3): 549-556 |
| SHARCGS | (small) | Solexa | Dohm J C et al., Substantial biases in ultra-short |
| | genomes | | read data sets from high-throughput DNA |
| | | | sequencing |
| | | | Nucleic Acids Res. 2008 Jul. 26. |
| SOPRA | genomes | Illumina, SOLiD, | Dayarian, A. et al., SOPRA: Scaffolding algorithm |
| | | Sanger, 454 | for paired reads via statistical optimization. BMC |
| | | | Bioinformatics 11, 345 (2010) |
| Sparse Assembler | (large) | Illumina, 454, Ion | Ye, C., Ma, Z. S., Cannon, C. H. et al. Exploiting |
| | genomes | torrent | sparseness in de novo genome assembly. BMC |
| | | | Bioinformatics 13, S1 (2012). |
| SSAKE | (small) | Solexa (SOLiD? | Warren R L, Sutton G G, Jones S J M, Holt R A. 2007 |
| | genomes | Helicos?) | (epub 2006 Dec. 8). |
| | | | Assembling millions of short DNA sequences using |
| | | | SSAKE. Bioinformatics 23: 500 |
| SOAPdenovo | genomes | Solexa | Luo, Ruibang et al. “SOAPdenovo2: an empirically |
| | | (DBG) | improved memory-efficient short-read de novo |
| | | | assembler.” GigaScience vol. 1, 1 18. 27 Dec. 2012, |
| | | | doi:10.1186/2047-217X-l-18 |
| SPAdes | (small) | Illumina, Solexa | Bankevich A. et al., SPAdes: A New Genome |
| | genomes, | | Assembly Algorithm and Its Applications to |
| | single-cell | | Single-Cell Sequencing. Journal of |
| | | | Computational Biology, 2012 |
| Staden gap5 | BACs (, small | Sanger | Bonfield, James K. and Whitwham, Andrew. Gap5 - |
| package | genomes?) | | editing the billion fragment sequence assembly. |
| | | | Bioinformatics 26, 1699-1703, (2010) |
| Taipan | (small) | Illumina | Bertil Schmidt et al, A fast hybrid short read fragment |
| | genomes | | assembly algorithm, Bioinformatics, Volume 25, |
| | | | Issue 17, 1 Sep. 2009, Pages 2279-2280 |
| VCAKE | (small) | Solexa (SOLiD?, | William R. Jeck et al., Extending assembly of short |
| | genomes | Helicos?) | DNA sequences to handle error, Bioinformatics, |
| | | | Volume 23, Issue 21, 1 Nov. 2007, Pages 2942- |
| | | | 2944, |
| Phusion | (large) | Sanger | Mullikin, James C, and Zemin Ning. “The phusion |
| assembler | genomes | (OLC) | assembler.” Genome research vol. 13, 1 (2003): 81- |
| | | | 90. doi:10.1101/gr.731003 |
| Quality Value | genomes | Sanger, Solexa | Bryant, Douglas W Jr et al. “QSRA: a quality-value |
| Guided SRA | | | guided de novo short read assembler.” BMC |
| (QSRA) | | | bioinformatics vol. 10 69. 24 Feb. 2009, |
| | | | doi:10.1186/1471-2105-10-69 |
| Velvet | (small) | Sanger, 454, | Zerbino, Daniel R. “Using the Velvet de novo |
| | genomes | Solexa, SOLiD | assembler for short-read sequencing |
| | | (DBG) | technologies.” Current protocols in |
| | | | bioinformatics vol. Chapter 11 (2010): Unit 11.5. |
| | | | doi:10.1002/0471250953.bi1105s31 |

### Training Data Sets

In some embodiments, the methods and systems herein make use of training data sets to train a machine learning model.

In some embodiments, the training data set comprises input variables and output variables. In some embodiments, the training data set comprises a genetic sequence input variable: this input variable contains sequences (nucleic acid and/or amino acid sequences) encoding proteins in the case of methods and systems for the selection of target protein variants. In some embodiments, the training data set contains nucleic acid sequences corresponding to target genes for methods and systems for the selection of target gene variants. In some embodiments, the training data set comprises a phenotypic performance output variable comprising one or more phenotypic performance measurements that are associated with the one or more input sequences. This output variable contains information about the protein encoded by the nucleic acid and/or amino acid sequences contained in the input variable or about the gene corresponding to the nucleic acid sequence. The phenotypic performance measurement may be the protein function or an indication of whether or not the protein performs a given protein function. The phenotypic performance measurement may be the gene function or an indication of whether or not the gene performs a given gene function. For example, in the initial training of a machine learning model that predicts whether or not proteins encoded by sequences in a database perform the function of a target protein, the training data set may comprise as input variables the nucleic acid and/or amino acid sequences encoding proteins that perform the same function as the target protein. These proteins may be known to perform the same function, experimentally validated as performing the same function, or be predicted to perform the same function with a very high likelihood. For example, a protein in the initial training data set may be included based on very high sequence homology with a protein of known function, coupled with knowledge that the organism comprising said sequence produces the target product. The output variables (phenotypic performance output variable) may then be an indication of whether or not the protein encoded by the sequence performs the same function as the target protein. This output variables may take the form of a simple “yes/no” label or a binary numeric equivalent. Alternatively, the output variables may take the form of statistical and/or confidence values indicating the likelihood that the protein performs the target function.

Thus, in some embodiments, the training set comprises input variables in the form of protein sequences (i.e., amino acid sequences) or gene sequences (nucleic acid sequences) and output variables in the form of phenotypic performance output variables comprising one or more phenotypic performance measurements that are associated with the one or more input sequences. The phenotypic performance measurements may include any parameter of the protein or gene encoded by the input sequence or a host cell comprising such a sequence, including, but not limited to, whether or not the protein or gene performs a given function, function, reaction rate, starting metabolite consumption, ending metabolite production, kₒₙ, k_{off}, K_{D}, host cell productivity, host cell yield, host cell optical density at a given time point, and host cell growth rate. Additional phenotypic performance measurements of interest, especially for improvement using the methods disclosed herein, may include the ability to import or export molecules(s) of interest across biological or synthetic membranes; the ability to carry higher metabolic flux towards desired metabolites as compared to wild-type cells; increased tolerance of cells to stress factors, including but not limited to high concentrations of the desired molecules or metabolic byproducts.

The output variables described above also apply to non-translated sequences. In some embodiments, the output variable for a promoter sequence may be whether the transcription factor binds to said sequence, or whether the gene to which the promoter is operably linked expresses. In other embodiments, the output variable for a small RNA (e.g., siRNA) is whether the small RNA complexes with its target sequence.

In some embodiments, the phenotypic performance output variable is not stored as information but is the basis for inclusion in the training data set: the fact of performing the target function or being predicted to perform the target function is the basis for inclusion of a sequence in the training data set, such that the output variable is implicit.

In some embodiments, the training data set also includes, as input data, sequences that do not perform the target protein or target gene function and corresponding output data indicating that the sequences do not perform the target protein or target gene function. Such negative information may be useful, e.g., in educating the machine learning model to recognize false positives. In some embodiments, this negative data may be derived from naturally occurring sequences known to not perform the same function of the target protein or target gene, or from mutational analysis of a protein or gene that loses function after one or more modifications.

In some embodiments, the phenotypic performance output variable may also include other relevant information about the corresponding genetic sequence input variable. For example, the training data set may, in some embodiments, include information indicating whether a sequence is patented, to train the predictive machine learning model to preferentially identify sequences with Freedom to Operate in a particular jurisdiction.

In subsequent rounds of training, the training data set may be updated with the results of the experimental validation of one or more candidate sequences identified by the disclosed methods and systems. In some embodiments, the tested candidate sequences (as input variables) and whether or not they encode proteins or genes performing the target protein or target gene function (as output variables) may be added to the training data set in order to further educate the machine learning model for improved predictive ability.

In some embodiments, the training data set may include phenotypic performance data other than or in addition to the function. For example, the training data set may include information about the productivity/yield (of the molecule of interest) of a host cell comprising a sequence. Such information may be added to the training data set, e.g., after experimental validation in a host cell. Alternatively, such information may be added to the training data set based on data available in the art and/or in databases.

### Machine Learning Models

The present methods and systems employ machine learning models to identify sequences (e.g., nucleic acid and/or amino acid sequences) that encode proteins that perform the same function as a target protein, or which enable a host cell to perform a desired function. In some embodiments, the present methods and systems employ machine learning models to identify gene sequences that perform the same function as a target gene, or which enable a host cell to perform a desired function.

The term “machine learning model” (or “model”) as used herein refers to a collection of parameters and functions, wherein the parameters are trained on a training data set, and wherein the model makes predictions about test data. The parameters and functions may be a collection of linear algebra operations, non-linear algebra operations, and tensor algebra operations. The parameters and functions may include statistical functions, tests, and probability models. The training data set, as described herein, can correspond to input data (e.g., nucleic acid and/or amino acid sequences) and output data (known classifications/labels, phenotypic performance measurements), as described in greater detail in the sections above. The model can learn from the training data set in a training process that optimizes the parameters (and potentially the functions) to provide an optimal quality metric (e.g., accuracy) for identifying new sequences with the desired function. The training function can include expectation maximization, maximum likelihood, Bayesian parameter estimation methods such as Markov chain monte carlo, gibbs sampling, hamiltonian monte carlo, and variational inference, or gradient based methods such as stochastic gradient descent and the Broyden-Fletcher-Goldfarb-Shanno (BFGS) algorithm. Example parameters include weights (e.g., vector or matrix transformations) that multiply values, e.g., in regression or neural networks, families of probability distributions, or a loss, cost or objective function that assigns scores and guides model training. Example parameters include weights that multiple values, e.g., in regression or neural networks. A model can include multiple sub-models, which may be different layers of a model or independent model, which may have a different structural form, e.g., a combination of a neural network and a support vector machine (SVM). Examples of machine learning models include Hidden Markov Models (HMMs), deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. A machine learning model can further include feature engineering (e.g., gathering of features into a data structure such as a 1, 2, or greater dimensional vector) and feature representation (e.g., processing of data structure of features into transformed features to use in training for inference of a classification).

In some embodiments, the computer processing of a machine learning technique can include method(s) of statistics, mathematics, biology, or any combination thereof. In some embodiments, any one of the computer processing methods can include a dimension reduction method, logistic regression, dimension reduction, principal component analysis, autoencoders, singular value decomposition, Fourier bases, singular value decomposition, wavelets, discriminant analysis, support vector machine, tree-based methods, random forest, gradient boost tree, logistic regression, matrix factorization, network clustering, statistical testing, and neural network.

In some embodiments, the computer processing of a machine learning technique can include logistic regression, multiple linear regression (MLR), dimension reduction, partial least squares (PLS) regression, principal component regression, autoencoders, variational autoencoders, singular value decomposition, Fourier bases, wavelets, discriminant analysis, support vector machine, decision tree, classification and regression trees (CART), tree-based methods, random forest, gradient boost tree, logistic regression, matrix factorization, multidimensional scaling (MDS), dimensionality reduction methods, t-distributed stochastic neighbor embedding (t-SNE), multilayer perceptron (MLP), network clustering, neuro-fuzzy, neural networks (shallow and deep), artificial neural networks, Pearson product-moment correlation coefficient, Spearman's rank correlation coefficient, Kendall tau rank correlation coefficient, or any combination thereof.

In some embodiments, the machine learning model is a supervised machine learning model including, for example, a regression, support vector machine, tree-based method, and neural network. In some examples, the computer processing method is an unsupervised machine learning method including, for example, clustering, network, principal component analysis, and matrix factorization.

In some embodiments, training sets may be used comprising data of protein sequences of known function. A learning module can optimize parameters of a model such that a quality metric is achieved with one or more specified criteria. Determining a quality metric can be implemented for any arbitrary function including the set of all risk, loss, utility, and decision functions. A gradient can be used in conjunction with a learning step (e.g., a measure of how much the parameters of the model should be updated for a given time step of the optimization process).

Genetic data can be acquired and analyzed to obtain a variety of different phenotypic features, which can include features based on a genome wide analysis. These features can form a feature space that is searched, stretched, rotated, translated, and linearly or non-linearly transformed to generate an accurate machine learning model, which can differentiate between sequences encoding variants performing the target protein or target gene function and unrelated sequences.

In general, machine learning may be described as the optimization of performance criteria, e.g., parameters, techniques or other features, in the performance of an informational task (such as classification or regression) using a limited number of examples of labeled data, and then performing the same task on unknown data. In supervised machine learning, the machine (e.g., a computing device) learns, for example, by identifying patterns, categories, statistical relationships, or other attributes, exhibited by training data. The result of the learning is then used to predict whether new data will exhibit the same patterns, categories, statistical relationships or other attributes.

In some embodiments, the methods and systems of the disclosure may employ other supervised machine learning techniques when training data is available. In some embodiments, in the absence of training data, the methods and systems may employ unsupervised machine learning. In some embodiments, the methods and systems may employ semi-supervised machine learning, using a small amount of labeled data and a large amount of unlabeled data. Embodiments may also employ feature selection to select the subset of the most relevant features to optimize performance of the machine learning model. Depending upon the type of machine learning approach selected, as alternatives or in addition to linear regression, embodiments may employ for example, logistic regression, neural networks, support vector machines (SVMs), decision trees, hidden Markov models, Bayesian networks, Gram Schmidt, reinforcement-based learning, cluster-based learning including hierarchical clustering, genetic algorithms, and any other suitable learning machines known in the art. In particular, embodiments may employ logistic regression to provide probabilities of classification (e.g., classification of genes into different functional groups) along with the classifications themselves. See, e.g., Shevade, A simple and efficient algorithm for gene selection using sparse logistic regression, Bioinformatics, Vol. 19, No. 17 2003, pp. 2246-2253, Leng, et al., Classification using functional data analysis for temporal gene expression data, Bioinformatics, Vol. 22, No. 1, Oxford University Press (2006), pp. 68-76, all of which are incorporated by reference in their entirety herein.

In some embodiments, the methods and systems may employ graphics processing unit (GPU) accelerated architectures that have found increasing popularity in performing machine learning tasks, particularly in the form known as deep neural networks (DNN). Embodiments of the disclosure may employ GPU-based machine learning, such as that described in GPU-Based Deep Learning Inference: A Performance and Power Analysis, NVidia Whitepaper, November 2015, Dahl, et al., Multi-task Neural Networks for QSAR Predictions, Dept. of Computer Science, Univ. of Toronto, June 2014 (arXiv:1406.1231 [stat.ML]), all of which are incorporated by reference in their entirety herein. Machine learning techniques applicable to embodiments of the disclosure may also be found in, among other references, Libbrecht, et al., Machine learning applications in genetics and genomics, Nature Reviews: Genetics, Vol. 16, June 2015, Kashyap, et al., Big Data Analytics in Bioinformatics: A Machine Learning Perspective, Journal of Latex Class Files, Vol. 13, No. 9, September 2014, Prompramote, et al., Machine Learning in Bioinformatics, Chapter 5 of Bioinformatics Technologies, pp. 117-153, Springer Berlin Heidelberg 2005, all of which are incorporated by reference in their entirety herein.

In some embodiments, the methods and systems herein make use of at least one machine learning model. The first machine learning model is a model that predicts whether or not a given sequence encodes a protein or gene that performs the same function as a target protein or target gene. In some embodiments, the machine learning model predicts whether a given sequence is capable of enabling a desired function in a host cell.

In some embodiments, the methods and systems herein make use of more than one machine learning model. The second machine learning model or models predict whether or not a given sequence encodes a protein or gene performing a function other than the target protein or target gene function. Thus, the second machine learning model or models predict the likelihood that a given sequence performs a different function, and is therefore incapable of enabling the desired function in a host cell. Analyzing sequences with more than one machine learning model identifies sequences which may be more likely to perform different functions than the one desired. For example, a sequence identified by the first machine learning model as exhibiting an Olivetolic acid synthase would, in some embodiments be filtered out of the result set, if a second machine learning model identified the same sequence as having a significantly higher likelihood of being an fatty acid reductase.

In some embodiments, the quality control check that comes from analyzing given sequence with a second machine learning model is repeated one or more times. That is, in some embodiments, a given sequence is analyzed by a plurality of alternative control machine learning models to determine whether its identification by the first machine learning model should be trusted. Control machine learning models have been trained on sequences that play functions distinct from those of the first machine learning model. Thus, if the first machine learning model has been trained to identify sequences encoding a specific reductase, the control machine learning models that will be tested will include models trained against desaturases, transcription factors, invertases, etc.

Thus, in some embodiments, the presently claimed systems and methods compare the predictions of the first machine learning model to one or more control machine learning models, to evaluate the likelihood that the first machine model's prediction is accurate. In some embodiments, if a control machine learning model identifies the given sequence as having a different function with substantially higher likelihood, then the given sequence is removed from the candidate sequence list.

In some embodiments, the predictive score of the first machine learning model is compared against the predictive scores of every tested control machine learning model. In other embodiments, the predictive scores (e.g., confidence score) of the control machine learning models is compared for a given sequence, and only the top score is considered as the “second predictive machine learning model” for the purposes of comparing the confidence scores of the first and second predictive machine learning models. Thus, in some embodiments, the predictions of the first machine learning model are only compared against the best of the control machine learning models.

In some embodiments, the machine learning model is a Hidden Markov Model (HMM). In some embodiments, the methods and systems herein make use of at least one HMM. The first HMM is a model that predicts whether or not a given sequence encodes a protein or gene that performs the same function as a target protein or target gene. In some embodiments, the methods and systems herein make use of more than one HMM. The second HMM or HMMs predict whether or not a given sequence encodes a protein or gene performing a function other than the target protein or target gene function.

### Construction of HMMs

The present disclosure, in some embodiments, provides methods and systems making use of Hidden Markov Models (HMMs) for the prediction of protein function.

The following provides an exemplary workflow for generating an HMM for use in the present methods and systems. In some embodiments, an HMM generation workflow comprises the following steps:

1) Identify sequences to be used in a training data set corresponding to the target protein/target gene/function of interest;

2) Align the sequences;

3) Evaluate the alignment;

4) Generate the HMM predictive machine learning model from the multiple sequence alignment;

5) Evaluate the HMM.

Each of these exemplary steps is elaborated on herein.

1. Identify sequences to be used in training data set

To construct an HMM to make predictions about whether or not a given sequence encodes a protein performing a desired function, it is necessary to have a set of sequences (at least one) that enable the desired function, or that perform the same function as the target protein/gene. This is the initial training data set that will be used to train the machine learning model (e.g., HMM) in the present methods and systems: the data set comprises input genetic data (nucleic acid and/or amino acid sequences) and output phenotypical data (that the sequence performs the desired function). The list may be generated from either an existing orthology group (e.g., a KEGG orthology group) identified as having the desired function, or by identifying a sequence performing the desired function in Uniprot and finding homologs of that sequence. In some embodiments, the list may be compiled from a publicly available sequence database. In some embodiments, the list may be compiled from a proprietary database. In some embodiments, the list may be compiled from a commercial database. In some embodiments, the list may be compiled from empirical data, such as validation experiments.

In some embodiments, the present disclosure teaches that the predictive ability of the HMM can be improved by providing the model with diverse sequences encoding proteins performing the desired function, i.e., the target protein function, or diverse sequences encoding genes performing the desired function, i.e., the target gene function. A very similar sequence set may train the HMM to identify similar sequences, similar to BLAST. Diverse sequences allow the HMM to capture which positions (e.g., amino acids) can vary and which are important to conserve. In some embodiments, it is desirable to include as many sequences as possible that are reasonably expected to perform the desired target function.

In some embodiments, the present disclosure teaches that the sequences in the training data set should share one or more sequence features. If sequences in the training data set do not share any common sequence features, they are likely not orthologs and should be excluded from the training data set. In some embodiments, the present disclosure teaches the creation of a primary HMM trained solely on high confidence training data sets, and a separate HMM trained on sequences selected with more lenient guidelines, such as outlier sequences that are believed to have the desired function, but do not share many of the sequence features present within the rest of the training data set.

For the purposes of illustration, the guidance for the identification of an initial training data set of sequences is applied to the target protein tyrosine decarboxylase. These steps may be followed by an individual or may be programmed into software as a part of a method or system. To find an initial sequence training data set for the target protein tyrosine decarboxylase, one may start by looking for an existing orthology group annotated with the desired function, e.g., as follows:
a. Search KEGG orthology database for the desired term (www.genome.jp/dbget-bin/www_bfind_sub?mode=bfind&max_hit=1000&dbkey=kegg&keywords=tyrosine+decarboxylase).
b. Select the KEGG Orthology link.
c. Scroll down to Genes and select the Uniprot link to get a list of Uniprot IDs for this function.
d. Cut and paste the list of Uniprot IDs into Excel to get a column of the IDs separate from the descriptions.
e. Go to Retrieve/ID at Uniprot.
f. Paste the set of Uniprot IDs retrieved in step (e). This will return a list of Uniprot entries. Select the download link to retrieve a list sequences of these entries in FASTA format.

It is also possible to compile an initial training data set by searching Uniprot for a desired sequence, e.g., as follows:
a. Search UniprotKB for a protein performing the function of the target protein in any organism, e.g., an organism of interest. For this example, the search begins with the exemplary tyrosine decarboxylase found at www.uniprot.org/uniprot/A4WQL8.
b. In the upper left corner, there is a button to do a BLAST search of this sequence against the full UniprotKB. Click this, and select the advanced option.
c. Set Threshold to 0.1 (at most, or 1e-5, 1e-10, 1e-15, 1e-20 or smaller for higher confidence) and Hits to 1000; this will provide a large number of hits while removing very different sequences. Then run the search. It will take a few minutes to complete the search.
d. Click the download link to download all sequences as a FASTA file.

2. Align the sequences

The sequences accumulated in step 1 may be aligned using any available multiple sequence alignment tool. Multiple sequence alignment tools include Clustal Omega, EMBOSS Cons, Kalign, MAFFT, MUSCLE, MView, T-Coffee, and WebPRANK, among others. For the purposes of this illustrative example, Clustal Omega is employed. Clustal Omega may be installed on a computer and run from the command line, e.g., with the following prompt:
$ clustalo-infile=uniprot-list.fasta-type=protein-output=fasta-outfile=aligned.fasta

3. Evaluate the alignment (optional)

The multiple sequence alignment performed in step 2 may be evaluated and filtered for poor matches. As described in the foregoing, sequences that do not share sequence features are likely not in the same orthology group and may be detrimental to the quality of the HMM.

For assisting in the evaluation of the alignment, exemplary in-browser alignment tools are http://msa.biojs.net/ and //github.com/veidenberg/wasabi. Both can be downloaded and run locally.

Sequences that do not match the rest of the training data set may be removed from the training data set before proceeding to the next step. Such sequences may be removed in an automated fashion based on objective criteria of the quality of the alignment, such as not possessing one or more sequence features common to most other members of the orthology group or low number of identical positions. In some embodiments, sequences that do not match the orthology group may be removed by other means, e.g., visual inspection.

4. Generate the HMM predictive machine learning model based on the training data set

The HMM can be generated by any HMM building software. Exemplary software may be found at, or adapted from: mallet.cs.umass.edu;
www.cs.ubc.ca/˜murphyk/Software/HMM/hmm.html; cran.r-project.org/web/packages/HMM/index.html; www.qub.buffalo.edu;
ccb.jhu.edu/software/glimmerhmm/; www.ebi.ac.uk/Tools/hmmer/search/hmmsearch. In some embodiments, the HMMER tool is employed.

For the purposes of this illustrative example, HMMbuild is used and may be downloaded and run locally with the following command:
$ hmmbuild test.hmm aligned.fasta

5. Evaluate the HMM (optional)

To evaluate the HMM generated in step 4, it may be run on an annotated database to evaluate its ability to correctly recognize sequences. In this illustrative example, the HMM is used to query the SwissProt database, for which all annotations are presumed to be true. The results of this test run may be checked to see if the annotations of the search result match the function the HMM should represent.

With a fasta file (or files) of a search database of protein sequences (e.g., protein_db.fasta), the following command can be run to get an output file of HMM matches with a corresponding E-value.
$ hmmsearch -A 0 --cpu 8 -E 1e-20 --noali --notextw test.hmm protein_db.fasta > hmm.out

This command can also be used on the translated proteome of a genome to find all hits matching a functional motif.

The various options in this command correspond to the following:
-A 0 : do not save multiple alignment of all hits to a file
--cpu 8 : use 8 parallel CPU workers for multithreads
-E 1e-20 : report sequences <= 1e-20 e-value threshold in output
--noali : don't output alignments, so output is smaller
--notextw : unlimit ASCII text output line width

### Candidate Sequence Identification and Filtering

Using the predictive models described herein, the present methods and systems identify sequences in a database, e.g., a metagenomic database, predicted to perform the same function as a target protein or target gene, or which enable a desired function in a host cell. Such identified sequences are termed “candidate sequences.” Candidate sequences may be identified based on the confidence score assigned to the candidate sequence by the model (e.g., a machine learning model, e.g., an HMM). For the purposes of selection of candidate sequences, a confidence score cutoff may be employed. The confidence score cutoff may vary based on the size of the database and other features of the particular implementation of the method. Alternatively, the method or system may employ other means for discriminating between candidate sequences and non-candidate sequences. In some embodiments, the candidate sequences are ranked in order of highest confidence to lowest confidence by their confidence score and then a cutoff is employed to remove any sequences falling below a particular confidence threshold. For example, if the confidence score is an e-value, the candidate sequences may be ranked in order of ascending e-value: lowest e-value (highest confidence) to highest e-value (lowest confidence). Then, any sequences assigned an e-value above a selected threshold may be removed from the pool of candidate sequences. Analogously, if the confidence score is a bit score, the candidate sequences may be ranked in order of descending bit score: highest bit score (highest confidence) to lowest bit score (lowest confidence). Then, any sequences assigned a bit score below a selected threshold may be removed from the pool of candidate sequences. In some embodiments, no additional cutoff or removal step is employed (after the preliminary identification using an input confidence value cutoff for the identification of candidate sequences) before proceeding to filtering as described below.

In some embodiments, following identification of the candidate sequences from the sequence database, the candidate sequences are filtered to remove candidate sequences that are less likely to perform the function of the target protein or target gene. In some embodiments, the candidate sequences are filtered based on their evaluation using one or more second “control” predictive models. The number of control predictive models employed may depend on the situation, the type of target protein or target gene, the availability of relevant data, and other such features. In some embodiments, the number of control predictive models is between 1 and 100,000. In some embodiments, the number of control predictive models is at least 1, at least 10, at least 100, at least 1,000, at least 10,000, or at least 100,000.

In some embodiments, the candidate sequences are evaluated by a first predictive model that determines the likelihood that the sequence performs the function of the target protein or target gene, e.g., by assigning a confidence score; then, the candidate sequences are evaluated by a second predictive model or models that determine the likelihood that the sequence performs a different function, e.g., by assigning a confidence score. The relative likelihoods of the candidate sequence performing the target protein or target gene function or another function are then compared. In some embodiments, each candidate sequence is assigned a “target protein or target gene confidence score” generated by the first predictive model and a “best match confidence score”, wherein the best match confidence score is the best confidence score generated by a second predictive model evaluating the likelihood that the candidate sequence performs a different function than the target protein or target gene function. For example, if 500 control predictive models are employed to determine whether or not the sequence is likely to encode a protein or gene performing a function other than the target protein or target gene function, the “best match confidence score” would be the best confidence score (e.g., highest bit score, lowest e-value) generated by any one of the 500 control predictive models.

In some embodiments, said “best match” would be used as the “second predictive machine learning model” for the purposes of evaluating the predicted function of a given protein/gene. Thus, in some embodiments, the target protein or target gene confidence score and the best match confidence score are compared. In some embodiments, the log of the target protein or target gene e-value and the log of the best match (e.g., from the second predictive machine learning model) e-value are compared. In some embodiments, the target protein or target gene bit score and the best match bit score are compared. In some embodiments, a threshold is established for the relative likelihood of performing the target protein or target gene function.

The number of control predictive machine learning models employed is not numerically limited, but is based on the ability to generate and/or availability of control models, such as those which may be generated based on the identification of orthology groups other than those to which the target protein or target gene belongs, i.e., “off-target” orthology groups. In some embodiments, at least one control model is employed. In some embodiments, at least 5, 10, 50, 100, 200, 300, 400, 500, 600, 700, 800, 900, 1,000, or 10,000 control models are employed. The terms “control,” “secondary,” and “off-target” models are used interchangeably for the purposes of this disclosure. In some embodiments, the control models are used to identify target proteins or target genes having any activity other than the desired or on-target activity.

In some embodiments, candidate sequences are only retained if the likelihood of performing the target protein or target gene function is greater than the likelihood of performing a different protein function. In some embodiments, candidate sequences are only retained if the likelihood of performing the target protein or target gene function is greater than or approximately equal to the likelihood of performing a different protein function. In some embodiments, the candidate sequence is retained if the relative likelihood of performing the target protein or target gene function falls within a certain confidence interval. In some embodiments, the candidate sequence is retained if the relative likelihood of performing the target protein or target gene function exceeds a certain threshold value. In some embodiments, a candidate sequence is retained if it meets the following criteria (or the equivalent for a target gene):

$$\frac{target protein bit score}{best match bit score} or \frac{log ( t arget protein E value )}{log ( best match E value )} > threshold value .$$

In some embodiments, the best match E value or best match bit score is the best confidence score out of the control predictive models. In other embodiments, the best match is the best confidence score out of all tested predictive models, including the target protein confidence score. In this second embodiment, if the target protein confidence score (e.g. bit score or E value) is the best match, then the ratio is 1. In other embodiments, in which the best match confidence score is selected from amongst the control predictive models, the ratio can exceed 1.

The threshold value for retaining a candidate sequence may be modified based on the desired confidence range. In some embodiments the threshold value is between 0.1 and 0.99. In some embodiments, the threshold value is between 0.5 and 0.99. In some embodiments, the threshold value is 0.1, 0.2, 0.3, 0.4, 0.5, 0.6, 0.7, 0.8, or 0.9. In some embodiments, the threshold value is 0.5, 0.55, 0.6, 0.65, 0.7, 0.75, 0.8, 0.85, 0.9, or 0.95.

The threshold calculations above are illustrative, but in no way exhaustive. Persons having skill in the art will recognize how to apply various threshold cutoffs depending on how their confidence scores are calculated. For example, if the confidence score is such that a lower score indicates greater confidence, then a sequence may be retained if the ratio of the target protein or target gene confidence score to the best match confidence score is lower than a certain threshold value.

Candidate Sequence Clustering and/or Selection for In Vitro Testing

In some embodiments, following identification of candidate sequences, the candidate sequences may be clustered. For the purposes of this disclosure, cluster analysis or clustering is the task of grouping a set of sequences in such a way that sequences in the same group (called a cluster) are more similar (in some sense) to each other than to those in other groups (clusters). In some embodiments, clustering is based on the sequence similarity of the candidate sequences. In some embodiments, clustering is based on the sequence identity of the candidate sequences.

If included in the method or system, clustering is performed after the identification of the candidate sequences. Clustering may be performed before or after filtering of the candidate sequences. In some embodiments, clustering is used to maximize the coverage of the sequence diversity present in the pool of candidate sequences or in the filtered pool of candidate sequences.

Clustering can be achieved by various algorithms known in the art. Popular notions of clusters include groups with small distances between cluster members, dense areas of the data space, intervals or particular statistical distributions. The appropriate clustering algorithm and parameter settings (including parameters such as the distance function to use, a density threshold or the number of expected clusters) depend on the individual data set and intended use of the results. In some embodiments, clustering parameters may be modified until the result exhibits the desired properties. Cluster models that may be employed in the present systems and methods include:

Connectivity models: for example, hierarchical clustering builds models based on distance connectivity. In some embodiments, connectivity-based clustering, or hierarchical clustering, is employed.

Centroid models: for example, the k-means algorithm represents each cluster by a single mean vector. In some embodiments, k-means clustering is employed. In some embodiments, the k-means clustering is employed through the use of Lloyd's algorithm. Fork means clustering, a number (k) of desired clusters must be specified prior to clustering. To determine the desired number of clusters, a combination of hierarchical and k-means clustering may be used. For example, a random subset of sequences may be subjected to hierarchical clustering and then analyzed for the optimum number of clusters, k. Then the full set of sequences can be subjected to k-means clustering with this pre-determined value of k. In some embodiments, another clustering method, such as any of those described herein, is employed prior to k-means clustering.

Distribution models: clusters are modeled using statistical distributions, such as multivariate normal distributions used by the expectation-maximization algorithm. In some embodiments, distribution-based clustering is employed.

Density models: for example, DBSCAN and OPTICS defines clusters as connected dense regions in the data space. In some embodiments, density-based clustering is employed.

Subspace models: in biclustering (also known as co-clustering or two-mode-clustering), clusters are modeled with both cluster members and relevant attributes. In some embodiments, biclustering is employed.

Group models: some algorithms do not provide a refined model for their results and just provide the grouping information. In some embodiments, group models are employed.

Graph-based models: a clique, that is, a subset of nodes in a graph such that every two nodes in the subset are connected by an edge can be considered as a prototypical form of cluster. Relaxations of the complete connectivity requirement (a fraction of the edges can be missing) are known as quasi-cliques, as in the HCS clustering algorithm. In some embodiments, graph-based models are employed.

Signed graph models: Every path in a signed graph has a sign from the product of the signs on the edges. Under the assumptions of balance theory, edges may change sign and result in a bifurcated graph. The weaker “clusterability axiom” (no cycle has exactly one negative edge) yields results with more than two clusters, or subgraphs with only positive edges. In some embodiments, signed graph models are employed.

Neural models: the most well-known unsupervised neural network is the self-organizing map and these models can usually be characterized as similar to one or more of the above models, and including subspace models when neural networks implement a form of Principal Component Analysis or Independent Component Analysis. In some embodiments, neural models are employed.

Other clustering models and algorithms known in the art may be employed herein.

In some embodiments, the clustering may be evaluated and/or refined. In some embodiments, the clustering may be evaluated internally, e.g., using the Davies-Bouldin index, Dunn index, or Silhouette coefficient. In some embodiments, the clustering may be evaluated externally, e.g., by assessing purity, the Rand index, the F-measure, the Jaccard index, the Dice index, the Fowlkes-Mallows index, mutual information, or a confusion matrix.

In some embodiments, clustering is used within the methods and systems to remove complexity or decrease the numeric burden of candidate sequences to consider for validation. That is, clustering permits the user to reduce the amount of wet lab bench work, by choosing only a few representative sequences from each “cluster” for validation. Positive results for the filtered representative sequences may lead to further analysis of other sequences within the same cluster. In some embodiments, clustering reduces the numeric burden from the original number of candidate sequences (or the number of filtered candidate sequences) 2-fold, 5-fold, 10-fold, 50-fold, 100-fold, 500-fold, 1000-fold, or 10,000-fold. In some embodiments, after clustering only a representative number of candidate sequences are identified from one or more clusters for validation or for downstream processing. In some embodiments, only 0 or 1 representative candidate sequences are selected from each identified cluster for testing.

The present methods and systems may also employ a variety of tools for the selection of specific candidate sequences to test, e.g., through in vitro validation in a host cell. In some embodiments, representative candidate sequences are selected after clustering. In some embodiments, candidate sequences are ordered based on some standard, e.g., based on ascending target protein or target gene confidence score generated by the machine learning model, which provides a measure of the likelihood that the sequence encodes a protein or gene performing the function of the target protein or target gene. In some embodiments, the candidate sequences for in vitro validation are selected based on the dual criteria of (1) having the best confidence scores (e.g., exhibiting the highest degree of confidence) and (2) belonging to different clusters. Other criteria may alternatively or additionally be applied to the selection of representative candidate sequences for in vitro validation.

### Cell Culture and Fermentation

In some embodiments, the present disclosure teaches manufacturing one or more host cells comprising a candidate sequence identified through the predictive models and filtering of the instant invention. In some embodiments, a host cell is manufactured to comprise a single candidate sequence. In some embodiments, a host cell is manufactured to comprise a combination (i.e., two or more) of candidate sequences. For example, host cells may be manufactured to comprise two or more candidate sequences in order to expedite the first screening step to select for transformed host cells comprising two or more candidate sequences that outperform the original host cell in some phenotypic performance. Candidate sequence combinations comprised by improved host cells may subsequently be tested individually to identify which of the candidate sequences contribute to the improved phenotypic performance of the host cell. In some embodiments, genes that resulted in improved phenotypic performance in a first round of testing may be combined for testing in subsequent rounds to identify whether or not the combination leads to even greater improvements in the phenotypic performance.

In some embodiments, host cells are manufactured to comprise candidate sequences predicted to perform a target function, wherein the host cell previously contained an endogenous protein or gene that performs that target function. As used herein, the term, “endogenous” refers to a protein or other gene that is encoded by the base strain of the host cell against which the manufactured host cells can be compared. In some embodiments, the endogenous target protein or target gene of the host cell is knocked down or knocked out prior to, during, or after transformation with the one or more candidate sequences.

Validating candidate sequences in host cells that previously comprised endogenous proteins/genes performing the same function provides a helpful platform for evaluating the function of the candidate sequence, because the manufactured host cell is assumed to have all other parts necessary to leverage the functionality of the candidate sequence. For example, by replacing a known endogenous reductase in a biosynthetic pathway with a candidate sequence predicted to also function as a reductase, one ensures that the candidate sequence is being tested in a background that contains all upstream and downstream genes of the pathway, such that measurement of the final product will be indicative of the candidate sequence' functionality.

In some embodiments, the present disclosure further teaches measuring the phenotypic performance of host cells. In some embodiments, these steps involve the culturing of host cells. Cells of the present disclosure can be cultured in conventional nutrient media modified as appropriate for any desired biosynthetic reactions or selections. In some embodiments, the present disclosure teaches culture in inducing media for activating promoters. In some embodiments, the present disclosure teaches media with selection agents, including selection agents of transformants (e.g., antibiotics), or selection of organisms suited to grow under inhibiting conditions (e.g., high ethanol conditions). In some embodiments, the present disclosure teaches growing cell cultures in media optimized for cell growth. In other embodiments, the present disclosure teaches growing cell cultures in media optimized for product yield. In some embodiments, the present disclosure teaches growing cultures in media capable of inducing cell growth and also contains the necessary precursors for final product production (e.g., high levels of sugars for ethanol production).

Culture conditions, such as temperature, pH and the like, are those suitable for use with the host cell selected for expression, and will be apparent to those skilled in the art. As noted, many references are available for the culture and production of many cells, including cells of bacterial, plant, animal (including mammalian) and archaebacterial origin. See e.g., Sambrook, Ausubel (all supra), as well as Berger, Guide to Molecular Cloning Techniques, Methods in Enzymology volume 152 Academic Press, Inc., San Diego, Calif.; and Freshney (1994) Culture of Animal Cells, a Manual of Basic Technique, third edition, Wiley-Liss, New York and the references cited therein; Doyle and Griffiths (1997) Mammalian Cell Culture: Essential Techniques John Wiley and Sons, NY; Humason (1979) Animal Tissue Techniques, fourth edition W.H. Freeman and Company; and Ricciardelle et al., (1989) In Vitro Cell Dev. Biol. 25:1016-1024, all of which are incorporated herein by reference. For plant cell culture and regeneration, Payne et al. (1992) Plant Cell and Tissue Culture in Liquid Systems John Wiley & Sons, Inc. New York, N.Y.; Gamborg and Phillips (eds) (1995) Plant Cell, Tissue and Organ Culture; Fundamental Methods Springer Lab Manual, Springer-Verlag (Berlin Heidelberg N.Y.); Jones, ed. (1984) Plant Gene Transfer and Expression Protocols, Humana Press, Totowa, N. J. and Plant Molecular Biology (1993) R. R. D. Croy, Ed. Bios Scientific Publishers, Oxford, U.K. ISBN 0 12 198370 6, all of which are incorporated herein by reference. Cell culture media in general are set forth in Atlas and Parks (eds.) The Handbook of Microbiological Media (1993) CRC Press, Boca Raton, Fla., which is incorporated herein by reference. Additional information for cell culture is found in available commercial literature such as the Life Science Research Cell Culture Catalogue from Sigma-Aldrich, Inc (St Louis, Mo.) (“Sigma-LSRCCC”) and, for example, The Plant Culture Catalogue and supplement also from Sigma-Aldrich, Inc (St Louis, Mo.) (“Sigma-PCCS”), all of which are incorporated herein by reference.

The culture medium to be used must in a suitable manner satisfy the demands of the respective strains. Descriptions of culture media for various microorganisms are present in the “Manual of Methods for General Bacteriology” of the American Society for Bacteriology (Washington D.C., USA, 1981).

The present disclosure furthermore provides a process for fermentative preparation of a product of interest, comprising the steps of: a) culturing a microorganism according to the present disclosure in a suitable medium, resulting in a fermentation broth; and b) concentrating the product of interest in the fermentation broth of a) and/or in the cells of the microorganism.

In some embodiments, the present disclosure teaches that the microorganisms produced may be cultured continuously—as described, for example, in WO 05/021772—or discontinuously in a batch process (batch cultivation) or in a fed-batch or repeated fed-batch process for the purpose of producing the desired organic-chemical compound. A summary of a general nature about known cultivation methods is available in the textbook by Chmiel (Bioprozeßtechnik. 1: Einführung in die Bioverfahrenstechnik (Gustav Fischer Verlag, Stuttgart, 1991)) or in the textbook by Storhas (Bioreaktoren and periphere Einrichtungen (Vieweg Verlag, Braunschweig/Wiesbaden, 1994)).

In some embodiments, the cells of the present disclosure are grown under batch or continuous fermentation conditions.

Classical batch fermentation is a closed system, wherein the compositions of the medium is set at the beginning of the fermentation and is not subject to artificial alternations during the fermentation. A variation of the batch system is a fed-batch fermentation which also finds use in the present disclosure. In this variation, the substrate is added in increments as the fermentation progresses. Fed-batch systems are useful when catabolite repression is likely to inhibit the metabolism of the cells and where it is desirable to have limited amounts of substrate in the medium. Batch and fed-batch fermentations are common and well known in the art.

Continuous fermentation is a system where a defined fermentation medium is added continuously to a bioreactor and an equal amount of conditioned medium is removed simultaneously for processing and harvesting of desired biomolecule products of interest. In some embodiments, continuous fermentation generally maintains the cultures at a constant high density where cells are primarily in log phase growth. In some embodiments, continuous fermentation generally maintains the cultures at a stationary or late log/stationary, phase growth. Continuous fermentation systems strive to maintain steady state growth conditions.

Methods for modulating nutrients and growth factors for continuous fermentation processes as well as techniques for maximizing the rate of product formation are well known in the art of industrial microbiology.

For example, a non-limiting list of carbon sources for the cultures of the present disclosure include, sugars and carbohydrates such as, for example, glucose, sucrose, lactose, fructose, maltose, molasses, sucrose-containing solutions from sugar beet or sugar cane processing, starch, starch hydrolysate, and cellulose; oils and fats such as, for example, soybean oil, sunflower oil, groundnut oil and coconut fat; fatty acids such as, for example, palmitic acid, stearic acid, and linoleic acid; alcohols such as, for example, glycerol, methanol, and ethanol; and organic acids such as, for example, acetic acid or lactic acid.

A non-limiting list of the nitrogen sources for the cultures of the present disclosure include, organic nitrogen-containing compounds such as peptones, yeast extract, meat extract, malt extract, corn steep liquor, soybean flour, and urea; or inorganic compounds such as ammonium sulfate, ammonium chloride, ammonium phosphate, ammonium carbonate, and ammonium nitrate. The nitrogen sources can be used individually or as a mixture.

A non-limiting list of the possible phosphorus sources for the cultures of the present disclosure include, phosphoric acid, potassium dihydrogen phosphate or dipotassium hydrogen phosphate or the corresponding sodium-containing salts.

The culture medium may additionally comprise salts, for example in the form of chlorides or sulfates of metals such as, for example, sodium, potassium, magnesium, calcium and iron, such as, for example, magnesium sulfate or iron sulfate, which are necessary for growth.

Finally, essential growth factors such as amino acids, for example homoserine and vitamins, for example thiamine, biotin or pantothenic acid, may be employed in addition to the abovementioned substances.

In some embodiments, the pH of the culture can be controlled by any acid or base, or buffer salt, including, but not limited to sodium hydroxide, potassium hydroxide, ammonia, or aqueous ammonia; or acidic compounds such as phosphoric acid or sulfuric acid in a suitable manner. In some embodiments, the pH is generally adjusted to a value of from 6.0 to 8.5, preferably 6.5 to 8.

In some embodiments, the cultures of the present disclosure may include an anti-foaming agent such as, for example, fatty acid polyglycol esters. In some embodiments the cultures of the present disclosure are modified to stabilize the plasmids of the cultures by adding suitable selective substances such as, for example, antibiotics.

In some embodiments, the culture is carried out under aerobic conditions. In order to maintain these conditions, oxygen or oxygen-containing gas mixtures such as, for example, air are introduced into the culture. It is likewise possible to use liquids enriched with hydrogen peroxide. The fermentation is carried out, where appropriate, at elevated pressure, for example at an elevated pressure of from 0.03 to 0.2 MPa. The temperature of the culture is normally from 20° C. to 45° C. and preferably from 25° C. to 40° C., particularly preferably from 30° C. to 37° C. In batch or fed-batch processes, the cultivation is preferably continued until an amount of the desired product of interest (e.g. an organic-chemical compound) sufficient for being recovered has formed. This aim can normally be achieved within 10 hours to 160 hours. In continuous processes, longer cultivation times are possible. The activity of the microorganisms results in a concentration (accumulation) of the product of interest in the fermentation medium and/or in the cells of said microorganisms.

In some embodiments, the culture is carried out under anaerobic conditions.

### Screening (Measuring Phenotypic Performance)

In some embodiments, the present disclosure teaches steps of measuring the phenotypic performance of manufactured host cells. In some embodiments, the present disclosure teaches high-throughput initial screenings for measuring phenotype in small scales. In other embodiments, the present disclosure teaches larger-scale tank-based validations for measuring phenotype.

In some embodiments, the high-throughput screening process is designed to predict performance of strains in bioreactors. As previously described, culture conditions are selected to be suitable for the organism and reflective of bioreactor conditions. Individual colonies are picked and transferred into 96 well plates and incubated for a suitable amount of time. Cells are subsequently transferred to new 96 well plates for additional seed cultures, or to production cultures. Cultures are incubated for varying lengths of time, where multiple measurements may be made. These may include measurements of product, biomass or other characteristics that predict performance of strains in bioreactors. High-throughput culture results are used to predict bioreactor performance.

In some embodiments, the tank-based performance validation is used to confirm performance of strains isolated by high throughput screening. In some embodiments, fermentation processes/conditions are obtained from client sites or from published literature on the host cell. Candidate strains are screened using bench scale fermentation reactors for relevant phenotypes such as productivity or yield of a product of interest. Persons having skill in the art will recognize that the instant systems and methods are also applicable to other phenotypes, such as those associated with overall culture density, resistance to various growth conditions and pests, or production of new products of interest, among many others.

### Product Recovery and Quantification

Methods for screening for the production of products of interest are known to those of skill in the art and are discussed throughout the present specification. Such methods may be employed when screening the strains of the disclosure.

In some embodiments, the present disclosure teaches systems and methods for enabling a desired function, such as producing (or increasing the production of) a product of interest. In some embodiments, the present disclosure teaches systems and methods that manufacture host cells with genes that perform the same function as a target genes, such as producing (or increasing the production of) a product of interest. In some embodiments, the host cells of the present invention are designed to produce non-secreted intracellular products. For example, the present disclosure teaches methods of improving the robustness, yield, efficiency, or overall desirability of cell cultures producing intracellular enzymes, oils, pharmaceuticals, or other valuable small molecules or peptides. The recovery or isolation of non-secreted intracellular products can be achieved by lysis and recovery techniques that are well known in the art, including those described herein.

For example, in some embodiments, cells of the present disclosure can be harvested by centrifugation, filtration, settling, or other method. Harvested cells are then disrupted by any convenient method, including freeze-thaw cycling, sonication, mechanical disruption, or use of cell lysing agents, or other methods, which are well known to those skilled in the art.

The resulting product of interest, e.g. a polypeptide, may be recovered/isolated and optionally purified by any of a number of methods known in the art. For example, a product polypeptide may be isolated from the nutrient medium by conventional procedures including, but not limited to: centrifugation, filtration, extraction, spray-drying, evaporation, chromatography (e.g., ion exchange, affinity, hydrophobic interaction, chromatofocusing, and size exclusion), or precipitation. Finally, high performance liquid chromatography (HPLC) can be employed in the final purification steps. (See for example Purification of intracellular protein as described in Parry et al., 2001, Biochem. J. 353:117, and Hong et al., 2007, Appl. Microbiol. Biotechnol. 73:1331, both incorporated herein by reference).

In addition to the references noted supra, a variety of purification methods are well known in the art, including, for example, those set forth in: Sandana (1997) Bioseparation of Proteins, Academic Press, Inc.; Bollag et al. (1996) Protein Methods, 2^{nd} Edition, Wiley-Liss, NY; Walker (1996) The Protein Protocols Handbook Humana Press, NJ; Harris and Angal (1990) Protein Purification Applications: A Practical Approach, IRL Press at Oxford, Oxford, England; Harris and Angal Protein Purification Methods: A Practical Approach, IRL Press at Oxford, Oxford, England; Scopes (1993) Protein Purification: Principles and Practice 3^{rd} Edition, Springer Verlag, NY; Janson and Ryden (1998) Protein Purification: Principles, High Resolution Methods and Applications, Second Edition, Wiley-VCH, NY; and Walker (1998) Protein Protocols on CD-ROM, Humana Press, NJ, all of which are incorporated herein by reference.

In some embodiments, the present disclosure teaches host cells designed to produce secreted products. For example, the present disclosure teaches methods of improving the robustness, yield, efficiency, or overall desirability of cell cultures producing valuable small molecules or peptides.

In some embodiments, immunological methods may be used to detect and/or purify secreted or non-secreted products produced by the cells of the present disclosure. In one example approach, antibody raised against a product molecule (e.g., against an insulin polypeptide or an immunogenic fragment thereof) using conventional methods is immobilized on beads, mixed with cell culture media under conditions in which the endoglucanase is bound, and precipitated. In some embodiments, the present disclosure teaches the use of enzyme-linked immunosorbent assays (ELISA).

In other related embodiments, immunochromatography is used, as disclosed in U.S. Pat. Nos. 5,591,645, 4,855,240, 4,435,504, 4,980,298, and Se-Hwan Paek, et al., “Development of rapid One-Step Immunochromatographic assay, Methods”, 22, 53-60, 2000), each of which are incorporated by reference herein. A general immunochromatography detects a specimen by using two antibodies. A first antibody exists in a test solution or at a portion at an end of a test piece in an approximately rectangular shape made from a porous membrane, where the test solution is dropped. This antibody is labeled with latex particles or gold colloidal particles (this antibody will be called as a labeled antibody hereinafter). When the dropped test solution includes a specimen to be detected, the labeled antibody recognizes the specimen so as to be bonded with the specimen. A complex of the specimen and labeled antibody flows by capillarity toward an absorber, which is made from a filter paper and attached to an end opposite to the end having included the labeled antibody. During the flow, the complex of the specimen and labeled antibody is recognized and caught by a second antibody (it will be called as a tapping antibody hereinafter) existing at the middle of the porous membrane and, as a result of this, the complex appears at a detection part on the porous membrane as a visible signal and is detected.

In some embodiments, the screening methods of the present disclosure are based on photometric detection techniques (absorption, fluorescence). For example, in some embodiments, detection may be based on the presence of a fluorophore detector such as GFP bound to an antibody. In other embodiments, the photometric detection may be based on the accumulation on the desired product from the cell culture. In some embodiments, the product may be detectable via UV of the culture or extracts from said culture.

Persons having skill in the art will recognize that the methods of the present disclosure are compatible with host cells producing any desirable biomolecule product of interest. Table 2 below presents a non-limiting list of the product categories, biomolecules, and host cells, included within the scope of the present disclosure. These examples are provided for illustrative purposes, and are not meant to limit the applicability of the presently disclosed technology in any way.

TABLE 2
A non-limiting list of the host cells and products
of interest of the present disclosure.

| Product category | Products | Host category | Hosts |
|---|---|---|---|
| Amino acids | Lysine | Bacteria | Corynebacterium |
| | | | glutamicum |
| Amino acids | Methionine | Bacteria | Escherichia coli |
| Amino acids | MSG | Bacteria | Corynebacterium |
| | | | glutamicum |
| Amino acids | Threonine | Bacteria | Escherichia coli |
| Amino acids | Threonine | Bacteria | Corynebacterium |
| | | | glutamicum |
| Amino acids | Tryptophan | Bacteria | Corynebacterium |
| | | | glutamicum |
| Enzymes | Enzymes (11) | Filamentous fungi | Trichoderma reesei |
| Enzymes | Enzymes (11) | Fungi | Myceliopthora thermophila |
| | | | (C1) |
| Enzymes | Enzymes (11) | Filamentous fungi | Aspergillus oryzae |
| Enzymes | Enzymes (11) | Filamentous fungi | Aspergillus niger |
| Enzymes | Enzymes (11) | Bacteria | Bacillus subtilis |
| Enzymes | Enzymes (11) | Bacteria | Bacillus licheniformis |
| Enzymes | Enzymes (11) | Bacteria | Bacillus clausii |
| Flavor & | Agarwood | Yeast | Saccharomyces cerevisiae |
| Fragrance | | | |
| Flavor & | Ambrox | Yeast | Saccharomyces cerevisiae |
| Fragrance | | | |
| Flavor & | Nootkatone | Yeast | Saccharomyces cerevisiae |
| Fragrance | | | |
| Flavor & | Patchouli oil | Yeast | Saccharomyces cerevisiae |
| Fragrance | | | |
| Flavor & | Saffron | Yeast | Saccharomyces cerevisiae |
| Fragrance | | | |
| Flavor & | Sandalwood oil | Yeast | Saccharomyces cerevisiae |
| Fragrance | | | |
| Flavor & | Valencene | Yeast | Saccharomyces cerevisiae |
| Fragrance | | | |
| Flavor & | Vanillin | Yeast | Saccharomyces cerevisiae |
| Fragrance | | | |
| Food | CoQ10/Ubiquinol | Yeast | Schizosaccharomyces pombe |
| Food | Omega 3 fatty | Microalgae | Schizochytrium |
| | acids | | |
| Food | Omega 6 fatty | Microalgae | Schizochytrium |
| | acids | | |
| Food | Vitamin B12 | Bacteria | Propionibacterium |
| | | | freudenreichii |
| Food | Vitamin B2 | Filamentous fungi | Ashbya gossypii |
| Food | Vitamin B2 | Bacteria | Bacillus subtilis |
| Food | Erythritol | Yeast-like fungi | Torula coralline |
| Food | Erythritol | Yeast-like fungi | Pseudozyma tsukubaensis |
| Food | Erythritol | Yeast-like fungi | Moniliella pollinis |
| Food | Steviol | Yeast | Saccharomyces cerevisiae |
| | glycosides | | |
| Hydrocolloids | Diutan gum | Bacteria | Sphingomonas sp |
| Hydrocolloids | Gellan gum | Bacteria | Sphingomonas elodea |
| Hydrocolloids | Xanthan gum | Bacteria | Xanthomonas campestris |
| Intermediates | 1,3-PDO | Bacteria | Escherichia coli |
| Intermediates | 1,4-BDO | Bacteria | Escherichia coli |
| Intermediates | Butadiene | Bacteria | Cupriavidus necator |
| Intermediates | n-butanol | Bacteria (obligate | Clostridium acetobutylicum |
| | | anaerobe) | |
| Organic acids | Citric acid | Filamentous fungi | Aspergillus niger |
| Organic acids | Citric acid | Yeast | Pichia guilliermondii |
| Organic acids | Gluconic acid | Filamentous fungi | Aspergillus niger |
| Organic acids | Itaconic acid | Filamentous fungi | Aspergillus terreus |
| Organic acids | Lactic acid | Bacteria | Lactobacillus |
| Organic acids | Lactic acid | Bacteria | Geobacillus |
| | | | thermoglucosidasius |
| Organic acids | LCDDs - DDDA | Yeast | Candida |
| Polyketides/Ag | Spinosad | Yeast | Saccharopolyspora spinosa |
| Polyketides/Ag | Spinetoram | Yeast | Saccharopolyspora spinosa |

In some embodiments, the molecule of interest is a protein. In some embodiments, the molecule of interest is a metabolite. In some embodiments, the molecule of interest is an amino acid. In some embodiments, the molecule of interest is a vitamin. In some embodiments, the molecule of interest is a commodity chemical. Numerous chemicals are known to be produced or known to be possible to produce in biological culture, such as ethanol, acetone, citric acid, propanoic acid, fumaric acid, butanol and 2,3-butanediol. See, e.g., Saxena, “Microbes in Production of Commodity Chemicals,” Applied Microbiology 2015: 71-81, incorporated by reference herein in its entirety. In some embodiments, the molecule of interest is a fine chemical. In some embodiments, the molecule of interest is a specialty chemical. In some embodiments, the molecule of interest is a pharmaceutical. In some embodiments, the molecule of interest is a biofuel. In some embodiments, the molecule of interest is a biopolymer.

Molecules of interest may include alcohols such as ethanol, propanol, isopropanol, butanol, fatty alcohols, fatty acid esters, wax esters; hydrocarbons and alkanes such as propane, octane, diesel, JP8; polymers such as terephthalate, 1,3-propanediol, 1,4-butanediol, polyols, PHA, PHB, acrylate, adipic acid, ε-caprolactone, isoprene, caprolactam, rubber; commodity chemicals such as lactate, DHA, 3-hydroxypropionate, γ-valerolactone, lysine, serine, aspartate, aspartic acid, sorbitol, ascorbate, ascorbic acid, isopentenol, lanosterol, omega-3 DHA, lycopene, itaconate, 1,3-butadiene, ethylene, propylene, succinate, citrate, citric acid, glutamate, malate, HPA, lactic acid, THF, gamma butyrolactone, pyrrolidones, hydroxybutyrate, glutamic acid, levulinic acid, acrylic acid, malonic acid; specialty chemicals such as carotenoids, isoprenoids, itaconic acid; pharmaceuticals and pharmaceutical intermediates such as 7-ADCA/cephalosporin, erythromycin, polyketides, statins, paclitaxel, docetaxel, terpenes, peptides, steroids, omega fatty acids and other such suitable molecules of interest. Such molecules may be useful in the context of fuels, biofuels, industrial and specialty chemicals, additives, as intermediates used to make additional products, such as nutritional supplements, nutraceuticals, polymers, paraffin replacements, personal care products and pharmaceuticals. These molecules can also be used as feedstock for subsequent reactions for example transesterification, hydrogenation, catalytic cracking via either hydrogenation, pyrolisis, or both or epoxidations reactions to make other products.

### Selection Criteria and Goals (Desired Function)

In some embodiments, the present disclosure teaches methods and systems for enabling a desired function in a host cell. As used herein, the term “desired function” refers to the goal of the strain improvement program. In some embodiments the terms “desired function” and “program goal(s)” are used interchangeably in this document.

The selection criteria applied to the methods of the present disclosure will vary with the specific goals of the strain improvement program (i.e., with the desired function that is being enabled). The present disclosure may be adapted to meet any program goals. For example, in some embodiments, the program goal may be to maximize single batch yields of reactions with no immediate time limits. In other embodiments, the program goal may be to rebalance biosynthetic yields to produce a specific product, or to produce a particular ratio of products. In other embodiments, the program goal may be to modify the chemical structure of a product, such as lengthening the carbon chain of a polymer. In some embodiments, the program goal may be to improve performance characteristics such as yield, titer, productivity, by-product elimination, tolerance to process excursions, optimal growth temperature and growth rate. In some embodiments, the program goal is improved host performance as measured by volumetric productivity, specific productivity, yield or titer, of a product of interest produced by a microbe.

In some embodiments, the program goal is to identify variants of a target protein or target gene that are improved in at least one respect. These variants may perform the same function or a similar function with one or more improved attributes. For example, in some embodiments, the variant may be more catalytically efficient, more pH- or thermo-stable, insensitive to feedback-inhibition or dependent on a different cofactor to catalyze a desired reaction. In some embodiments, the variant may be fused with another protein thus enabling more efficient catalysis. In some embodiments, the program goal is to improve characteristics of the target protein, target gene, or production of the target molecule of interest. In some embodiments, the goal is to improve resilience to stress factors. In some embodiments, the stress factor is selected from pH, temperature, osmotic pressure, substrate concentration, product concentration, and byproduct concentration.

In other embodiments, the program goal may be to optimize synthesis efficiency of a commercial strain in terms of final product yield per quantity of inputs (e.g., total amount of ethanol produced per pound of sucrose). In other embodiments, the program goal may be to optimize synthesis speed, as measured for example in terms of batch completion rates, or yield rates in continuous culturing systems. In other embodiments, the program goal may be to increase strain resistance to a particular phage, or otherwise increase strain vigor/robustness under culture conditions.

In some embodiments, strain improvement projects may be subject to more than one goal. In some embodiments, the goal of the strain project may hinge on quality, reliability, or overall profitability. In some embodiments, the present disclosure teaches methods of associated selected mutations or groups of mutations with one or more of the strain properties described above.

Persons having ordinary skill in the art will recognize how to tailor strain selection criteria to meet the particular project goal. For example, selections of a strain's single batch max yield at reaction saturation may be appropriate for identifying strains with high single batch yields. Selection based on consistency in yield across a range of temperatures and conditions may be appropriate for identifying strains with increased robustness and reliability.

In some embodiments, the selection criteria for the initial high-throughput phase and the tank-based validation will be identical. In other embodiments, tank-based selection may operate under additional and/or different selection criteria. For example, in some embodiments, high-throughput strain selection might be based on single batch reaction completion yields, while tank-based selection may be expanded to include selections based on yields for reaction speed.

### Organisms Amenable to Genetic Design

In some embodiments, the present disclosure teaches systems and methods of manufacturing one or more host cells, each comprising a sequence from amongst the candidate sequences identified through the predictive models and filtering steps of the instant invention. In some embodiments, the present disclosure teaches methods and systems for identifying a candidate gene sequence for enabling a desired function in a host cell. The disclosed systems and methods of this application are exemplified with industrial host cell cultures of Corynebacterium, but are applicable to any host cell organism that is amenable to genetic transformation.

Thus, as used herein, the terms “host cell,” “microbe,” and “microorganism” should be taken broadly. These include, but are not limited to, cells from the two prokaryotic domains, Bacteria and Archaea, as well as certain eukaryotic fungi and protists. However, in certain aspects, “higher” eukaryotic organisms such as insects, plants, and animals can be utilized in the methods taught herein.

Suitable host cells include, but are not limited to: bacterial cells, algal cells, plant cells, fungal cells, insect cells, and mammalian cells. In one illustrative embodiment, suitable host cells include E. coli (e.g., SHuffle™ competent E. coli available from New England BioLabs in Ipswich, Mass.).

Other suitable host organisms of the present disclosure include microorganisms of the genus Corynebacterium. In some embodiments, preferred Corynebacterium strains/species include: C. efficiens, with the deposited type strain being DSM44549, C. glutamicum, with the deposited type strain being ATCC13032, and C. ammoniagenes, with the deposited type strain being ATCC6871. In some embodiments the preferred host of the present disclosure is C. glutamicum.

Suitable host strains of the genus Corynebacterium, in particular of the species Corynebacterium glutamicum, are in particular the known wild-type strains: Corynebacterium glutamicum ATCC 13032, Corynebacterium acetoglutamicum ATCC 15806, Corynebacterium acetoacidophilum ATCC 13870, Corynebacterium melassecola ATCC17965, Corynebacterium thermoaminogenes FERM BP-1539, Brevibacterium flavum ATCC14067, Brevibacterium lactofermentum ATCC13869, and Brevibacterium divaricatum ATCC14020; and L-amino acid-producing mutants, or strains, prepared therefrom, such as, for example, the L-lysine-producing strains: Corynebacterium glutamicum FERM-P 1709, Brevibacterium flavum FERM-P 1708, Brevibacterium lactofermentum FERM-P 1712, Corynebacterium glutamicum FERM-P 6463, Corynebacterium glutamicum FERM-P 6464, Corynebacterium glutamicum DM58-1, Corynebacterium glutamicum DG52-5, Corynebacterium glutamicum DSM5714, and Corynebacterium glutamicum DSM12866.

The term “Micrococcus glutamicus” has also been in use for C. glutamicum. Some representatives of the species C. efficiens have also been referred to as C. thermoaminogenes in the prior art, such as the strain FERM BP-1539, for example.

In some embodiments, the host cell of the present disclosure is a eukaryotic cell. Suitable eukaryotic host cells include, but are not limited to: fungal cells, algal cells, insect cells, animal cells, and plant cells. Suitable fungal host cells include, but are not limited to: Ascomycota, Basidiomycota, Deuteromycota, Zygomycota, Fungi imperfecti. Certain preferred fungal host cells include yeast cells and filamentous fungal cells. Suitable filamentous fungi host cells include, for example, any filamentous forms of the subdivision Eumycotina and Oomycota. (see, e.g., Hawksworth et al., In Ainsworth and Bisby's Dictionary of The Fungi, 8^{th} edition, 1995, CAB International, University Press, Cambridge, UK, which is incorporated herein by reference). Filamentous fungi are characterized by a vegetative mycelium with a cell wall composed of chitin, cellulose and other complex polysaccharides. The filamentous fungi host cells are morphologically distinct from yeast.

In certain illustrative, but non-limiting embodiments, the filamentous fungal host cell may be a cell of a species of: Achlya, Acremonium, Aspergillus, Aureobasidium, Bjerkandera, Ceriporiopsis, Cephalosporium, Chrysosporium, Cochliobolus, Corynascus, Cryphonectria, Cryptococcus, Coprinus, Coriolus, Diplodia, Endothis, Fusarium, Gibberella, Gliocladium, Humicola, Hypocrea, Myceliophthora (e.g., Myceliophthora thermophila), Mucor, Neurospora, Penicillium, Podospora, Phlebia, Piromyces, Pyricularia, Rhizomucor, Rhizopus, Schizophyllum, Scytalidium, Sporotrichum, Talaromyces, Thermoascus, Thielavia, Tramates, Tolypocladium, Trichoderma, Verticillium, Volvariella, or teleomorphs, or anamorphs, and synonyms or taxonomic equivalents thereof. In one embodiment, the filamentous fungus is selected from the group consisting of A. nidulans, A. oryzae, A. sojae, and Aspergilli of the A. niger Group. In an embodiment, the filamentous fungus is Aspergillus niger.

In another embodiment, specific mutants of the fungal species are used for the methods and systems provided herein. In one embodiment, specific mutants of the fungal species are used which are suitable for the high-throughput and/or automated methods and systems provided herein. Examples of such mutants can be strains that protoplast very well; strains that produce mainly or, more preferably, only protoplasts with a single nucleus; strains that regenerate efficiently in microtiter plates, strains that regenerate faster and/or strains that take up polynucleotide (e.g., DNA) molecules efficiently, strains that produce cultures of low viscosity such as, for example, cells that produce hyphae in culture that are not so entangled as to prevent isolation of single clones and/or raise the viscosity of the culture, strains that have reduced random integration (e.g., disabled non-homologous end joining pathway) or combinations thereof.

In yet another embodiment, a specific mutant strain for use in the methods and systems provided herein can be strains lacking a selectable marker gene such as, for example, uridine-requiring mutant strains. These mutant strains can be either deficient in orotidine 5 phosphate decarboxylase (OMPD) or orotate p-ribosyl transferase (OPRT) encoded by the pyrG or pyrE gene, respectively (T. Goosen et al., Curr Genet. 1987, 11:499 503; J. Begueret et al., Gene. 1984 32:487 92.

In one embodiment, specific mutant strains for use in the methods and systems provided herein are strains that possess a compact cellular morphology characterized by shorter hyphae and a more yeast-like appearance.

Suitable yeast host cells include, but are not limited to: Candida, Hansenula, Saccharomyces, Schizosaccharomyces, Pichia, Kluyveromyces, and Yarrowia. In some embodiments, the yeast cell is Hansenula polymorpha, Saccharomyces cerevisiae, Saccaromyces carlsbergensis, Saccharomyces diastaticus, Saccharomyces norbensis, Saccharomyces kluyveri, Schizosaccharomyces pombe, Pichia pastoris, Pichia finlandica, Pichia trehalophila, Pichia kodamae, Pichia membranaefaciens, Pichia opuntiae, Pichia thermotolerans, Pichia salictaria, Pichia quercuum, Pichia pijperi, Pichia stipitis, Pichia methanolica, Pichia angusta, Kluyveromyces lactis, Candida albicans, or Yarrowia lipolytica.

In certain embodiments, the host cell is an algal cell such as, Chlamydomonas (e.g., C. Reinhardtii) and Phormidium (P. sp. ATCC29409).

In other embodiments, the host cell is a prokaryotic cell. Suitable prokaryotic cells include gram positive, gram negative, and gram-variable bacterial cells. The host cell may be a species of, but not limited to: Agrobacterium, Alicyclobacillus, Anabaena, Anacystis, Acinetobacter, Acidothermus, Arthrobacter, Azobacter, Bacillus, Bifidobacterium, Brevibacterium, Butyrivibrio, Buchnera, Campestris, Camplyobacter, Clostridium, Corynebacterium, Chromatium, Coprococcus, Escherichia, Enterococcus, Enterobacter, Erwinia, Fusobacterium, Faecalibacterium, Francisella, Flavobacterium, Geobacillus, Haemophilus, Helicobacter, Klebsiella, Lactobacillus, Lactococcus, Ilyobacter, Micrococcus, Microbacterium, Mesorhizobium, Methylobacterium, Methylobacterium, Mycobacterium, Neisseria, Pantoea, Pseudomonas, Prochlorococcus, Rhodobacter, Rhodopseudomonas, Rhodopseudomonas, Roseburia, Rhodospirillum, Rhodococcus, Scenedesmus, Streptomyces, Streptococcus, Synecoccus, Saccharomonospora, Saccharopolyspora, Staphylococcus, Serratia, Salmonella, Shigella, Thermoanaerobacterium, Tropheryma, Tularensis, Temecula, Thermosynechococcus, Thermococcus, Ureaplasma, Xanthomonas, Xylella, Yersinia, and Zymomonas. In some embodiments, the host cell is Corynebacterium glutamicum.

In some embodiments, the bacterial host strain is an industrial strain. Numerous bacterial industrial strains are known and suitable in the methods and compositions described herein.

In some embodiments, the bacterial host cell is of the Agrobacterium species (e.g., A. radiobacter, A. rhizogenes, A. rubi), the Arthrobacterspecies (e.g., A. aurescens, A. citreus, A. globformis, A. hydrocarboglutamicus, A. mysorens, A. nicotianae, A. paraffineus, A. protophonniae, A. roseoparaffinus, A. sulfureus, A. ureafaciens), the Bacillus species (e.g., B. thuringiensis, B. anthracis, B. megaterium, B. subtilis, B. lentus, B. circulars, B. pumilus, B. lautus, B. coagulans, B. brevis, B. firmus, B. alkaophius, B. licheniformis, B. clausii, B. stearothermophilus, B. halodurans and B. amyloliquefaciens. In particular embodiments, the host cell will be an industrial Bacillus strain including but not limited to B. subtilis, B. pumilus, B. licheniformis, B. megaterium, B. clausii, B. stearothermophilus and B. amyloliquefaciens. In some embodiments, the host cell will be an industrial Clostridium species (e.g., C. acetobutylicum, C. tetani E88, C. lituseburense, C. saccharobutylicum, C. perfringens, C. beijerinckii). In some embodiments, the host cell will be an industrial Corynebacterium species (e.g., C. glutamicum, C. acetoacidophilum). In some embodiments, the host cell will be an industrial Escherichia species (e.g., E. coli). In some embodiments, the host cell will be an industrial Erwinia species (e.g., E. uredovora, E. carotovora, E. ananas, E. herbicola, E. punctata, E. terreus). In some embodiments, the host cell will be an industrial Pantoea species (e.g., P. citrea, P. agglomerans). In some embodiments, the host cell will be an industrial Pseudomonas species, (e.g., P. putida, P. aeruginosa, P. mevalonii). In some embodiments, the host cell will be an industrial Streptococcus species (e.g., S. equisimiles, S. pyogenes, S. uberis). In some embodiments, the host cell will be an industrial Streptomyces species (e.g., S. ambofaciens, S. achromogenes, S. avermitilis, S. coelicolor, S. aureofaciens, S. aureus, S. fungicidicus, S. griseus, S. lividans). In some embodiments, the host cell will be an industrial Zymomonas species (e.g., Z. mobilis, Z. lipolytica), and the like.

The present disclosure is also suitable for use with a variety of animal cell types, including mammalian cells, for example, human (including 293, WI38, PER.C6 and Bowes melanoma cells), mouse (including 3T3, NS0, NS1, Sp2/0), hamster (CHO, BHK), monkey (COS, FRhL, Vero), and hybridoma cell lines.

In various embodiments, strains that may be used in the practice of the disclosure including both prokaryotic and eukaryotic strains, are readily accessible to the public from a number of culture collections such as American Type Culture Collection (ATCC), Deutsche Sammlung von Mikroorganismen and Zellkulturen GmbH (DSM), Centraalbureau Voor Schimmelcultures (CBS), and Agricultural Research Service Patent Culture Collection, Northern Regional Research Center (NRRL).

In some embodiments, the methods of the present disclosure are also applicable to multi-cellular organisms. For example, the platform could be used for improving the performance of crops. The organisms can comprise a plurality of plants such as Gramineae, Fetucoideae, Poacoideae, Agrostis, Phleum, Dactylis, Sorgum, Setaria, Zea, Oryza, Triticum, Secale, Avena, Hordeum, Saccharum, Poa, Festuca, Stenotaphrum, Cynodon, Coix, Olyreae, Phareae, Compositae or Leguminosae. For example, the plants can be corn, rice, soybean, cotton, wheat, rye, oats, barley, pea, beans, lentil, peanut, yam bean, cowpeas, velvet beans, clover, alfalfa, lupine, vetch, lotus, sweet clover, wisteria, sweet pea, sorghum, millet, sunflower, canola or the like. Similarly, the organisms can include a plurality of animals such as non-human mammals, fish, insects, or the like.

### Systems for Carrying out the Disclosed Methods

In some embodiments, the present disclosure teaches systems or devices capable of carrying out the sequence selection methods disclosed herein, e.g., methods to select sequences encoding variants of a target protein or target gene. In some embodiments, the systems of the present disclosure comprise an electronic compute device (“electronic device”). The electronic device can include one or more memories and one or more processors operatively coupled to at least one of the one or more memories, and configured to execute instructions stored on the at least one of the one or more memories to carry out any of the selection methods disclosed herein.

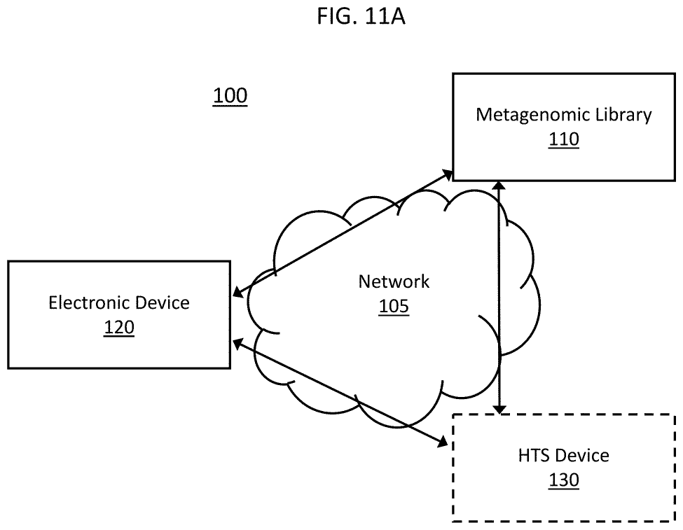

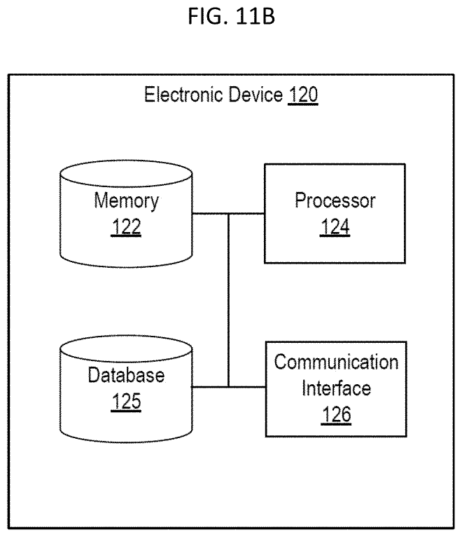

By way of example, FIGS. 11A-11B illustrate a system 100 (and/or portions thereof) configured to provide the sequence selection methods described herein, according to embodiments. While various components, elements, features, and/or functions may be described below, it should be understood that they have been presented by way of example only and not limitation. Those skilled in the art will appreciate that changes may be made to the form and/or features of the system 100 without altering the ability of the system 100 to perform the function of providing the selection methods described herein.

The system 100 can include at least a metagenomic library 110 and an electronic compute device 120 which are in communication via a network 105. As described in further detail herein, in some implementations, the system 100 can be implemented such that the metagenomic library 110 provides one or more sequences to the electronic compute device 120. In some embodiments, the system 100 can optionally include a high throughput screening device 130. The high throughput screening device 130 can be in communication with the electronic compute device 120 and/or the metagenomic library 110 via a network 105.

The network 105 can be any type of network(s) such as, for example, a local area network (LAN), a wireless local area network (WLAN), a virtual network such as a virtual local area network (VLAN), a wide area network (WAN), a metropolitan area network (MAN), a worldwide interoperability for microwave access network (WiMAX), a telephone network (such as the Public Switched Telephone Network (PSTN) and/or a Public Land Mobile Network (PLMN)), an intranet, the Internet, an optical fiber (or fiber optic)-based network, a cellular network, and/or any other suitable network. In some embodiments, the network may be a system bus or the like. Moreover, the network 105 and/or one or more portions thereof can be implemented as a wired and/or wireless network. In some implementations, the network 105 can include one or more networks of any type such as, for example, a wired or wireless LAN and the Internet.

The metagenomic library 110 can be any suitable library or database. For example, the metagenomic library 110 can be any of those described in detail above. In some implementations, the metagenomic library 110 can be in communication with the high throughput screening device 130 and/or the electronic device 120 via the network 105. In some implementations, the metagenomic library 110 can be included in a machine that further includes a high throughput screening device 130 and/or the electronic device 120. The metagenomic library 110 can be included in or in communication with the memory 122 and/or at least a portion thereof. In some implementations, the metagenomic library 110 can be configured to store data associated with the sequence selection methods described herein. The metagenomic library 110 can be any suitable data storage structure(s) such as, for example, a table, a repository, a relational database, an object-oriented database, an object-relational database, a structured query language (SQL) database, an extensible markup language (XML) database, and/or the like. In some embodiments, the metagenomic library 110 can be disposed in a housing, rack, and/or other physical structure including a housing, rack, and/or physical structure associated with the electronic device 120. In other embodiments, the electronic device 120 can be operably coupled to any number of databases (e.g., including the metagenomics library 110).

The optional high throughput screening device 130 can be any suitable machine, device, and/or system for screening protein variants, gene variants, or transformed host cells, as described herein. For example, the high throughput screening device 130 can be any of those described in detail in this disclosure, including in the sections below. In some implementations, the high throughput screening device 130 can be in communication with the metagenomic library 110 and/or the electronic device 120 via the network 105. In some implementations, the high throughput screening device 130 can be included in a machine that further includes at least one of the metagenomic library 110 and/or the electronic device 120. In some implementations, the high throughput screening device 130 can be included in a system that is separate from but in communication with the system 100 via one or more networks (e.g., including the network 105 and/or any other suitable network).

In some embodiments the high throughput screening (HTS) device 130 comprises different engines. Engines that may be included in the HTS device 130 include sequence generation engines, in vitro screening engines, host cell transformation engines, host cell culturing engines, phenotypic performance measurement engines, and the like. In some embodiments, the HTS device 130 receives input sequence data from the metagenomic library 110 and/or the electronic device 120. In some embodiments, the received sequence data is used to generate protein variants for in vitro enzymatic or phenotypical assays, e.g., through the use of an in vitro screening engine. In some embodiments, the received sequence data is used to generate gene editing tools comprising the selected representative candidate sequences received from the metagenomic library 110 and/or the electronic device 120. In some embodiments, the HTS device 130 comprises an engine to carry out transformation of the host cell, e.g., a transformation engine. In some embodiments, the HTS device 130 has an engine to measure the phenotypic performance of the transformed host cells, e.g., a phenotypic performance measurement engine. In some embodiments, the HTS device 130 is in communication with the electronic device 120 and communicates data from the transformation and/or phenotypic measurements.

The electronic compute device 120 (“electronic device”) can be any suitable hardware-based computing device configured to send and/or receive data via the network 105 and configured to receive, process, define, and/or store data such as, for example, one or more sequences, orthology groups, HMMs, phenotypic performance measurements, etc. In some embodiments, the electronic device 120 can be, for example, a personal computer (PC), a mobile device, a workstation, a server device or a distributed network of server devices, a virtual server or machine, and/or the like. In some embodiments, the electronic device 120 can be a smartphone, a tablet, a laptop, and/or the like. The components of the electronic device 120 can be contained within a single housing or machine or can be distributed within and/or between multiple machines.

As shown in FIG. 11B, the electronic device 120 can include at least a memory 122, a processor 124, and a communication interface 126. The memory 122, the processor 124, and the communication interface 126 can be connected and/or electrically coupled (e.g., via a system bus or the like) such that electric and/or electronic signals may be sent between the memory 122, the processor 124, and the communication interface 126. The electronic device 120 can also include and/or can otherwise be operably coupled to a database 125 configured, for example, to store data associated with files accessible via the network 105, as described in further detail herein. For example, the database 125 can be and/or can include the metagenomics library 110 and/or one or more portions thereof.

The memory 122 of the electronic device 120 can be, for example, a RAM, a memory buffer, a hard drive, a ROM, an EPROM, a flash memory, and/or the like. The memory 122 can be configured to store, for example, one or more software modules and/or code that can include instructions that can cause the processor 124 to perform one or more processes, functions, and/or the like (e.g., processes, functions, etc. associated with performing the selection methods described herein). In some implementations, the memory 122 can be physically housed and/or contained in or by the electronic device 120. In other implementations, the memory 122 and/or at least a portion thereof can be operatively coupled to the electronic device 120 and/or at least the processor 124. In such implementations, the memory 122 can be, for example, included in and/or distributed across one or more devices such as, for example, server devices, cloud-based computing devices, network computing devices, and/or the like.

The processor 124 can be a hardware-based integrated circuit (IC) and/or any other suitable processing device configured to run or execute a set of instructions and/or code stored, for example, in the memory 122. For example, the processor 124 can be a general purpose processor, a central processing unit (CPU), an accelerated processing unit (APU), an application specific integrated circuit (ASIC), a network processor, a front end processor, a field programmable gate array (FPGA), a programmable logic array (PLA), and/or the like. The processor 124 can be in communication with the memory 122 via any suitable interconnection, system bus, circuit, and/or the like. As described in further detail herein, the processor 124 can include any number of engines, processing units, cores, etc. configured to execute code, instructions, modules, processes, and/or functions associated with performing the selection methods described herein.

The communication interface 126 can be any suitable hardware-based device in communication with the processor 124 and the memory 122 and/or any suitable software stored in the memory 122 and executed by the processor 124. In some implementations, the communication interface 126 can be configured to communicate with the network 105 (e.g., any suitable device in communication with the network 105). The communication interface 126 can include one or more wired and/or wireless interfaces, such as, for example, a network interface card (NIC). In some implementations, the NIC can include, for example, one or more Ethernet interfaces, optical carrier (OC) interfaces, asynchronous transfer mode (ATM) interfaces, one or more wireless radios (e.g., a WiFi® radio, a Bluetooth® radio, etc.), and/or the like. As described in further detail herein, in some implementations, the communication interface 126 can be configured to send data to and/or receive data from at least the metagenomic library 110, the high throughput screening device 130, and/or any other suitable device(s) (e.g., via the network 105).

The memory 122 and/or at least a portion thereof can include and/or can be in communication with one or more data storage structures such as, for example, one or more databases (e.g., the database 125) and/or the like. In some implementations, the database 125 can be configured to store data associated with the sequence selection methods described herein. The database 125 can be any suitable data storage structure(s) such as, for example, a table, a repository, a relational database, an object-oriented database, an object-relational database, a structured query language (SQL) database, an extensible markup language (XML) database, and/or the like. In some embodiments, the database 125 can be disposed in a housing, rack, and/or other physical structure including at least the memory 122, the processor 124, and/or the communication interface 126. In other embodiments, the electronic device 120 can include and/or can be operably coupled to any number of databases. In some embodiments, the database 125 can be and/or can include the metagenomics library 110 and/or one or more portions thereof.

Although the electronic device 120 is shown and described with reference to FIGS. 11A-11B as being a single device, in other embodiments, the electronic device 120 can be implemented as any suitable number of devices collectively configured to perform as the electronic device 120. For example, the electronic device 120 can include and/or can be collectively formed by any suitable number of server devices or the like. In some embodiments, the electronic device 120 can include and/or can be collectively formed by a client or mobile device (e.g., a smartphone, a tablet, and/or the like) and a server, which can be in communication via the network 105. In some embodiments, the electronic device 120 can be a virtual machine, virtual private server, and/or the like that is executed and/or run as an instance or guest on a physical server or group of servers. In some such embodiments, the electronic device 120 can be stored, run, executed, and/or otherwise implemented in a cloud-computing environment. Such a virtual machine, virtual private server, and/or cloud-based implementation can be similar in at least form and/or function to a physical machine. Thus, the electronic device 120 can be implemented as one or more physical machine(s) or as a virtual machine run on a physical machine.

Although not shown in FIGS. 11A and 11B, the electronic device 120 can also include and/or can be in communication with any suitable user interface. For example, in some embodiments, a user interface of the electronic device 120 can be a display such as, for example, a cathode ray tube (CRT) monitor, a liquid crystal display (LCD) monitor, a light emitting diode (LED) monitor, and/or the like. In some instances, the display can be a touch sensitive display or the like (e.g., the touch sensitive display of a smartphone, tablet, wearable device, and/or the like). In some instances, the display can provide the user interface for a software application (e.g., a mobile application, internet web browser, and/or the like) that can allow the user to manipulate the electronic device 120. In other implementations, the user interface can be any other suitable user interface such as a mouse, keyboard, display, and/or the like.

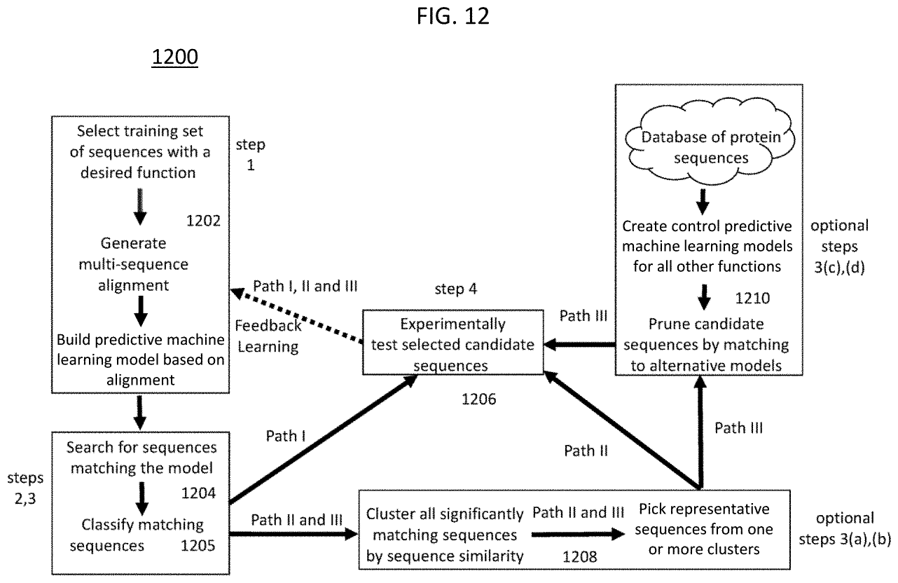

The system 100 can be configured to provide, perform, and/or execute any of the sequence selection/identification methods described herein. For example, FIG. 12 is a flowchart illustrating a method 1200 of identifying a distant ortholog of a target protein or gene. The method 1200 can be performed by the system 100 described above with reference to FIGS. 11A-11B or can be performed by any other suitable system and/or device. The processor configured to execute and/or perform the method 1200 can be included in an electronic device such as, for example, the electronic device 120 (e.g., the processor 124).

In some implementations, the processor can execute the predictive machine learning models on the one or more sequence databases. For example, in some embodiments, a sequence database (e.g., the metagenomic library 110 and/or the database 125) can be configured to provide one or more sequences. In some embodiments, an electronic device that includes the processor can receive the one or more sequences from the sequencing database and can develop and/or implement one or more predictive machine learning models on those sequences. For example, in some instances, the electronic device can be configured to generate one or more predictive machine learning models based at least in part on the one or more sequences. In some instances, the processor can execute the one or more predictive machine learning models on the one or more sequences retrieved from the sequence database, e.g., the metagenomic library 110.

In some embodiments, the processor uses input data to determine how the sequence selection method is carried out. In some embodiments, the user can provide input to the electronic device 120. In some embodiments, the input is the target function or sequence of the target protein/target gene for which variants are sought. In other instances, the processor can execute one or more instructions or code stored, for example, in the memory of the electronic device that can include a set of predefined rules and/or conditions that dictate and/or control how the sequence selection method is carried out.

In some embodiments, the processor sends to a high throughput screening device (e.g., the optional high throughput screening device 130) information about the candidate sequences, filtered candidate sequences, representative candidate sequences, and/or sequences selected for in vitro testing. In some embodiments, the processor sends the HTS device information about one or more of the sequences to be tested, the transformation conditions, the culture conditions, and the phenotypic performance to be measured.

The system 100 is described above as being configured to perform a sequence selection method such as, for example, the method 1200 or operations 1202, 1204, 1205, 1206, 1208, and 1210. However, in some implementations, the system 100 can be configured to perform any suitable functions associated with and/or in addition to a sequence selection method. For example, in some embodiments, the electronic device 120 and/or the processor 124 thereof can be configured to annotate sequence data, make sequence predictions, define new orthology groups, and the like. In some implementations, this data can be stored in the database 125 and/or metagenomics library 110 and retrieved when performing a new sequence selection method or host cell modification method. In some implementations, the data can be used to determine whether a given target protein or target gene is suitable for any of the sequence selection methods described herein. Moreover, in some implementations, the database 125 and/or memory 122 of the electronic device 120 can be configured to store historical data associated with predicted protein function, experimental phenotypic performances, sequence similarity, orthology groups, predictive models, and/or the like that can be used, for example, to expedite and/or improve the accuracy of further sequence selection methods. For example, in some implementations the processor 124 can be configured to select variants for a target protein or target gene and can compare data associated with historical data stored in the database 125 that is associated with other target proteins or target genes. As such, the system 100 can be configured to select sequences, and in some embodiments modify host cells, for any target protein or target gene.

Some embodiments described herein relate to a computer storage product with a non-transitory computer-readable medium (e.g., memories or one or more memories) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, an FPGA, an ASIC, and/or the like. Software modules (executed on hardware) can be expressed in a variety of software languages (e.g., computer code), including C, C++, Java™, Ruby, Visual Basic™, Python™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools, and/or combinations thereof (e.g., Python™). Additional examples of computer code include, but are not limited to, control signals, encrypted code, and compressed code.

### Genomic Automation

Automation of the methods of the present disclosure enables high-throughput phenotypic screening and identification of target products from multiple test strain variants simultaneously.

The aforementioned genomic engineering predictive modeling platform is premised upon the fact that hundreds and thousands of mutant strains are constructed in a high-throughput fashion. The robotic and computer systems described below are the structural mechanisms by which such a high-throughput process can be carried out.

In some embodiments, the present disclosure teaches methods of identifying distantly related orthologs of a target protein, or identifying genes capable of enabling a desired function. In some embodiments, the methods and systems of the present disclosure comprise manufacturing steps of host cells comprising candidate sequences. In some embodiments, the methods and systems further comprise methods of measuring phenotypic performance of manufactured cells. As part of this process, the present disclosure teaches methods of assembling DNA, building new strains, screening cultures in plates, and screening cultures in models for tank fermentation. In some embodiments, the present disclosure teaches that one or more of the aforementioned methods and systems of creating and testing new host strains is aided by automated robotics.

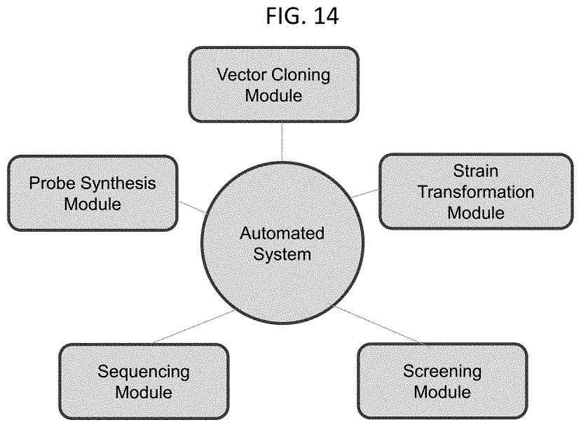

In some embodiments, the present disclosure teaches a high-throughput strain engineering platform as depicted in FIG. 14.

### HTP Robotic Systems (HTS-130)

In some embodiments, the automated methods of the disclosure comprise a robotic system. The systems outlined herein are generally directed to the use of 96- or 384-well microtiter plates, but as will be appreciated by those in the art, any number of different plates or configurations may be used. In addition, any or all of the steps outlined herein may be automated; thus, for example, the systems may be completely or partially automated.

In some embodiments, the automated systems of the present disclosure comprise one or more work modules. For example, in some embodiments, the automated system of the present disclosure comprises a DNA synthesis module, a vector cloning module, a strain transformation module, a screening module, and a sequencing module (see FIG. 14).

As will be appreciated by those in the art, an automated system can include a wide variety of components, including, but not limited to: liquid handlers; one or more robotic arms; plate handlers for the positioning of microplates; plate sealers, plate piercers, automated lid handlers to remove and replace lids for wells on non-cross contamination plates; disposable tip assemblies for sample distribution with disposable tips; washable tip assemblies for sample distribution; 96 well loading blocks; integrated thermal cyclers; cooled reagent racks; microtiter plate pipette positions (optionally cooled); stacking towers for plates and tips; magnetic bead processing stations; filtrations systems; plate shakers; barcode readers and applicators; and computer systems.

In some embodiments, the robotic systems of the present disclosure include automated liquid and particle handling enabling high-throughput pipetting to perform all the steps in the process of gene targeting and recombination applications. This includes liquid and particle manipulations such as aspiration, dispensing, mixing, diluting, washing, accurate volumetric transfers; retrieving and discarding of pipette tips; and repetitive pipetting of identical volumes for multiple deliveries from a single sample aspiration. These manipulations are cross-contamination-free liquid, particle, cell, and organism transfers. The instruments perform automated replication of microplate samples to filters, membranes, and/or daughter plates, high-density transfers, full-plate serial dilutions, and high capacity operation.

In some embodiments, the customized automated liquid handling system of the disclosure is a TECAN machine (e.g. a customized TECAN Freedom Evo).

In some embodiments, the automated systems of the present disclosure are compatible with platforms for multi-well plates, deep-well plates, square well plates, reagent troughs, test tubes, mini tubes, microfuge tubes, cryovials, filters, micro array chips, optic fibers, beads, agarose and acrylamide gels, and other solid-phase matrices or platforms are accommodated on an upgradeable modular deck. In some embodiments, the automated systems of the present disclosure contain at least one modular deck for multi-position work surfaces for placing source and output samples, reagents, sample and reagent dilution, assay plates, sample and reagent reservoirs, pipette tips, and an active tip-washing station.

In some embodiments, the automated systems of the present disclosure include high-throughput electroporation systems. In some embodiments, the high-throughput electroporation systems are capable of transforming cells in 96 or 384- well plates. In some embodiments, the high-throughput electroporation systems include VWR® High-throughput Electroporation Systems, BTX™, Bio-Rad® Gene Pulser MXcell™ or other multi-well electroporation system.

In some embodiments, the integrated thermal cycler and/or thermal regulators are used for stabilizing the temperature of heat exchangers such as controlled blocks or platforms to provide accurate temperature control of incubating samples from 0° C. to 100° C.

In some embodiments, the automated systems of the present disclosure are compatible with interchangeable machine-heads (single or multi-channel) with single or multiple magnetic probes, affinity probes, replicators or pipetters, capable of robotically manipulating liquid, particles, cells, and multi-cellular organisms. Multi-well or multi-tube magnetic separators and filtration stations manipulate liquid, particles, cells, and organisms in single or multiple sample formats.

In some embodiments, the automated systems of the present disclosure are compatible with camera vision and/or spectrometer systems. Thus, in some embodiments, the automated systems of the present disclosure are capable of detecting and logging color and absorption changes in ongoing cellular cultures.

In some embodiments, the automated system of the present disclosure is designed to be flexible and adaptable with multiple hardware add-ons to allow the system to carry out multiple applications. The software program modules allow creation, modification, and running of methods. The system's diagnostic modules allow setup, instrument alignment, and motor operations. The customized tools, labware, and liquid and particle transfer patterns allow different applications to be programmed and performed. The database allows method and parameter storage. Robotic and computer interfaces allow communication between instruments.

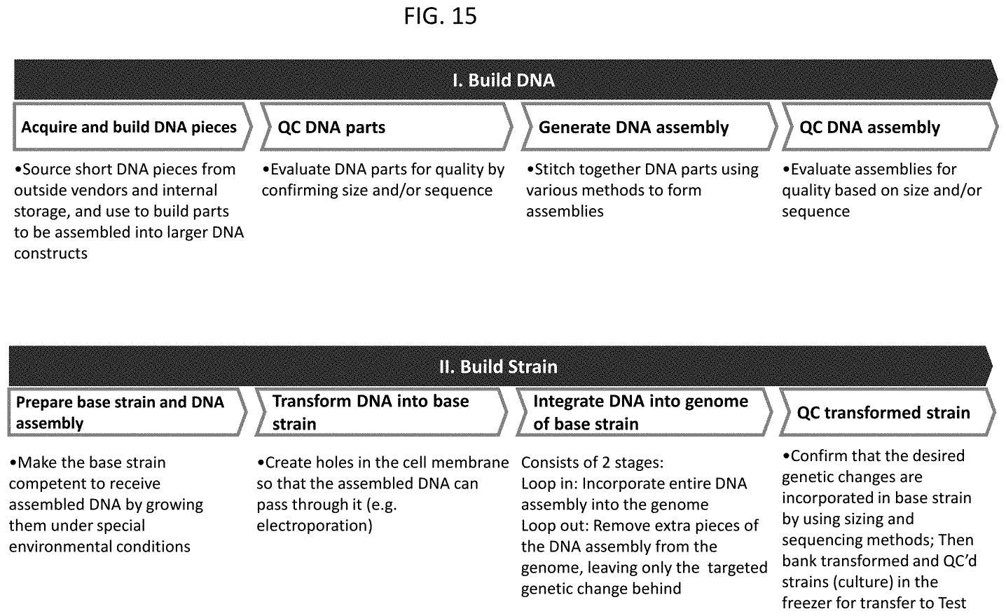

Thus, in some embodiments, the present disclosure teaches a high-throughput strain engineering platform, as depicted in FIG. 15.

Persons having skill in the art will recognize the various robotic platforms capable of carrying out the HTP engineering methods of the present disclosure. Table 3 below provides a non-exclusive list of scientific equipment capable of carrying out each step of the HTP engineering steps of the present disclosure as described in FIG. 15.

TABLE 3
Non-exclusive list of Scientific Equipment Compatible with
the HTP engineering methods of the present disclosure.

| | Equipment | | Compatible Equipment |
|---|---|---|---|
| | Type | Operation(s) performed | Make/Model/Configuration |
| Acquire and build | liquid handlers | Hitpicking (combining by | Hamilton Microlab STAR, |
| DNA pieces | | transferring) | Labcyte Echo 550, Tecan EVO |
| | | primers/templates for PCR | 200, Beckman Coulter Biomek |
| | | amplification of DNA | FX, or equivalents |
| | | parts | |
| | Thermal cyclers | PCR amplification of | Inheco Cycler, ABI 2720, ABI |
| | | DNA parts | Proflex 384, ABI Veriti, or |
| | | | equivalents |
| QC DNA parts | Fragment | gel electrophoresis to | Agilent Bioanalyzer, AATI |
| | analyzers | confirm PCR products of | Fragment Analyzer, or |
| | (capillary | appropriate size | equivalents |
| | electrophoresis) | | |
| | Sequencer | Verifying sequence of | Beckman Ceq-8000, Beckman |
| | (sanger: | parts/templates | GenomeLab ™, or equivalents |
| | Beckman) | | |
| | NGS (next | Verifying sequence of | Illumina MiSeq series |
| | generation | parts/templates | sequences, illumina Hi-Seq, Ion |
| | sequencing) | | torrent, pac bio or other |
| | instrument | | equivalents |
| | nanodrop/plate | assessing concentration of | Molecular Devices SpectraMax |
| | reader | DNA samples | M5, Tecan M1000, or |
| | | | equivalents. |
| Generate DNA | liquid handlers | Hitpicking (combining by | Hamilton Microlab STAR, |
| assembly | | transferring) DNA parts | Labcyte Echo 550, Tecan EVO |
| | | for assembly along with | 200, Beckman Coulter Biomek |
| | | cloning vector, addition of | FX, or equivalents |
| | | reagents for assembly | |
| | | reaction/process | |
| QC DNA assembly | Colony pickers | for inoculating colonies in | Scirobotics Pickolo, Molecular |
| | | liquid media | Devices QPix 420 |
| | liquid handlers | Hitpicking | Hamilton Microlab STAR, |
| | | primers/templates, diluting | Labcyte Echo 550, Tecan EVO |
| | | samples | 200, Beckman Coulter Biomek |
| | | | FX, or equivalents |
| | Fragment | gel electrophoresis to | Agilent Bioanalyzer, AATI |
| | analyzers | confirm assembled | Fragment Analyzer |
| | (capillary | products of appropriate | |
| | electrophoresis) | size | |
| | Sequencer | Verifying sequence of | ABI3730 Thermo Fisher, |
| | (sanger: | assembled plasmids | Beckman Ceq-8000, Beckman |
| | Beckman) | | GenomeLab ™, or equivalents |
| | NGS (next | Verifying sequence of | Illumina MiSeq series |
| | generation | assembled plasmids | sequences, illumina Hi-Seq, Ion |
| | sequencing) | | torrent, pac bio or other |
| | instrument | | equivalents |
| Prepare base strain | centrifuge | spinning/pelleting cells | Beckman Avanti floor |
| and DNA assembly | | | centrifuge, |
| | | | Hettich Centrifuge |
| Transform DNA into | Electroporators | electroporative | BTX Gemini X2, BIO-RAD |
| base strain | | transformation of cells | MicroPulser Electroporator |
| | Ballistic | ballistic transformation of | BIO-RAD PDS1000 |
| | transformation | cells | |
| | Incubators, | for chemical | Inheco Cycler, ABI 2720, ABI |
| | thermal cyclers | transformation/heat shock | Proflex 384, ABI Veriti, or |
| | | | equivalents |
| | Liquid handlers | for combining DNA, cells, | Hamilton Microlab STAR, |
| | | buffer | Labcyte Echo 550, Tecan EVO |
| | | | 200, Beckman Coulter Biomek |
| | | | FX, or equivalents |
| Integrate DNA into | Colony pickers | for inoculating colonies in | Scirobotics Pickolo, Molecular |
| genome of base strain | | liquid media | Devices QPix 420 |
| | Liquid handlers | For transferring cells onto | Hamilton Microlab STAR, |
| | | Agar, transferring from | Labcyte Echo 550, Tecan EVO |
| | | culture plates to different | 200, Beckman Coulter Biomek |
| | | culture plates (inoculation | FX, or equivalents |
| | | into other selective media) | |
| | Platform | incubation with shaking of | Kuhner Shaker ISF4-X, Infors- |
| | shaker- | microtiter plate cultures | ht Multitron Pro |
| | incubators | | |
| QC transformed strain | Colony pickers | for inoculating colonies in | Scirobotics Pickolo, Molecular |
| | | liquid media | Devices QPix 420 |
| | liquid handlers | Hitpicking | Hamilton Microlab STAR, |
| | | primers/templates, diluting | Labcyte Echo 550, Tecan EVO |
| | | samples | 200, Beckman Coulter Biomek |
| | | | FX, or equivalents |
| | Thermal cyclers | cPCR verification of | Inheco Cycler, ABI 2720, ABI |
| | | strains | Proflex 384, ABI Veriti, or |
| | | | equivalents |
| | Fragment | gel electrophoresis to | Infors-ht Multitron Pro, Kuhner |
| | analyzers | confirm cPCR products of | Shaker ISF4-X |
| | (capillary | appropriate size | |
| | electrophoresis) | | |
| | Sequencer | Sequence verification of | Beckman Ceq-8000, Beckman |
| | (sanger: | introduced modification | GenomeLab ™, or equivalents |
| | Beckman) | | |
| | NGS (next | Sequence verification of | Illumina MiSeq series |
| | generation | introduced modification | sequences, illumina Hi-Seq, Ion |
| | sequencing) | | torrent, pac bio or other |
| | instrument | | equivalents |
| Select and consolidate QC'd | Liquid handlers | For transferring from | Hamilton Microlab STAR, |
| strains into test plate | | culture plates to different | Labcyte Echo 550, Tecan EVO |
| | | culture plates (inoculation | 200, Beckman Coulter Biomek |
| | | into production media) | FX, or equivalents |
| | Colony pickers | for inoculating colonies in | Scirobotics Pickolo, Molecular |
| | | liquid media | Devices QPix 420 |
| | Platform | incubation with shaking of | Kuhner Shaker ISF4-X, Infors- |
| | shaker- | microtiter plate cultures | ht Multitron Pro |
| | incubators | | |
| Culture strains in | Liquid handlers | For transferring from | Hamilton Microlab STAR, |
| seed plates | | culture plates to different | Labcyte Echo 550, Tecan EVO |
| | | culture plates (inoculation | 200, Beckman Coulter Biomek |
| | | into production media) | FX, or equivalents |
| | Platform | incubation with shaking of | Kuhner Shaker ISF4-X, Infors- |
| | shaker- | microtiter plate cultures | ht Multitron Pro |
| | incubators | | |
| | liquid | Dispense liquid culture | Well mate (Thermo), |
| | dispensers | media into microtiter | Benchcel2R (velocity 11), |
| | | plates | plateloc (velocity 11) |
| | microplate | apply barcoders to plates | Microplate labeler (a2+ cab - |
| | labeler | | agilent), benchcell 6R |
| | | | (velocity11) |
| Generate product | Liquid handlers | For transferring from | Hamilton Microlab STAR, |
| from strain | | culture plates to different | Labcyte Echo 550, Tecan EVO |
| | | culture plates (inoculation | 200, Beckman Coulter Biomek |
| | | into production media) | FX, or equivalents |
| | Platform | incubation with shaking of | Kuhner Shaker ISF4-X, Infors- |
| | shaker- | microtiter plate cultures | ht Multitron Pro |
| | incubators | | |
| | liquid | Dispense liquid culture | well mate (Thermo), |
| | dispensers | media into multiple | Benchcel2R (velocity 11), |
| | | microtiter plates and seal | plateloc (velocity 11) |
| | | plates | |
| | microplate | Apply barcodes to plates | microplate labeler (a2+ cab - |
| | labeler | | agilent), benchcell 6R |
| | | | (velocity11) |
| Evaluate performance | Liquid handlers | For processing culture | Hamilton Microlab STAR, |
| | | broth for downstream | Labcyte Echo 550, Tecan EVO |
| | | analytical | 200, Beckman Coulter Biomek |
| | | | FX, or equivalents |
| | UHPLC, HPLC | quantitative analysis of | Agilent 1290 Series UHPLC |
| | | precursor and target | and 1200 Series HPLC with |
| | | compounds | UV and RI detectors, or |
| | | | equivalent; also any LC/MS |
| | LC/MS | highly specific analysis of | Agilent 6490 QQQ and 6550 |
| | | precursor and target | QTOF coupled to 1290 Series |
| | | compounds as well as side | UHPLC |
| | | and degradation products | |
| | Spectrophotometer | Quantification of different | Tecan M1000, spectramax M5, |
| | | compounds using | Genesys 10S |
| | | spectrophotometer based | |
| | | assays | |
| Culture strains | Fermenters: | incubation with shaking | Sartorius, DASGIPs |
| in flasks | | | (Eppendorf), BIO-FLOs |
| | | | (Sartorius-stedim). Applikon |
| | Platform | | innova 4900, or any equivalent |
| | shakers | | |
| Generate product | Fermenters: DASGIPs (Eppendorf), BIO-FLOs (Sartorius-stedim) | | |
| from strain | | | |
| Evaluate | Liquid handlers | For transferring from | Hamilton Microlab STAR, |
| performance | | culture plates to different | Labcyte Echo 550, Tecan EVO |
| | | culture plates (inoculation | 200, Beckman Coulter Biomek |
| | | into production media) | FX, or equivalents |
| | UHPLC, HPLC | quantitative analysis of | Agilent 1290 Series UHPLC |
| | | precursor and target | and 1200 Series HPLC with |
| | | compounds | UV and RI detectors, or |
| | | | equivalent; also any LC/MS |
| | LC/MS | highly specific analysis of | Agilent 6490 QQQ and 6550 |
| | | precursor and target | QTOF coupled to 1290 Series |
| | | compounds as well as side | UHPLC |
| | | and degradation products | |
| | Flow cytometer | Characterize strain | BD Accuri, Millipore Guava |
| | | performance (measure | |
| | | viability) | |
| | Spectrophotometer | Characterize strain | Tecan M1000, Spectramax M5, |
| | | performance (measure | or other equivalents |
| | | biomass) | |

### System Workflow

### Algorithmic Sequence Selection

### Overview

Embodiments of the disclosure that include algorithmic biological sequence selection provide an algorithmic, computer-implemented approach to select candidate sequences for performing an intended function. This approach substantially reduces the time required to determine optimal sequences and eliminates human error. It also enables continuous improvement of the tool's prediction accuracy via refinement of its predictive models based on the empirical data generated as a result of experimental validation of the sets of candidate sequences selected for in vitro validation.

Because of the ability to handle enormous data sets, embodiments employing algorithmic biological sequence selection may cause an exponential increase in potential candidate sequences. Embodiments of the disclosure address this issue by performing clustering and/or filtering to refine the selection of candidate sequences while maintaining the diversity of the sequence space.

Moreover, embodiments of the disclosure enable the identification of sequences that are statistically more similar to the desired function than manual approaches that rely on the functional human annotation of sequences.

More generally, embodiments of the disclosure may select sequences for enabling the performance of a desired function in a host cell. In addition to enzymes, such sequences may include, for example, transporters, transcription factors, and nucleic acid sequences that code for proteins such as enzymes for catalyzing reactions. In addition to an enzymatic reaction, functions may include facilitation or regulation of cellular processes such as gene transcription/translation, transport of molecules across membranes, and stabilization or degradation of molecules.

Embodiments of the disclosure identify candidate biological sequences for enabling a function in a host cell based upon sequences that are known or believed to enable the same or a similar function in different cells. The cells may, for example, be found in different species. In other cases, different sequences that carry out the same function in the same species, however, may exhibit different attributes that a scientist would find desirable for one purpose but not another.

### Operation

In some embodiments, the methods and systems herein include program code for identifying a candidate sequence for enabling a function in a host cell. The sequence may be an amino acid or a nucleic acid sequence. In some embodiments, the systems and methods may: access a predictive machine learning model that associates a plurality of sequences with one or more functions; predict, using the predictive machine learning model, that one or more candidate sequences accessed from a metagenomic library enable a desired function in the host cell; classify candidate sequences that satisfy a confidence threshold as filtered candidate sequences. In some embodiments, the systems and methods also include clustering the candidate sequences before or after the filtering step. In some embodiments, the systems and methods include clustering the candidate sequences after the filtering step. In some embodiments, the systems and methods include selecting representative sequences for in vitro testing. In some embodiments, the sequences are amino acid sequences for, e.g., enzymes for catalyzing reactions (the function being the enzyme-catalyzed reaction). In some embodiments the sequences are nucleic acid sequences for, e.g., transcription factor binding sites. The method or system may include the electronic device 120 providing to a gene manufacturing system or high throughput screening device 130 information concerning a candidate sequence, so that the gene manufacturing system or high throughput screening device 130 may use the candidate sequence to produce a molecule of interest.

FIG. 12 is a flow diagram illustrating the operation of embodiments of the disclosure according to a method 1200. Any reference to the method 1200 herein may also refer to the individual operations 1202, 1204, 1205, 1206, 1208, and 1210. Unless otherwise indicated, these operations may be performed by software residing in the electronic device 120. Although the description below concerns the identification of enzyme amino acid sequences, the same approach may be used to identify other sequences, as noted below.

According to embodiments of the disclosure, the electronic device 120 may perform the following operations:

Step 1 1202: obtaining the predictive machine learning model

The electronic device 120 may generate (or retrieve from an internal or external database) one or more predictive machine learning models trained on instances of protein or gene sequences experimentally verified, or predicted with a high degree of confidence, to carry out the desired function. Examples of functions are: enzymatic activity, transcription regulation, transport, structure, digestion, metabolic function, and the like. In some embodiments the training data set is provided by the user, and is saved in a database or other memory for ready access

In some embodiments, the predictive machine learning models are trained on and applied to genetic sequences (e.g., amino acid sequences). In some embodiments, the predictive machine learning models are trained on and applied to nucleic acid sequences that code for proteins. In some embodiments, the predictive machine learning models are trained on and applied to nucleic acid sequences. Further, functions represented by such models are not limited to enzymes of metabolic reactions, however, and may also, for example, refer to functions, such as DNA helicases, which are responsible for separating two strands of DNA or proteins, and other non-catalytic types of functions such as transcription factors, transporters, structural proteins, as well as nucleotide sequences that are not translated into peptides such as transfer RNAs, and small non-coding RNAs. In addition, one or multiple models can be generated for each functional activity that abstracts diversified information such as phylogeny, orthology, sequence similarity, enzyme subunits, and protein morphology. For example, in some embodiments, predictive machine learning models are generated for each orthology group comprising the target protein or target gene sequence. In some embodiments, predictive machine learning models are generated based on sequence similarity.

As used herein, “models,” “predictive models,” “machine learning models,” or “predictive machine learning models” include but are not limited to statistical models such as Hidden Markov Models (HMMs), dynamic Bayesian networks, artificial neural networks (ANNs) including recurrent neural networks such as those based on Long Short Term Memory Models (LSTM) as well as derivatives and generalizations thereof, and other machine learning-based models.

As an example of a predictive model, for step 1 of FIG. 12, the electronic device 120 may rely on HMM, which is a statistical model of multiple sequence alignments (MSAs). In bioinformatics, a sequence alignment is a way of arranging the sequences such as DNA, RNA, or protein, to identify regions of similarity that may be a consequence of functional, structural, and/or evolutionary relationships among the sequences. In evolutionary biology, conserved sequences are similar or identical (either in sequence or 3D structure) sequences in nucleic acids (DNA and RNA) or proteins across species (orthologous sequences) or within a genome (paralogous sequences). Conservation indicates that a sequence has been maintained by natural selection. Amino acid sequences can be conserved to maintain the structure or function of a protein or domain.

In some embodiments, the electronic device 120 may retrieve from the metagenomic library 110 or any sequence database, as described herein, a training data set of sequences known to, or predicted to, perform the same function as the target protein or target gene. The sequences may be found in different species. However, in some embodiments, not every amino acid in a protein sequence is important to performing the function. The observed frequency with which an amino acid occupies the same position in different protein sequences that perform the same function (the degree to which the amino acid is “conserved”) correlates to the likelihood that the amino acid enables performance of that function. In some embodiments, this is the basis for using an MSA to identify other enzyme sequences for performing a desired function. In some embodiments, the electronic device 120 employing an MSA model provides the output sequences along with a measure of the degree of confidence (based on the conservation of the sequences) that a sequence enables the desired function.

Conserved sequences may be identified by homology search, using traditional tools such as BLAST, HMMER and Infernal. Homology search tools may take an individual nucleic acid or protein sequence as input, or use statistical models generated from multiple sequence alignments of known related sequences. These tools however are typically only able to identify homologs/orthologs with high sequence identity.

The present disclosure teaches that statistical machine learning models, such as profile-HMMs, and RNA covariance models which also incorporate structural information, can be helpful when searching for more distantly related sequences. Input sequences are then aligned against a database, e.g., a metagenomic library, of sequences from related individuals or other species. The resulting alignments are then scored based on the number of matching amino acids or bases, and the number of gaps or deletions generated by the alignment. Acceptable conservative substitutions may be identified using substitution matrices such as PAM and BLOSUM. Highly scoring alignments are assumed to be from homologous sequences. The conservation of a sequence may then be inferred by detection of highly similar homologs over a broad phylogenetic range.

Identifying conserved sequences can be used to discover and predict functions of sequences such as proteins and genes. Conserved sequences with a known function, such as protein domains or motifs, can also be used to predict the function of a sequence. Databases of conserved protein domains or motifs such as Pfam and the Conserved Domain Database can be used to annotate functional domains or motifs of predicted proteins.

### Example Inputs and Outputs

Step 1 (1202)

Input step 1: a target protein, such as “tyrosine decarboxylase,” and a training set of sequences that are believed to perform the same function as this target protein (e.g., based on scientific publications, experimental data from a public or internal database or a computational prediction based on homology to sequences with experimental evidence of the required activity).

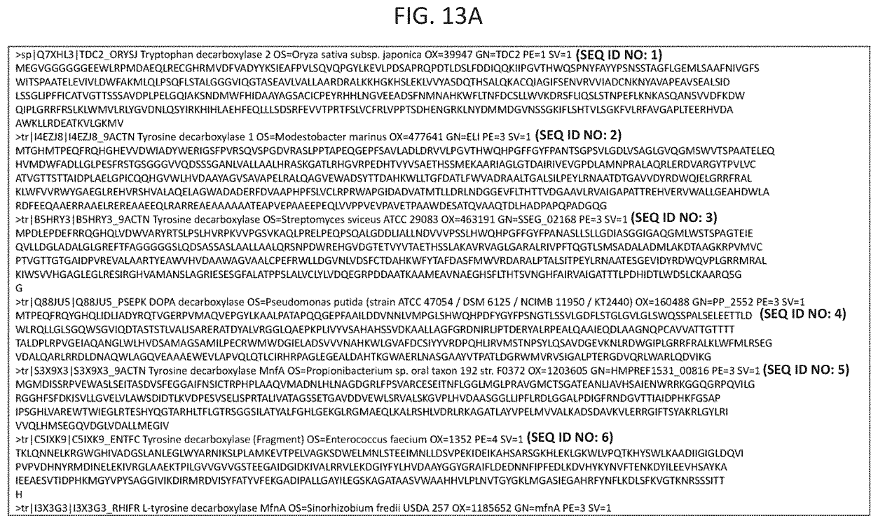

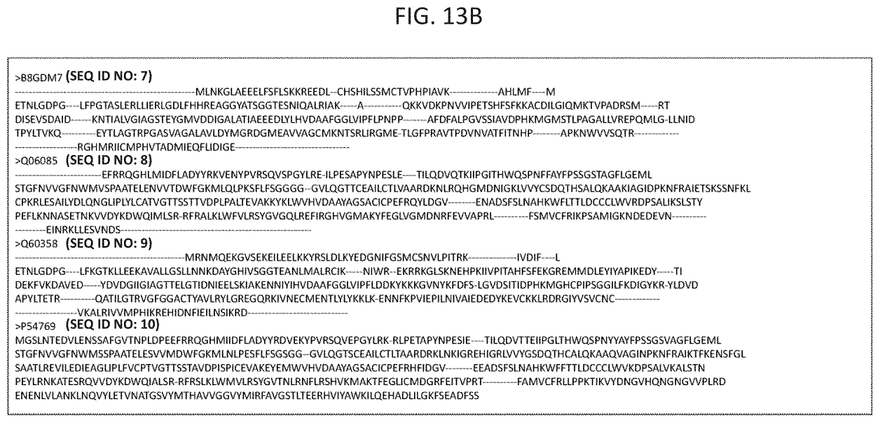

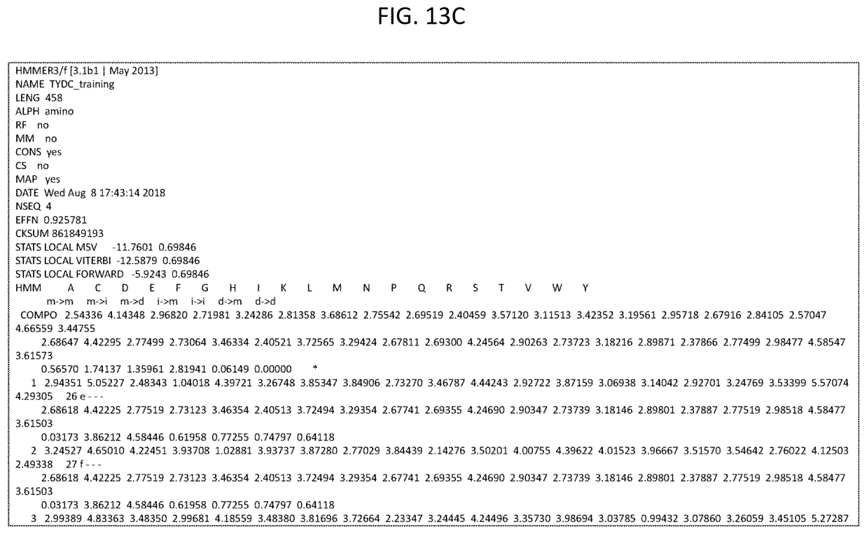

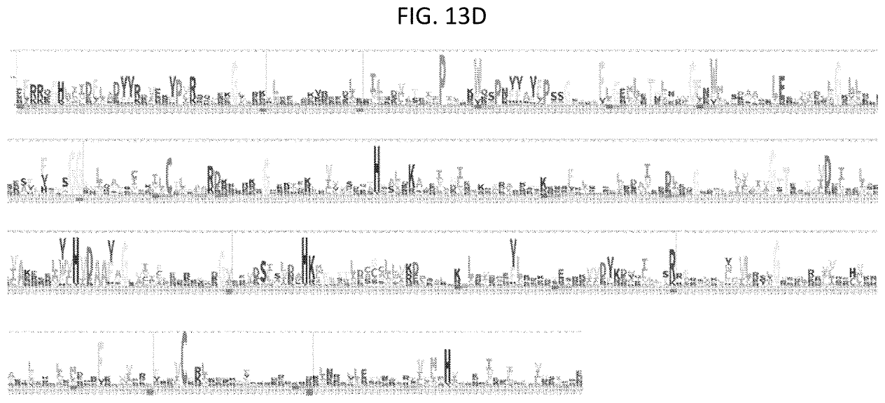

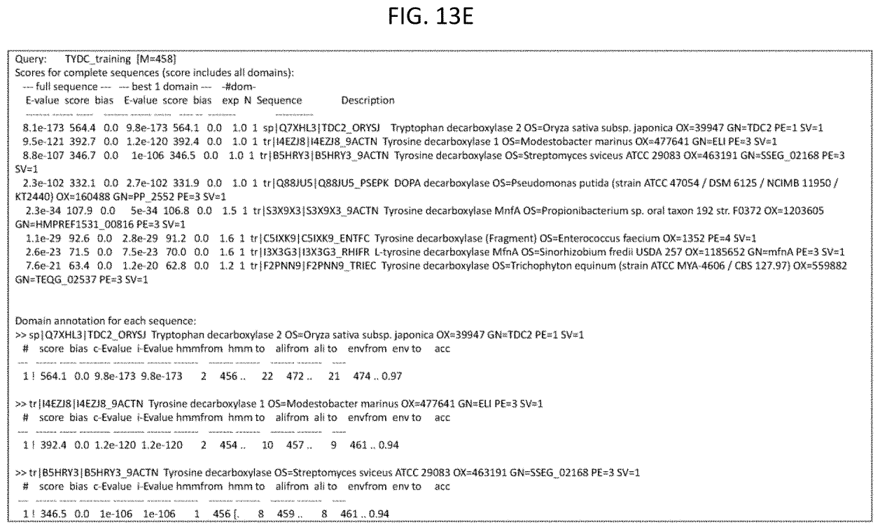

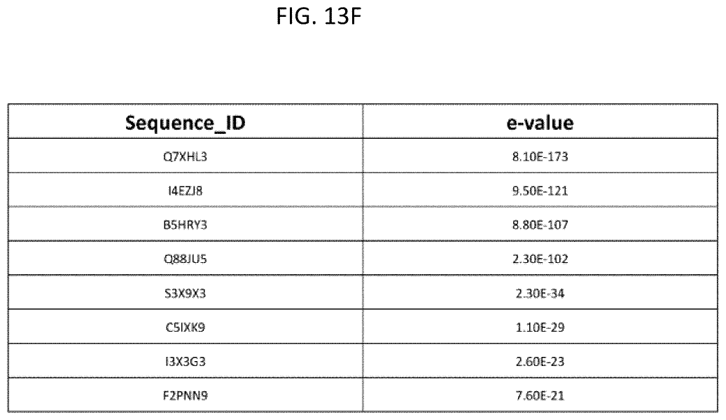

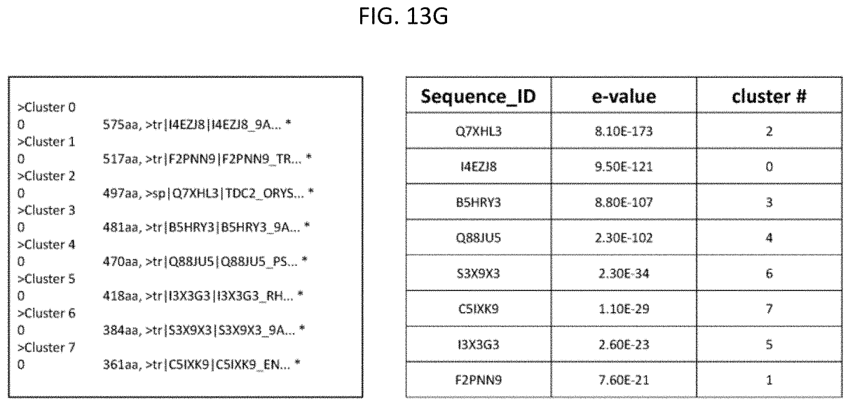

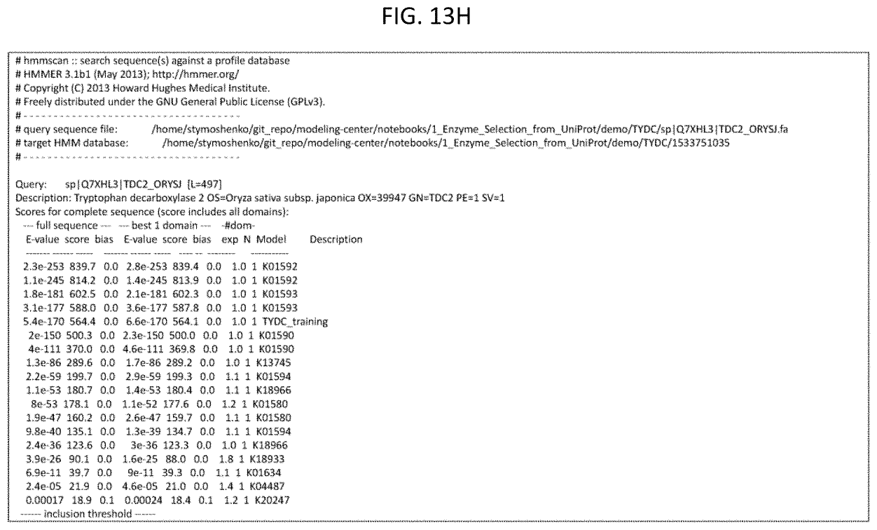

FIGS. 13A-H illustrate a prophetic example of identifying at least one sequence to enable tyrosine decarboxylase activity using predictive machine learning models, in this case HMMs, according to some embodiments of the disclosure. Interpretation of these figures may be aided by reference to Eddy, et al., “HMMER User's Guide: Biological sequence analysis using profile hidden Markov models,” Version 3.1b2; February 2015, incorporated by reference herein in its entirety.

FIG. 13A illustrates a snippet of an example FASTA file containing a training set of enzymes having tyrosine decarboxylase activity. The file contains the amino acid sequences of the training set of enzymes encoding for the reaction activity. Note that the annotations in the file indicate activity other than tyrosine decarboxylase, such as tryptophan decarboxylase, because the displayed annotations were derived from a commercially available database. However, predictive machine learning models employed in some embodiments of the disclosure determined that such sequences, in fact, enabled tyrosine decarboxylase activity. Thus, some embodiments of the disclosure enable correct recordation of annotations in otherwise incorrect publicly available databases.

Output step 1: multi-sequence alignment(s) of the sequences present in the training set and a model (or multiple models) representative of this alignment, including an indicator of the degree of confidence that a unit within the sequence (e.g., an amino acid) is related to the desired function (e.g., expectation value, probability that the unit is conserved at a given position within the sequence). FIG. 13B shows snippet of an output file showing such a multi-sequence alignment of the training set of sequences encoding for proteins performing the tyrosine decarboxylase function. An identifier (e.g., B8GDM7) following the “>” sign identifies an enzyme sequence, and the text below shows the corresponding sequence. In this example, spaces, as indicated by “-” in the amino acid sequences, indicate positions where a particular protein sequence does not align with the consensus alignment of all proteins in the training set of proteins. The consensus alignment is determined by optimal subsequences that are conserved, through similarity and/or identity, across all the sequences in the training set of proteins.

FIG. 13C shows a snippet of an output file of a Hidden Markov Model constructed from the multi-sequence alignment file shown in FIG. 13B, from which a skilled artisan can determine the degree of confidence that an amino acid within the sequence is related to the desired tyrosine decarboxylase activity (function). FIG. 13D shows a pictorial representation of the same statistical model for tyrosine decarboxylase activity, where the height of the each amino acid annotation represents the propensity of that particular amino acid in that position (represented on the x axis) to be related to the desired function of the overall enzyme.

Step 2 (1204): matching database of sequences to model

The electronic device 120 may perform a search for candidate sequences for enabling the function of interest using the model(s) trained in step 1, by comparing every sequence in a source database (such as a metagenomic library, Uniprot, KEGG, NCBI, JGI GOLD or a proprietary database of nucleotide or protein sequences) to the model(s) generated in step 1. Examples of the tools that could be used for this process are HMMsearch, HMMscan, or Recurrent Neural Networks designed for search by LSTM models.

Example Inputs and Outputs

Input step 2: the predictive machine learning model(s) trained on the training data set(s) of sequences with the desired function and a search database of sequences.

Output step 2: due to the size of the source databases, the electronic device 120 may output a set of sequences ranging from a few to 100,000 s (for just one reaction) that significantly match (with a high probability score) to the model(s) produced in step 1. FIG. 13E shows a snippet of an example output file of candidate sequences identified by the predictive machine learning model (HMM model) for tyrosine decarboxylase. In this example file, the confidence of the prediction by the HMM model that a particular sequence from a database performs the function of tyrosine decarboxylase is enumerated by the e-value metric. The lower the e-value of enzyme sequence, the higher the statistical confidence of a match to the model.

FIG. 13F shows an example of the processed table of candidate sequences from the raw output file for FIG. 13E that extracts the identifier of the sequence from the search database and the e-value of the match to the tyrosine decarboxylase HMM model sorted in ascending order of e-value. In this example, the enzyme sequence Q7XHL3 has the lowest e-value, and thus is ranked as the amino acid sequence most likely to enable tyrosine decarboxylase activity.

Embodiments of the disclosure provide further refinements to reduce the size of the data set.

Step 3 1205: filtering matching sequences

The electronic device 120 may classify the candidate sequences from step 2 based on threshold parameters (e.g., minimal probability score such as expect value (e-value), confidence score, or significance threshold) that may be determined by the user or another based on the intended purpose and trade-offs between precision and scope of the search or may be automatically generated by a program. For example, if step 2 results in a large number of sequences that enable the desired function with low degrees of confidence, a user may adjust a first confidence threshold so that the electronic device 120 eliminates sequences that do not satisfy that first threshold to result in a more manageable number of candidate sequences with higher confidence. The candidate sequences that satisfy the first confidence threshold (remaining in the pool of candidate sequences after step 3) may be referred to as “filtered candidate sequences” if the workflow follows Path I, shown in FIG. 12 and described below. If Path II or Path III is taken, then the candidate sequences that enter step 4 from optional step 3(b) or 3(d), respectively, may be referred to as “filtered candidate sequences.”

For example, depending on the size of the training set, size of the sequence database (e.g., metagenomic library), and number of candidate sequences found at step 2, as well as other factors, a user may set the minimal degree of confidence, e.g. expect-value, as permissive as 1E-10* or higher (to broaden the scope of the search by sacrificing precision), or, conversely, as strict as 1E-50** or lower to increase the precision with the caveat of a reduced scope.

*estimated one out of ten billion (10¹⁰) randomly-generated sequences would be a better match to the given model than the candidate sequence with the e-value 1E-10

**estimated one out of 10⁵⁰ randomly-generated sequences would be a better match to the given model than the candidate sequence with the e-value 1E-50.

Example Inputs and Outputs

Input step 3: One or more candidate sequences predicted by the predictive machine learning model(s) to perform the function of interest.

Output Step 3: A subset of (filtered) candidate sequences predicted by the predictive machine learning model(s) to perform the function of interest and which satisfy a user-defined minimal, first degree of confidence threshold.

Step 4 1206: refining predictive model

The candidate sequences that satisfy the first confidence threshold in step 3 may be synthesized and tested to ascertain empirically if they enable the desired function as predicted by the model, e.g., through the use of a gene synthesis device or high throughput screening device 130. (The same operations may be performed on the candidate sequences resulting from optional Paths II and III, which are described below.) This test can be performed as an in vitro enzyme assay, or via incorporation of the sequences into host(s) through, but not limited to, gene editing (e.g., CRISPR), chromosomal integration, or replicated plasmids. For those sequences that produced the desired function under the particular experimental conditions, the electronic device 120 may record the result in the model database (e.g., metagenomic library 110 or database 125). For those sequences where the desired function was not detectable, the electronic device 120 may also record that result in the metagenomic library 110 or database 125. The electronic device 120 may use these records to expand/refine the set of training sequences for the predictive machine learning model(s) representing this function as the “positive” and “negative” training set/examples.

A change in the experimental setting (such as a change in the host cell or growth media) may change the empirical outcomes. For example, not all sequences may produce the desired function in all possible conditions, e.g., in certain stress conditions. The electronic device 120 may record this result in the metagenomic library 110 or database 125 such that subsequent searches with the same combination of host and experimental conditions would exclude the negative examples.

The number of sequences chosen to be validated experimentally may be limited by available throughput. In a high-throughput factory-like setting, in principle, many sequences could be tested simultaneously for the same functionality. The “re-training,” via feedback loop, of the models based on positive and negative outcomes observed enhances the predictive power and precision of the models with every select-test-retrain cycle (illustrated as part of Paths I, II and III in FIG. 12). To this end, automated, high-throughput experiments can yield large and consistent training sets, thereby enabling retraining in a consistent manner that is robust to occasional errors and biological variability.

Example Inputs and Outputs

Input step 4: candidate sequences to be validated.

Output step 4: recorded results of experimental validation in metagenomic library to update predictive model.

Optional steps 3(a) and 3(b) 1208: clustering

In some embodiments, the candidate sequences to be validated experimentally may be narrowed by the use of, e.g., clustering as described herein. Clustering may be used to group candidate sequences in clusters from which a representative number of candidate sequences may be selected. In some embodiments, only a small number of sequences are selected for experimental validation from each cluster. In some embodiments, only 0 or 1 sequences are selected from each cluster for experimental validation. Referring to FIG. 12, steps 1, 2, 3 and 4 described above follow the arrows labeled with “Path I.” FIG. 12 also illustrates optional Paths II and III, which may be performed to further refine the filtered candidate sequences, according to some embodiments of the disclosure. The candidate sequences resulting from Paths II and III, like those from Path I, are subject to step 4, according to some embodiments of the disclosure.

Path II includes steps 3(a) and 3(b) 1208. In some embodiments, the electronic device 120 may (e.g., if the user elects) take additional steps 3(a) and 3(b) before step 4 to diversify the candidate sequences that satisfy the first confidence threshold.

Step 3(a) 1208: The electronic device 120 may perform statistical clustering (based on, for example, sequence similarity, or t-Distributed Stochastic Neighbor Embedding) on the candidate sequences that satisfy the first confidence threshold. The electronic device 120 may record which sequences are sufficiently similar to appear in the same cluster. For example, using the CD-HIT clustering algorithm, the electronic device 120 may denote sequences as belonging to the same cluster if they exceed a 38%-99% sequence identity threshold. This value is a user-defined parameter that reflects the maximal degree of identity among the sequences, which a user allows to include in the final filtered set of candidates. In the left table, FIG. 13G shows a snippet of the raw output file resulting from clustering all HMM sequence hits for tyrosine decarboxylase. All the HMM sequence hits are clustered using an example sequence identity threshold of 70%. The figure shows a snippet of the file that lists the cluster number and the sequence identifiers of all the sequences that lie within that cluster. (In this snippet, the full list of sequence identifiers is truncated as indicated by the asterisks.) In this manner, a user can address the challenge of evenly exploring candidate sequences when their number exceeds the experimental capacity for testing all the candidates.

Optional step 3(b) 1208: selecting sequence(s) from the clusters

The electronic device 120 may select one or more sequences from each cluster. The number of sequences selected may depend upon the number of clusters, which in turn depends on the user-defined sequence identity threshold as well as the overall “sequence diversity” within the set of candidate sequences prior to the clustering. Selection of a particular candidate sequence(s) from each cluster may be informed by the degree of confidence (e.g. the e-value of the match to the corresponding model). This ensures that not only a diversified set of candidates are selected for each function/reaction but also that the candidates with the highest likelihood of desired function are prioritized. FIG. 13G (right table) shows the example processed table output of sub-selected sequences where only the sequence with lowest e-value is selected from each cluster, after clustering step 3(a). The table shows the identifiers of those enzymes, the e-value of the prediction by the predictive machine learning model (HMM) for tyrosine decarboxylase, and the cluster number in which it fell, which is generated by parsing the output file in the left table of the figure. The right table shows the sorted sequences by increasing e-value (i.e., decreasing confidence).

Optional steps 3(c) and 3(d) 1208: eliminating candidate sequences that have affinity toward alternative functions

Path III includes steps 3(c) and 3(d) 1210. In some embodiments, the electronic device 120 may (e.g., if the user elects), take additional steps 3(c) and 3(d) before step 4 to reduce the likelihood that the candidate sequences that satisfy the first confidence threshold represent undesired functions. In some embodiments, steps 3(c) and 3(d) may be chosen only if the confidence scores of the candidate sequences that satisfy the first confidence threshold are above or below a second threshold. In some embodiments, steps 3(c) and 3(d) are chosen to increase the likelihood that the candidate sequences perform the desired target protein/gene function.

Optional step 3(c): creating data set of models for other functions

In some embodiments, the electronic device 120 may prepare at least one secondary predictive machine learning model or a database of control predictive machine learning models that represent other functions for which such model(s) can be constructed, e.g., KEGG orthology groups that are associated with at least one sequence that has been empirically observed to carry out a corresponding function.

Optional step 3(d): eliminating candidate sequences that have affinity toward alternative functions

In some embodiments, the electronic device 120 may prevent classification, as a filtered candidate sequence, of a candidate sequence that satisfies the first confidence threshold but that is more likely, within a given tolerance (e.g. between 0.5 and 1, where 1 represents no tolerance to the possibility of an alternative function), to enable a function different from the desired function. To do so, the electronic device 120 may compare (e.g.,. using HMMscan) each candidate sequence resulting from step 3 (satisfying the first confidence threshold, e.g., 0.8) to each of the models stored in the database in step 3(c), to find and eliminate sequences that have a higher confidence score (given the tolerance parameter) for any function other than the desired function. FIG. 13H shows a snippet of an example output file of filtering clustered hits against other Hidden Markov Models representing a varied array of reaction activities. In this example, the Model Identifiers represent KEGG orthology groups that represent a particular reaction activity. For each identified sequence, the figure shows the expectation-value with which the sequence matches to the HMMs in the scanning database of different activities. The expectation score of the identified sequence to the desired activity (tyrosine decarboxylase shown as TYDC_training) in relation to those of other activities quantifies how specific the sequence is for the desired activity. For example, for the sequence Q7XHL3, the desired tyrosine decarboxylase activity is not the activity with the least e-value, and hence, may not be the best candidate sequence to test.

A user-defined tolerance parameter may be used to set a limit as to how much the confidence that a candidate sequence produces a desired function is allowed to fall below a confidence that it also produces an undesired function. The electronic device 120 may compare the confidence that a given candidate sequence enables a desired function to the confidence levels that the candidate sequence enables any other known functions stored in a database, according to their predictive models. This tolerance parameter allows the user to address cases where a candidate sequence may be predicted to match multiple functions (represented by models) with varying degrees of confidence, and the user would like to ensure that the model representing the desired function is one of the best matches (if not the best match) for the candidate sequence. For example, this tolerance can be a ratio of the (log of the e-value assigned to the prediction that the sequence performs the desired function) divided by the (log of the lowest e-value found when evaluated by the database of all control predictive machine learning models). In that instance, if the best-matching model is also the one representing the desired function, the ratio will be 1. If the target protein/target gene e-value is not included in the denominator, the ratio may be higher than 1. In all other cases, ratios lower than 1 would denote decreased confidence about the given candidate sequence having the desired function and not the function represented by the model which is the best match (e.g., the once with the lowest e-value). In some embodiments, the tolerance can be a ratio of the bit scores, e.g., (target protein/target gene bit score)/(best match bit score). Similarly, a value below 1 would indicate decreased confidence that the candidate sequence performs the target function. However, the threshold or cutoff employed may allow for a certain degree of flexibility in including candidate sequences that have a certain likelihood of performing the target function, even if they received a higher confidence score from a secondary predictive machine learning model.

Example Based on Experimental Data

Using the sequence selection process essentially as illustrated by FIG. 12, path III (i.e., all the steps except the feedback learning), between 48 and 72 candidate sequences were selected for 3 enzymatic functions of interest from a meta-genomic collection of protein sequences. In the same manner 72 candidate sequences were also selected for a small-molecule exporter function of interest. Notably, all four functions were native to the microbe in which selected sequences were tested, but were deemed of interest based on the assumption that they may be limiting for production of the target molecule or its export from the cells.

Each one of the selected protein sequences was back-translated into a coding DNA sequence, synthesized and inserted in the genome of the microbe, which was already a highly-effective industrial producer of the molecule of interest. These modified microbes were tested for the improvement in production of the specific molecule in terms of two phenotypes of interest: (1) speed of production in gram per L per hour (e.g., productivity); (2) overall substrate-to-product conversion efficiency in gram per gram (e.g., yield). Multiple sequences representing two of the three enzymatic functions and one exporter function resulted in a statistically significant improvement of over 1% for at least one of the two phenotypes of interest. In such a highly-optimized, industrially-used microbe it would be rare to observe any change that improved one of the phenotypes without a detrimental effect on the other one. Nevertheless, multiple of the candidate sequences conferred such an improvement. To measure phenotypic improvement, each of the algorithmically-selected sequences was engineered individually into the host microbe, and then the resulting phenotypic improvement was evaluated.

This experiment demonstrated utility of the workflow illustrated by FIG. 12 for finding highly efficacious candidate sequences for enzymatic and exporter functions even from a large meta-genome that consists of only predicted protein sequences without any functional annotations. The improvements in this example were obtained without the feedback learning of embodiments of the disclosure. Thus, one would expect feedback learning to result in prediction of sequences with even greater improvement.

### Sequences

The following sequences, listed in Table 4, were employed in the foregoing system workflow example.

TABLE 4
Sequences employed in
exemplary system workflow.

| SEQ | | |
|---|---|---|
| ID | | |
| NO | Organism | Sequence |
| 1 | Oryza sativa | MEGVGGGGGGEEWLRPMDAEQ |
| | | LRECGHRMVDFVADYYKSIEA |
| | | FPVLSQVQPGYLKEVLPDSAP |
| | | RQPDTLDSLFDDIQQKIIPGV |
| | | THWQSPNYFAYYPSNSSTAGF |
| | | LGEMLSAAFNIVGFSWITSPA |
| | | ATELEVIVLDWFAKMLQLPSQ |
| | | FLSTALGGGVIQGTASEAVLV |
| | | ALLAARDRALKKHGKHSLEKL |
| | | VVYASDQTHSALQKACQIAGI |
| | | FSENVRVVIADCNKNYAVAPE |
| | | AVSEALSIDLSSGLIPFFICA |
| | | TVGTTSSSAVDPLPELGQIAK |
| | | SNDMWFHIDAAYAGSACICPE |
| | | YRHHLNGVEEADSFNMNAHKW |
| | | FLTNFDCSLLWVKDRSFLIQS |
| | | LSTNPEFLKNKASQANSVVDF |
| | | KDWQIPLGRRFRSLKLWMVLR |
| | | LYGVDNLQSYIRKHIHLAEHF |
| | | EQLLLSDSRFEVVTPRTFSLV |
| | | CFRLVPPTSDHENGRKLNYDM |
| | | MDGVNSSGKIFLSHTVLSGKF |
| | | VLRFAVGAPLTEERHVDAAWK |
| | | LLRDEATKVLGKMV |
| 2 | Modestobacter | MTGHMTPEQFRQHGHEVVDWI |
| | marinus | ADYWERIGSFPVRSQVSPGDV |
| | | RASLPPTAPEQGEPFSAVLAD |
| | | LDRVVLPGVTHWQHPGFFGYF |
| | | PANTSGPSVLGDLVSAGLGVQ |
| | | GMSWVTSPAATELEQHVMDWF |
| | | ADLLGLPESFRSTGSGGGVVQ |
| | | DSSSGANLVALLAALHRASKG |
| | | ATLRHGVRPEDHTVYVSAETH |
| | | SSMEKAARIAGLGTDAIRIVE |
| | | VGPDLAMNPRALAQRLERDVA |
| | | RGYTPVLVCATVGTTSTTAID |
| | | PLAELGPICQQHGVWLHVDAA |
| | | YAGVSAVAPELRALQAGVEWA |
| | | DSYTTDAHKWLLTGFDATLFW |
| | | VADRAALTGALSILPEYLRNA |
| | | ATDTGAVVDYRDWQIELGRRF |
| | | RALKLWFVVRWYGAEGLREHV |
| | | RSHVALAQELAGWADADERFD |
| | | VAAPHPFSLVCLRPRWAPGID |
| | | ADVATMTLLDRLNDGGEVFLT |
| | | HTTVDGAAVLRVAIGAPATTR |
| | | EHVERVWALLGEAHDWLARDF |
| | | EEQAAERRAAELREREAAEEQ |
| | | LRARREAEAAAAAATEAPVEP |
| | | AAEEPEQLVVPPVEVPAVETP |
| | | AAWDESATQVAAQTDLHADPA |
| | | PQPADGQG |
| 3 | Streptomyces | MPDLEPDEFRRQCHQLVDWVA |
| | sviceus | RYRTSLPSLHVRPKVVPGSVK |
| | | AQLPRELPEQPSQALGDDLIA |
| | | LLNDVVVPSSLHWQHPGFFGY |
| | | FPANASLLSLLGDIASGGIGA |
| | | QGMLWSTSPAGTEIEQVLLDG |
| | | LADALGLGREFTFAGGGGGSL |
| | | QDSASSASLAALLAALQRSNP |
| | | DWREHGVDGTETVYVTAETHS |
| | | SLAKAVRVAGLGARALRIVPF |
| | | TQGTLSMSADALADMLAKDTA |
| | | AGKRPVMVCPTVGTTGTGAID |
| | | PVREVALAARTYEAWVHVDAA |
| | | WAGVAALCPEFRWLLDGVNLV |
| | | DSFCTDAHKWFYTAFDASFMW |
| | | VRDARALPTALSITPEYLRNA |
| | | ATESGEVIDYRDWQVPLGRRM |
| | | RALKIWSVVHGAGLEGLRESI |
| | | RGHVAMANSLAGRIESESGFA |
| | | LATPPSLALVCLYLVDQEGRP |
| | | DDAATKAAMEAVNAEGHSFLT |
| | | HTSVNGHFAIRVAIGATTTLP |
| | | DHIDTLWDSLCKAARQSGG |
| 4 | Pseudomonas | MTPEQFRQYGHQLIDLIADYR |
| | putida | QTVGERPVMAQVEPGYLKAAL |
| | | PATAPQQGEPFAAILDDVNNL |
| | | VMPGLSHWQHPDFYGYFPSNG |
| | | TLSSVLGDFLSTGLGVLGLSW |
| | | QSSPALSELEETTLDWLRQLL |
| | | GLSGQWSGVIQDTASTSTLVA |
| | | LISARERATDYALVRGGLQAE |
| | | PKPLIVYVSAHAHSSVDKAAL |
| | | LAGFGRDNIRLIPTDERYALR |
| | | PEALQAAIEQDIAAGNQPCAV |
| | | VATTGTTTTTALDPLRPVGEI |
| | | AQANGLWLHVDSAMAGSAMIL |
| | | PECRWMWDGIELADSVVVNAH |
| | | KWLGVAFDCSIYYVRDPQHLI |
| | | RVMSTNPSYLQSAVDGEVKNL |
| | | RDWGIPLGRRFRALKLWFMLR |
| | | SEGVDALQARLRRDLDNAQWL |
| | | AGQVEAAAEWEVLAPVQLQTL |
| | | CIRHRPAGLEGEALDAHTKGW |
| | | AERLNASGAAYVTPATLDGRW |
| | | MVRVSIGALPTERGDVQRLWA |
| | | RLQDVIKG |
| 5 | Propionibacterium | MGMDISSRPVEWASLSEITAS |
| | sp. | DVSFEGGAIFNSICTRPHPLA |
| | | AQVMADNLHLNAGDGRLFPSV |
| | | ARCESEITNFLGGLMGLPRAV |
| | | GMCTSGATEANLIAVHSAIEN |
| | | WRRKGGQGRPQVILGRGGHFS |
| | | FDKISVLLGVELVLAWSDIDT |
| | | LKVDPESVSELISPRTALIVA |
| | | TAGSSETGAVDDVEWLSRVAL |
| | | SKGVPLHVDAASGGLLIPFLR |
| | | DLGGALPDIGFRNDGVTTIAI |
| | | DPHKFGSAPIPSGHLVAREWT |
| | | WIEGLRTESHYQGTARHLTFL |
| | | GTRSGGSILATYALFGHLGEK |
| | | GLRGMAEQLKALRSHLVDRLR |
| | | KAGATLAYVPELMVVALKADS |
| | | DAVKVLERRGIFTSYAKRLGY |
| | | LRIVVQLHMSEGQVDGLVDAL |
| | | LMEGIV |
| 6 | Enterococcus | TKLQNNELKRGWGHIVADGSL |
| | faecium | ANLEGLWYARNIKSLPLAMKE |
| | | VTPELVAGKSDWELMNLSTEE |
| | | IMNLLDSVPEKIDEIKAHSAR |
| | | SGKHLEKLGKWLVPQTKHYSW |
| | | LKAADIIGIGLDQVIPVPVDH |
| | | NYRMDINELEKIVRGLAAEKT |
| | | PILGVVGVVGSTEEGAIDGID |
| | | KIVALRRVLEKDGIYFYLHVD |
| | | AAYGGYGRAIFLDEDNNFIPF |
| | | EDLKDVHYKYNVFTENKDYIL |
| | | EEVHSAYKAIEEAESVTIDPH |
| | | KMGYVPYSAGGIVIKDIRMRD |
| | | VISYFATYVFEKGADIPALLG |
| | | AYILEGSKAGATAASVWAAHH |
| | | VLPLNVTGYGKLMGASIEGAH |
| | | RFYNFLKDLSFKVGTKNRSSS |
| | | ITTH |
| 7 | Methanosphaerula | MLNKGLAEEELFSFLSKKREE |
| | palustris | DLCHSHILSSMCTVPHPIAVK |
| | | AHLMFMETNLGDPGLFPGTAS |
| | | LERLLIERLGDLFHHREAGGY |
| | | ATSGGTESNIQALRIAKAQKK |
| | | VDKPNVVIPETSHFSFKKACD |
| | | ILGIQMKTVPADRSMRTDISE |
| | | VSDAIDKNTIALVGIAGSTEY |
| | | GMVDDIGALATIAEEEDLYLH |
| | | VDAAFGGLVIPFLPNPPAFDF |
| | | ALPGVSSIAVDPHKMGMSTLP |
| | | AGALLVREPQMLGLLNIDTPY |
| | | LTVKQEYTLAGTRPGASVAGA |
| | | LAVLDYMGRDGMEAVVAGCMK |
| | | NTSRLIRGMETLGFPRAVTPD |
| | | VNVATFITNHPAPKNWVVSQT |
| | | RRGHMRIICMPHVTADMIEQF |
| | | LIDIGE |
| 8 | Petroselinum | EFRRQGHLMIDFLADYYRKVE |
| | crispum | NYPVRSQVSPGYLREILPESA |
| | | PYNPESLETILQDVQTKIIPG |
| | | ITHWQSPNFFAYFPSSGSTAG |
| | | FLGEMLSTGFNWGFNVVMVSP |
| | | AATELENVVTDWFGKMLQLPK |
| | | SFLFSGGGGGVLQGTTCEAIL |
| | | CTLVAARDKNLRQHGMDNIGK |
| | | LVVYCSDQTHSALQKAAKIAG |
| | | IDPKNFRAIETSKSSNFKLCP |
| | | KRLESAILYDLQNGLIPLYLC |
| | | ATVGTTSSTTVDPLPALTEVA |
| | | KKYKLWVHVDAAYAGSACICP |
| | | EFRQYLDGVENADSFSLNAHK |
| | | WFLTTLDCCCLWVRDPSALIK |
| | | SLSTYPEFLKNNASETNKVVD |
| | | YKDWQIMLSRRFRALKLWFVL |
| | | RSYGVGQLREFIRGHVGMAKY |
| | | FEGLVGMDNRFEVVAPRLFSM |
| | | VCFRIKPSAMIGKNDEDEVNE |
| | | INRKLLESVNDS |
| 9 | Methanocaldococcus | MRNMQEKGVSEKEILEELKKY |
| | jannaschii | RSLDLKYEDGNIFGSMCSNVL |
| | | PITRKIVDIFLETNLGDPGLF |
| | | KGTKLLEEKAVALLGSLLNNK |
| | | DAYGHIVSGGTEANLMALRCI |
| | | KNIWREKRRKGLSKNEHPKII |
| | | VPITAHFSFEKGREMMDLEYI |
| | | YAPIKEDYTIDEKFVKDAVED |
| | | YDVDGIIGIAGTTELGTIDNI |
| | | EELSKIAKENNIYIHVDAAFG |
| | | GLVIPFLDDKYKKKGVNYKFD |
| | | FSLGVDSITIDPHKMGHCPIP |
| | | SGGILFKDIGYKRYLDVDAPY |
| | | LTETRQATILGTRVGFGGACT |
| | | YAVLRYLGREGQRKIVNECME |
| | | NTLYLYKKLKENNFKPVIEPI |
| | | LNIVAIEDEDYKEVCKKLRDR |
| | | GIYVSVCNCVKALRIVVMPHI |
| | | KREHIDNFIEILNSIKRD |
| 10 | Papaver somniferum | MGSLNTEDVLENSSAFGVTNP |
| | | LDPEEFRRQGHMIIDFLADYY |
| | | RDVEKYPVRSQVEPGYLRKRL |
| | | PETAPYNPESIETILQDVTTE |
| | | IIPGLTHWQSPNYYAYFPSSG |
| | | SVAGFLGEMLSTGFNVVGFNW |
| | | MSSPAATELESVVMDWFGKML |
| | | NLPESFLFSGSGGGVLQGTSC |
| | | EAILCTLTAARDRKLNKIGRE |
| | | HIGRLVVYGSDQTHCALQKAA |
| | | QVAGINPKNFRAIKTFKENSF |
| | | GLSAATLREVILEDIEAGLIP |
| | | LFVCPTVGTTSSTAVDPISPI |
| | | CEVAKEYEMWVHVDAAYAGSA |
| | | CICPEFRHFIDGVEEADSFSL |
| | | NAHKWFFTTLDCCCLWVKDPS |
| | | ALVKALSTNPEYLRNKATESR |
| | | QVVDYKDWQIALSRRFRSLKL |
| | | WMVLRSYGVTNLRNFLRSHVK |
| | | MAKTFEGLICMDGRFEITVPR |
| | | TFAMVCFRLLPPKTIKVYDNG |
| | | VHQNGNGVVPLRDENENLVLA |
| | | NKLNQVYLETVNATGSVYMTH |
| | | AVVGGVYMIRFAVGSTLTEER |
| | | HVIYAWKILQEHADLILGKFS |
| | | EADFSS |

Those skilled in the art will understand that some or all of the elements of embodiments of the disclosure, and their accompanying operations, may be implemented wholly or partially by one or more computer systems including one or more processors and one or more memory systems. Some elements and functionality may be implemented locally and others may be implemented in a distributed fashion over a network through different servers, e.g., in client-server fashion, for example. In particular, server-side operations may be made available to multiple clients in a software as a service (SaaS) fashion.

The present description is made with reference to the accompanying drawings and Examples, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive “or” in the manner of “and/or.”

Those skilled in the art will recognize that, in some embodiments, some of the operations described herein may be performed by human implementation, or through a combination of automated and manual means. When an operation is not fully automated, appropriate components of embodiments of the disclosure may, for example, receive the results of human performance of the operations rather than generate results through its own operational capabilities.

### EXAMPLES

### Example 1: Identification of Genetically Dissimilar Protein Variants for Improved Host Strain Phenotypic Performance

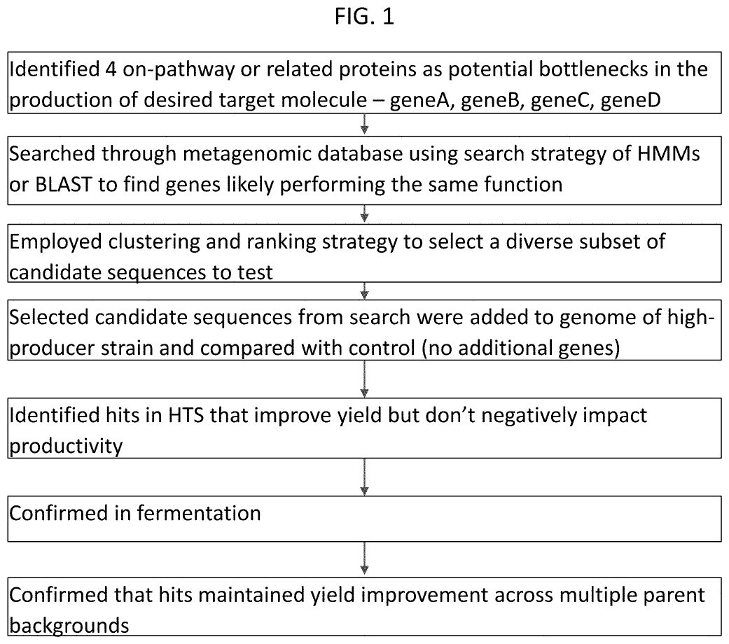

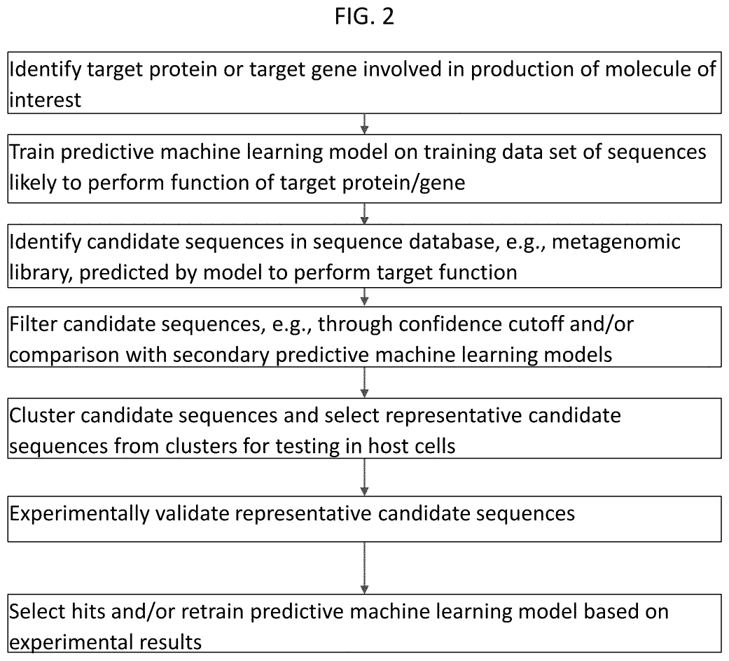

This example employs the machine learning methods and systems of the present disclosure to identify a gene capable of enabling the desired function of production of a target molecule of interest, (“MOI”) The process followed by this example is illustrated in FIG. 1, which is a specific implementation of the general method depicted in FIG. 2. Four proteins performing functions of interest were identified as potential metabolic bottlenecks, i.e. limiting, for faster and/or more complete conversion of carbon source feed (e.g., media) into the MOI. The possibility of “debottlenecking” was explored by identifying and testing other heterologous, i.e. non-native, versions of one of the four proteins according to an exemplary method as disclosed herein. Three of the four proteins carried out an enzymatic function (geneA, geneB and geneC) and one had a transport function (geneD).

### Variant Identification

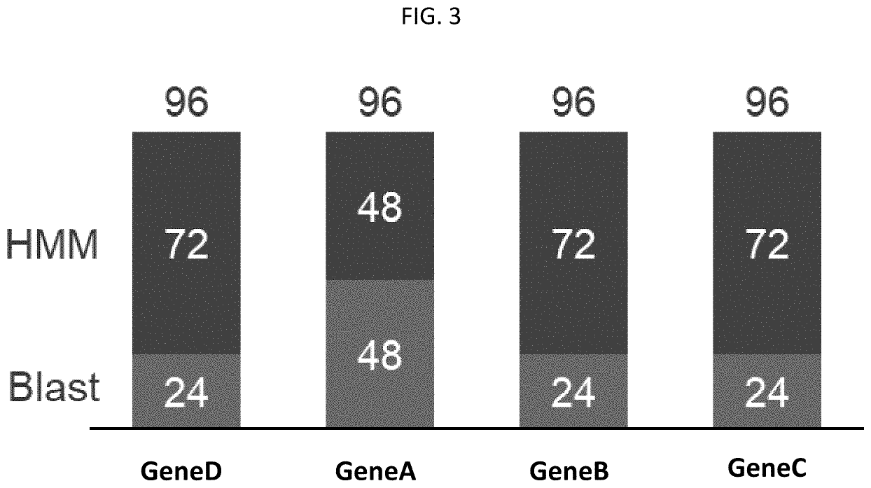

To test the efficacy of the novel methods disclosed herein, protein variants predicted to perform the same function as the target proteins were identified from a metagenomics library in two different ways: via traditional BLAST searching and via the searching methods disclosed herein employing HMMs. The query type and number of candidates selected is shown in Table 5 below and illustrated in FIG. 3.

TABLE 5
Overview of query method and candidate sequence selection.

| | Query Method Count | | | Total |
|---|---|---|---|---|
| Gene | BLAST | | HMM | Variants |
| geneA | 24 (hits): | 24: optimized | 48: native geneA | 96 |
| | canonical geneA | geneA | | |

| | | | |
|---|---|---|---|
| geneD | 24: native geneD | 72: native geneD | 96 |
| geneB | 24: native geneB | 24: native geneB | 96 |
| | | (model 1) | |
| | | 24: native geneB | |
| | | (model 2) | |
| | | 24: native geneB | |
| | | (model 3) | |
| geneC | 24: native geneC | 72: native geneC | 96 |

As shown in Table 5, for the BLAST search, native host strain sequences were generally employed as queries to find the 24 closest (non-identical) candidate sequences in the metagenomics library. In the case of the geneA candidates, 24 were identified using a canonical geneA sequence and another 24 were identified using the best metagenomics library-derived geneA from prior efforts.

Generally, a single HMM was employed for each enzymatic function to select 48 (for geneA) or 72 (for geneD and geneC) candidate sequences. For the geneB candidates, three orthology groups were available to produce 3 machine learning models, which were each used to identify 24 candidate sequences.

### HMM Generation

6 HMMs were employed in this example: geneA.hmm (geneA), geneC.hmm (geneC), geneD.hmm (geneD), geneB1.hmm (geneB), geneB2.hmm (geneB), and geneB3.hmm (geneB). These HMM models were generated based on the training sequence data described above, including KEGG orthology groups available at the time. Prokaryotic and eukaryotic sequences were separated and separate HMMs were created for them; in this instance, the HMMs were trained only on sequences derived from prokaryotes.

### Pruning Hits

To further increase the confidence that candidate sequences have the desired function, candidate sequences were removed based on the relative likelihood of performing another function within a given confidence interval. This filtering was based on screening with a large database of over 10,000 “control” HMMs that represented a full set of metabolism-related KEGG orthology groups. For each of the sequences, the e-value of the best match from the HMM database was recorded (also referred to in other sections of this disclosure as the “second predictive machine learning model”). The e-value calculated from the target protein HMM was compared to the e-value of the best match HMM and candidate sequences were kept only if they satisfied the following requirement: log(target HMM e-value)/log(top hit HMM e-value) >0.8, wherein the target HMM e-value was also included amongst the pool of e-values for the selection of the top hit HMM e-value pool, such that the maximum value was 1.0. This pruning step allowed for the selection of only those candidate sequences for which the function of the target protein was the best match or near-best within the preselected threshold value of greater than 0.8.

Clustering and Selection for In Vitro Testing

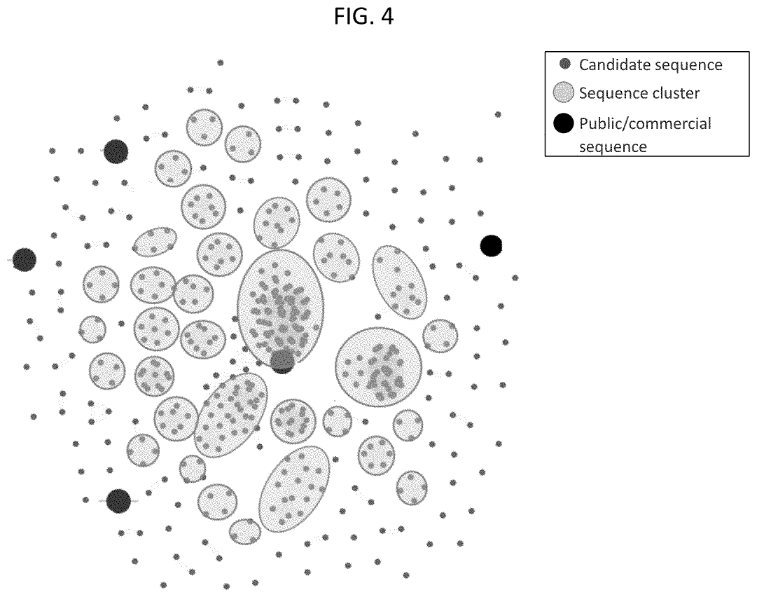

Given a large database, it is typical to find a great diversity of candidate sequences for ubiquitous metabolic enzymes such as geneA, geneB and geneC. In the present example, the number of identified candidate sequences was very large and would have required significant resources and time to test in vitro. To limit the number of sequences that needed to be tested, sequences that shared more than 50% sequence identity were grouped into clusters using a CD-HIT algorithm, e.g., as illustrated in FIG. 4. This allowed for the selection of a more diverse set of sequences to test by assuring that none of the selected sequences were highly similar. From each cluster, at most 1 candidate sequence was selected for testing.

After clustering, candidate sequences were ranked by ascending e-value, a value which gives a quantitative measure of confidence that a given sequence has the function an HMM represents. Ranking the sequences placed the highest confidence matches at the top, and from this set of sequences, the top 24, 48, or 72 candidates were chosen such that the lowest e-value candidates were selected but no more than one candidate sequence was selected from a cluster.

### In Vitro Testing

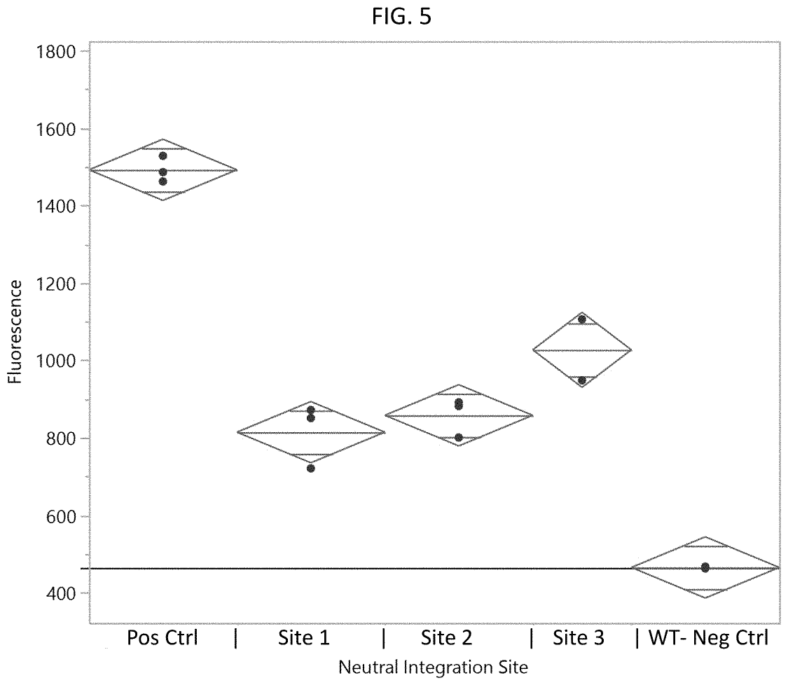

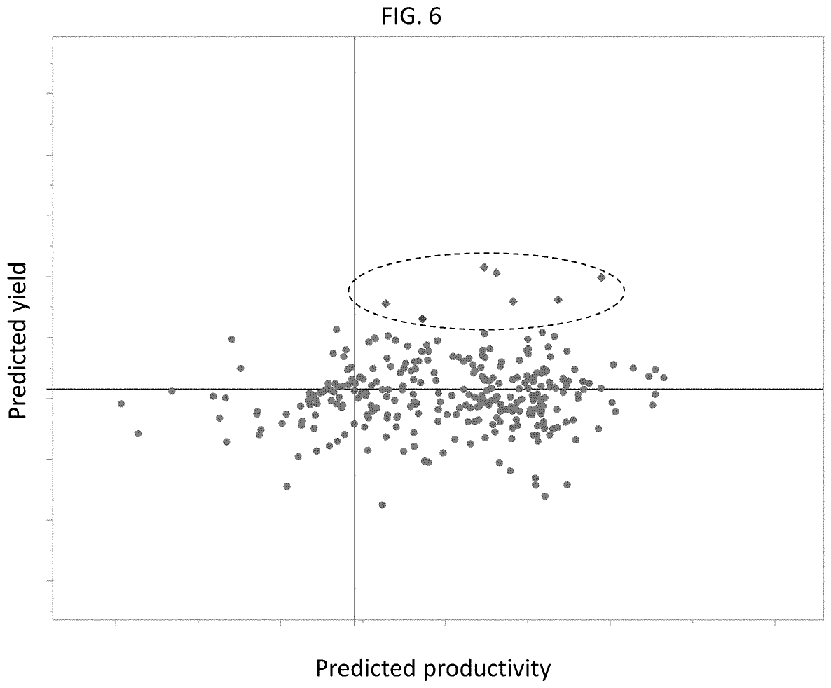

Genes corresponding to the selected candidate sequences were inserted into the host strain genome at neutral integration sites, for which RFP gene insertion was confirmed to produce acceptable expression levels as shown in FIG. 5. The productivity and yield of the transformed cells was measured in a high throughput screen (HTS). Seven leads that showed yield improvement and no decrease in productivity in the HTS were selected as hits, as shown in FIG. 6. The HTS results are shown in Table 6.

TABLE 6
Initial yield and productivity results from HTS.

| Edit | ΔYield (%) | ΔProd (%) |
|---|---|---|
| geneB_1975 | 3.5 | 0.4 |
| geneC_1048 | 3.3 | 0.8 |
| geneD_1446 | 3.2 | 4.8 |
| geneD_0481 | 2.6 | 3.1 |
| geneB_1977 | 2.5 | 1.5 |
| geneC_1042 | 2.2 | 1.0 |
| geneC_2000 | 1.8 | 2.4 |

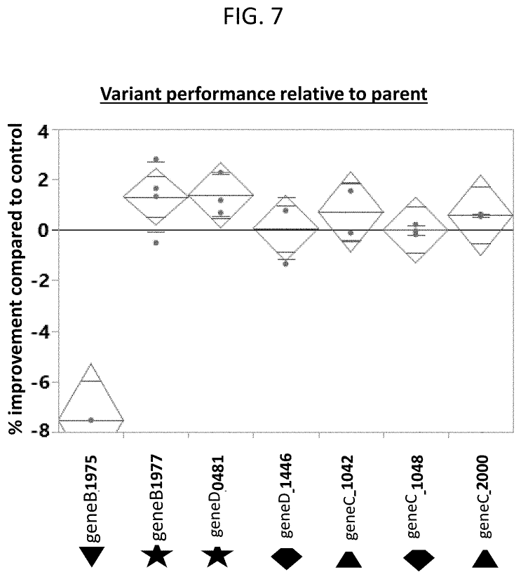

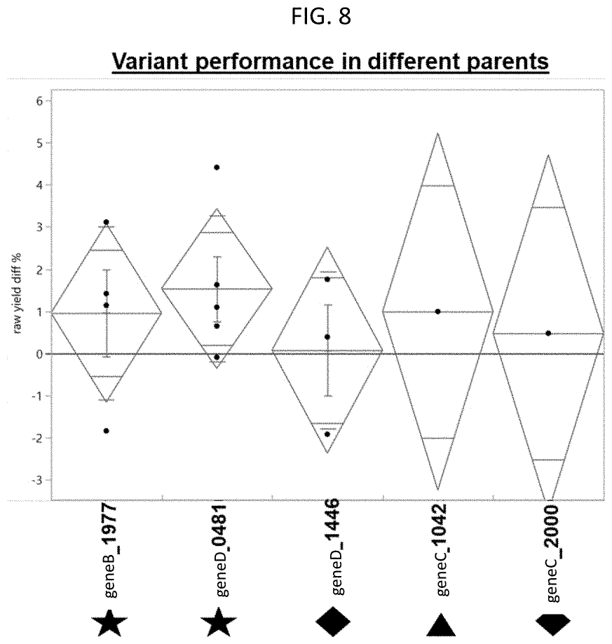

These lead sequences were then individually tested for percent change in yield of the target molecule of interest, as demonstrated in FIG. 7. Two of these hits were confirmed to increase yield in the host strain by greater than 1%: geneD_0481 and geneB_1977. The candidate sequences were then verified across multiple parent backgrounds, as shown in FIG. 8. The top two hits maintained ˜1% yield improvement on more than three different genetic backgrounds.

### Verification of Protein Variant Function

In a further experiment, the function of the selected candidate sequences is verified by deletion of the native target gene sequences. The ability of the candidate sequences to perform the same function as the native sequence is then observed.

### Results

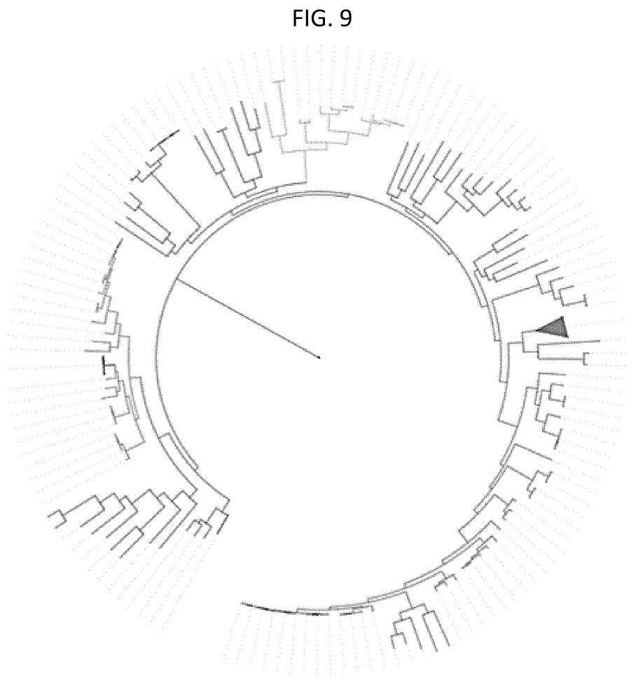

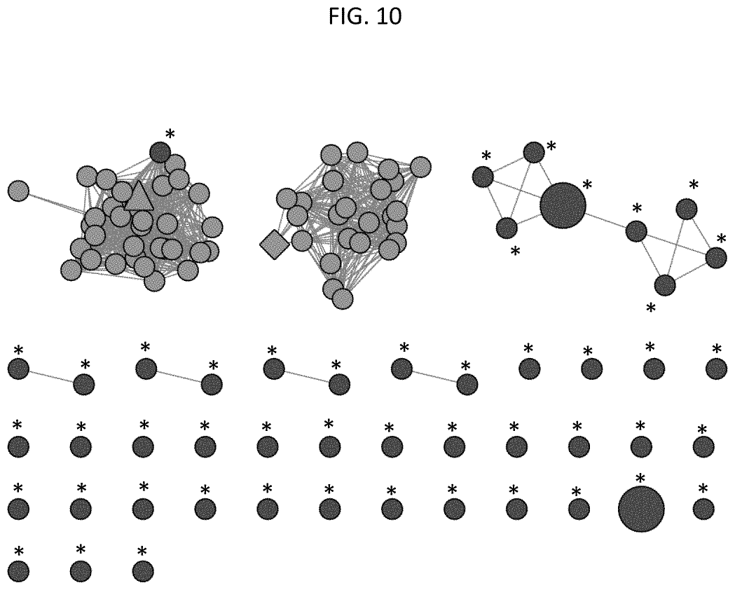

The search method of the present disclosure, in this instance utilizing HMMs, outperformed the BLAST search method in identifying protein variants that improved the phenotypic performance of the host cell: all seven hits shown in Table 6 were identified by the HMM search, rather than the BLAST search. Furthermore, the present methods identified hits that were genetically dissimilar to the native host strain proteins, as visually demonstrated in the phylogenetic tree shown in FIG. 9. Similarly, FIG. 10 demonstrates the sequence similarity of the geneB candidate sequences identified by BLAST and the sequence dissimilarity of the geneB candidate sequences identified by the HMMs. In this figure, the BLAST results in green are highly clustered, as indicated by the lines connecting the nodes, whereas the HMM results are dissimilar, as indicated by the many results that share less than 50% sequence homology with one another. In addition, FIG. 10 shows that both of the top geneB hits, indicated by larger circles, were identified with the HMM, rather than with BLAST. The top geneB hits were selected from the same one of the 3 HMMs used to identify candidate sequences. This HMM corresponded to one of the KEGG orthology groups, to which the native geneB of the host strain did not belong. This genetic dissimilarity is further substantiated by the very low amino acid percent sequence identity (see Table 7) and low amino acid sequence similarity (see Table 8), as calculated using the BLOSUM45 similarity matrix with a threshold of 0. These two geneB hits were confirmed to improve the yield of the desired target molecule across multiple parent backgrounds.

These results demonstrate that the present methods may be used to identify highly dissimilar (and, consequently, non-homologous) sequences, which likely perform the same function as a target protein and improve the host cell phenotype of interest.

TABLE 7
Percent identity of lead sequences
versus native host strain sequences

| | geneB native sequence identity |
|---|---|
| geneB native sequence | X |
| geneB_1975 | 14% |
| geneB_1977 | 12% |
| | geneD native sequence identity |
| geneD native sequence | X |
| geneD_0481 | 32% |
| geneD_1446 | 28% |
| | geneC native sequence identity |
| geneC native sequence | X |
| geneC_1042 | 56% |
| geneC_1048 | 22% |
| geneC_2000 | 20% |

TABLE 8
Percent sequence similarity of lead sequences
versus native host strain sequences

| | geneB native sequence similarity |
|---|---|
| geneB native sequence | X |
| geneB_1975 | 43% |
| geneB_1977 | 41% |
| | geneD native sequence similarity |
| geneD native sequence | X |
| geneD_0481 | 62% |
| geneD_1446 | 58% |
| | geneC native sequence similarity |
| geneC native sequence | X |
| geneC_1042 | 78% |
| geneC_1048 | 37% |
| geneC_2000 | 33% |

### Example 2: Use of the Present Methods in Alternative Metagenomic Libraries

Test predictive models in additional metagenomic libraries—Predictive models of the present disclosure are validated in more than one library to test species within the metagenomic library genus. In another assay, common structural features of metagenomic libraries are identified that give rise to the functional utility of the HMM tool/metagenomic libraries methods of the invention.

Results demonstrate that the HMM tool can identify distant orthologs and/or functionally improved variants of target proteins/genes in different metagenomic libraries. Any identified common features of tested metagenomic libraries are used to establish relationships between structure and function of the databases (e.g., read length, diversity in pool of candidate genes).

### Example 3: Comparison of Metagenomics Database and Publicly Available Sequence Database

Results from the disclosed predictive machine learning models run on a metagenomics database and a public database are quantitatively compared. In addition to showing that the predictive machine learning tools herein can identify distantly related and/or functionally improved orthologs of target proteins/genes, comparisons are generated to show that the results from a metagenomic database are superior to those of a public non-metagenomics database.

Exemplary metagenomic databases are shown to produce greater number of validated candidates (i.e., less false positives), the most sequence diversity among results, and/or lower sequence identity while maintaining functionality.

### Example 4: Use of an Iterative Predictive Model Method

Iterative predictive machine learning model, e.g., HMM. In this example, the results from a first HMM prediction/validation are added back to the training data set before a second iteration is performed. Results of second and subsequent iterations identify candidate sequences with increasing confidence and/or identify candidate sequences with less sequence identity to the target protein/gene or proteins/genes of the initial training data set.

### Numbered Embodiments of the Invention

Notwithstanding the claims provided herein, the following embodiments are contemplated according to the present disclosure.
1. A method of identifying distantly related orthologs of a target protein, said method comprising the steps of:
   a) accessing a training data set comprising a genetic sequence input variable and a phenotypic performance output variable;
      i) wherein the genetic sequence input variable comprises one or more amino acid sequences of proteins capable of performing the same function as the target protein, and
      ii) wherein the phenotypic performance output variable comprises one or more phenotypic performance features that are associated with the one or more amino acid sequences;
   b) developing a first predictive machine learning model that is populated with the training data set;
   c) applying, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model;
   d) removing from the pool of candidate sequences any sequence that is predicted to perform a different function than the target protein function by a second predictive machine learning model with a second confidence score if the ratio of the first confidence score to the second confidence score falls beyond a preselected threshold, thereby producing a filtered pool of candidate sequences;
   e) clustering the pool of candidate sequences or the filtered pool of candidate sequences after step (d) and selecting a subset of representative candidate sequences comprising one or more candidate sequences from one or more clusters;
   f) manufacturing one or more host cells to each express a sequence from amongst the representative candidate sequences from step (e);
   g) measuring the phenotypic performance of the manufactured host cell(s) of step (f), and
   h) selecting a candidate sequence capable of performing the same function as the target protein, based on the phenotypic performance of the manufactured host cell expressing said candidate sequence, thereby identifying a distantly related ortholog of the target protein.
2. A method of identifying distantly related orthologs of a target protein, said method comprising the steps of:
   a) accessing a training data set comprising a genetic sequence input variable and a phenotypic performance output variable;
      i) wherein the genetic sequence input variable comprises one or more amino acid sequences of proteins capable of performing the same function as the target protein, and
      ii) wherein the phenotypic performance output variable comprises one or more phenotypic performance features that are associated with the one or more amino acid sequences;
   b) developing a first predictive machine learning model that is populated with the training data set;
   c) applying, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model;
   d) removing from the pool of candidate sequences any sequence that is predicted to perform a different function than the target protein function by a second predictive machine learning model with a second confidence score if the ratio of the first confidence score to the second confidence score falls beyond a preselected threshold, thereby producing a filtered pool of candidate sequences;
   e) optionally clustering the pool of candidate sequences or the filtered pool of candidate sequences after step (d) and selecting a subset of representative candidate sequences comprising one or more candidate sequences from one or more clusters, thereby identifying distantly related orthologs of the target protein.
3. The method of embodiment 1 or 2, wherein the metagenomic database comprises amino acid sequences from at least one uncultured microorganism.
4. The method of any one of embodiments 1-3, wherein step (d) comprises analyzing candidate sequences by a plurality of predictive machine learning models to produce a corresponding plurality of control confidence scores.
5. The method of embodiment 4, wherein the best score among the control confidence scores is the second confidence score for purposes of calculating the ratio of the first confidence score to the second confidence score.
6. The method of any one of embodiments 1-5, wherein the confidence score is a bit score or is the log₁₀(e-value).
7. The method of embodiment 6, wherein candidate sequences are removed if the ratio of the first confidence score to the second confidence score is less than 0.7, 0.8, or 0.9.
8. The method of any one of embodiments 1-7 wherein candidate sequences are removed if they are more likely to perform a different function than the target protein function, as predicted by the second predictive machine learning model.
9. The method of any one of embodiments 1-8, wherein the clustering of step (e) is based on sequence similarities between candidate sequences.
10. The method of any one of embodiments 1 and 3-9, further comprising adding to the training data set of step (a):
   i) at least one of the candidate sequence(s) that were expressed in the host cell(s) of step (f), and
   ii) the phenotypic performance measurement(s) corresponding to the at least one candidate sequence of (i), as measured in step (g), thereby creating an updated training data set.
11. The method of embodiment 10, wherein the following step occurs before step (h):
   repeating steps (a)-(g) with the updated training data set.
12. The method of any one of embodiments 1-11, wherein the metagenomic library of step (c), comprises amino acid sequences from at least one organism that is different from the organism from where the target protein was originally obtained.
13. The method of any one of embodiments 1 and 3-12, wherein the manufacturing of step (f) comprises: replacing an endogenous protein-encoding gene in a host cell, wherein said endogenous protein-coding gene is known to perform the same function as the target protein.
14. The method of embodiment 13, wherein the endogenous protein-coding gene encodes for the target protein.
15. The method of any one of embodiments 1, and 3-14, wherein the manufacturing of step (f) comprises manufacturing the cells to comprise at least two sequences from amongst the representative candidate sequences from step (e).
16. The method of any one of embodiments 1-15, wherein the distantly related ortholog shares less than 90%, 80%, 70%, 60% 50%, 40%, 30%, or 20% sequence identity with the amino acid sequence of the target protein.
17. The method of any one of embodiments 1 and 3-16, wherein the manufactured host cell expressing the selected candidate sequence exhibits improved phenotypic performance compared to a control host cell expressing the target protein.
18. The method of embodiment 17, wherein the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.
19. The method of embodiment 18, wherein the stress factor is selected from pH, temperature, osmotic pressure, substrate concentration, product concentration, and byproduct concentration.
20. The method of any one of embodiments 17-19, wherein the manufactured host cell expressing the selected candidate sequence exhibits at least a 10%, 20%, 30%, 40%, 50%, 60%, 70%, 80%, 90%, or 100% improved phenotypic performance.
21. The method of any one of embodiments 1-20, wherein the training data set comprises amino acid sequences of proteins that have either been:
   i) empirically shown to perform the same function as the target protein; or
   ii) predicted with a high degree of confidence through other mechanisms to perform the same function as the target protein.
22. The method of any one of embodiments 1-21, wherein the first predictive machine learning model and/or the second predictive machine learning model is a hidden Markov model (HMM).
23. A method of identifying a candidate amino acid sequence for enabling a desired function in a host cell, said method comprising the steps of:
   a) accessing a training data set comprising a genetic sequence input variable and a phenotypic performance output variable;
      i) wherein the genetic sequence input variable comprises one or more amino acid sequences of proteins capable of enabling the desired function in at least one organism, and
      ii) wherein the phenotypic performance output variable comprises one or more phenotypic performance features that are associated with the one or more amino acid sequences;
   b) developing a first predictive machine learning model that is populated with the training data set;
   c) applying, using a computer processor, the first predictive machine learning model to a metagenomic library containing amino acid sequences from one or more organisms to identify a pool of candidate sequences within the library, wherein said candidate sequences are predicted with respective first confidence scores to enable the desired function by the first predictive machine learning model;
   d) removing from the pool of candidate sequences, any sequence that is predicted to perform a different function than the desired function by a second predictive machine learning model with a second confidence score if the ratio of the first confidence score to the second confidence score falls beyond a preselected threshold, thereby producing a filtered pool of candidate sequences;
   e) clustering the pool of candidate sequences or the filtered pool of candidate sequences after step (d) and selecting a subset of representative candidate sequences comprising one or more candidate sequences from one or more clusters;
   f) manufacturing one or more host cells to each express a sequence from amongst the representative candidate sequences from step (e);
   g) measuring the phenotypic performance of the manufactured host cell(s) of step (f), and
   h) selecting a candidate sequence capable of performing the desired function, based on the phenotypic performance of the manufactured host cell expressing said candidate sequence, thereby identifying the candidate amino acid sequence for enabling the desired function.
24. A method of identifying a candidate amino acid sequence for enabling a desired function in a host cell, said method comprising the steps of:
   a) accessing a training data set comprising a genetic sequence input variable and a phenotypic performance output variable;
      i) wherein the genetic sequence input variable comprises one or more amino acid sequences of proteins capable of enabling the desired function in at least one organism, and
      ii) wherein the phenotypic performance output variable comprises one or more phenotypic performance features that are associated with the one or more amino acid sequences;
   b) developing a first predictive machine learning model that is populated with the training data set;
   c) applying, using a computer processor, the first predictive machine learning model to a metagenomic library containing amino acid sequences from one or more organisms to identify a pool of candidate sequences within the library, wherein said candidate sequences are predicted with respective first confidence scores to enable the desired function by the first predictive machine learning model;
   d) removing from the pool of candidate sequences, any sequence that is predicted to perform a different function than the desired function by a second predictive machine learning model with a second confidence score if the ratio of the first confidence score to the second confidence score falls beyond a preselected threshold, thereby producing a filtered pool of candidate sequences;
   e) optionally clustering the pool of candidate sequences or the filtered pool of candidate sequences after step (d) and selecting a subset of representative candidate sequences comprising one or more candidate sequences from one or more clusters, thereby identifying the candidate amino acid sequence for enabling a desired function.
25. The method of embodiment 23 or 24, wherein the metagenomic library of step (c), comprises amino acid sequences from at least one uncultured microorganism.
26. The method of any one of embodiments 23-25, wherein step (d) comprises analyzing candidate sequences by a plurality of predictive machine learning models to produce a corresponding plurality of control confidence scores.
27. The method of embodiment 26, wherein the best score among the control confidence scores is the second confidence score for purposes of calculating the ratio of the first confidence score to the second confidence score.
28. The method of any one of embodiments 23-27, wherein the confidence score is a bit score or is the log₁₀(e-value).
29. The method of embodiment 28, wherein candidate sequences are removed if the ratio of the first confidence score to the second confidence score is less than 0.7, 0.8, or 0.9.
30. The method of any one of embodiments 23-29, wherein candidate sequences are removed if they are more likely to perform a different function than the target protein function, as predicted by the second predictive machine learning model.
31. The method of any one of embodiments 23-30, wherein the clustering of step (e) is based on sequence similarities between candidate sequences.
32. The method of any one of embodiments 23 and 25-31, further comprising adding to the training data set of step (a):
   i) at least one of the candidate sequence(s) that were expressed in the host cell(s) of step (f), and
   ii) the phenotypic performance measurement(s) corresponding to the at least one candidate sequence of (i), as measured in step (g), thereby creating an updated training data set.
33. The method of embodiment 32, wherein the following step occurs before step (h): repeating steps (a)-(g) with the updated training data set.
34. The method of any one of embodiments 23-33, wherein the metagenomic library of step (c) comprises amino acid sequences from at least one organism that has no sequences derived from it in the training data set.
35. The method of any one of embodiments 23 and 25-34, wherein the manufacturing of step (f) comprises: replacing an endogenous protein-encoding gene in a host cell, wherein said endogenous protein-coding gene is known to enable the desired function.
36. The method of embodiment 35, wherein the endogenous protein-coding gene is comprised in the training data set.
37. The method of any one of embodiments 23 and 25-36, wherein the manufacturing of step (f) comprises manufacturing the cells to express at least two sequences from amongst the representative candidate sequences from step (e).
38. The method of any one of embodiments 23 and 25-37, wherein the candidate sequence selected in step (h) shares less than 90%, 80%, 70%, 60% 50%, 40%, 30%, or 20% sequence identity with any amino acid sequence in the training data set.
39. The method of any one of embodiments 23 and 25-38, wherein the manufactured host cell expressing the selected candidate sequence exhibits improved phenotypic performance compared to a control host cell expressing any amino acid sequence from the training data set.
40. The method of embodiment 39, wherein the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.
41. The method of embodiment 40, wherein the stress factor is selected from pH, temperature, osmotic pressure, substrate concentration, product concentration, and byproduct concentration.
42. The method of any one of embodiments 39-41, wherein the manufactured host cell expressing the selected candidate sequence exhibits at least a 10%, 20%, 30%, 40%, 50%, 60%, 70%, 80%, 90%, or 100% improved phenotypic performance.
43. The method of any one of embodiments 23-42, wherein the training data set comprises amino acid sequences of proteins that have either been:
   i) empirically shown to enable the desired function as the target protein; or
   ii) predicted with a high degree of confidence through other mechanisms to perform the desired function.
44. The method of any one of embodiments 23-43, wherein the first predictive machine learning model and/or the second predictive machine learning model is a hidden Markov model (HMM).
45. A system for identifying a candidate amino acid sequence for enabling a desired function in a host cell, the system comprising:
   one or more processors; and
   one or more memories storing instructions, that when executed by at least one of the one of more processors, cause the system to:
   a) access a training data set comprising a genetic sequence input variable and a phenotypic performance output variable;
      i) wherein the genetic sequence input variable comprises one or more amino acid sequences of proteins capable of enabling the desired function in at least one organism, and
      ii) wherein the phenotypic performance output variable comprises one or more phenotypic performance features that are associated with the one or more amino acid sequences;
   b) develop a first predictive machine learning model that is populated with the training data set;
   c) apply the first predictive machine learning model to a metagenomic library containing amino acid sequences from one or more organisms to identify a pool of candidate sequences within the library, wherein said candidate sequences are predicted with respective first confidence scores to enable the desired function by the first predictive machine learning model;
   d) remove from the pool of candidate sequences, any sequence that is predicted to perform a different function than the desired function by a second predictive machine learning model with a second confidence score if the ratio of the first confidence score to the second confidence score falls beyond a preselected threshold, thereby producing a filtered pool of candidate sequences;
   e) cluster the pool of candidate sequences or the filtered pool of candidate sequences after step (d) and selecting a subset of representative candidate sequences comprising one or more candidate sequences from one or more clusters;
   f) manufacture one or more host cells to each express a sequence from amongst the representative candidate sequences from step (e);
   g) measure the phenotypic performance of the manufactured host cell(s) of step (f), and
   h) select a candidate sequence capable of performing the desired function, based on the phenotypic performance of the manufactured host cell expressing said candidate sequence, thereby identifying the candidate amino acid sequence for enabling the desired function.
46. The system of embodiment 45, wherein the metagenomic library comprises amino acid sequences from at least one uncultured microorganism.
47. The system of any one of embodiments 45 or 46, wherein step (d) comprises analyzing candidate sequences by a plurality of predictive machine learning models to produce a corresponding plurality of control confidence scores.
48. The system of embodiment 47, wherein the best score among the control confidence scores is the second confidence score for purposes of calculating the ratio of the first confidence score to the second confidence score.
49. The system of any one of embodiments 45-48, wherein the confidence score is a bit score or is the log₁₀(e-value).
50. The system of embodiment 49, wherein candidate sequences are removed if the ratio of the first confidence score to the second confidence score is less than 0.7, 0.8, or 0.9.
51. The system of any one of embodiments 45-50, wherein candidate sequences are removed if they are more likely to perform a different function than the target protein function, as predicted by the second predictive machine learning model.
52. The system of any one of embodiments 45-51, wherein the clustering of step (e) is based on sequence similarities between candidate sequences.
53. The system of any one of embodiments 45-52, wherein the one of more processors, cause the system to further add to the training data set of step (a):
   i) at least one of the candidate sequence(s) that were expressed in the host cell(s) of step (f), and
   ii) the phenotypic performance measurement(s) corresponding to the at least one candidate sequence of (i), as measured in step (g), thereby creating an updated training data set.
54. The system of embodiment 45, wherein the one of more processors, cause the system to carry out the following step occurs before step (h): repeat steps (a)-(g) with the updated training data set.
55. The system of any one of embodiments 45-54, wherein the metagenomic library of step (c) comprises amino acid sequences from at least one organism that has no sequences derived from it in the training data set.
56. The system of any one of embodiments 45-55, wherein the manufacturing of step (f) comprises: replacing an endogenous protein-encoding gene in a host cell, wherein said endogenous protein-coding gene is known to enable the desired function.
57. The system of embodiment 56, wherein the endogenous protein-coding gene is comprised in the training data set.
58. The system of any one of embodiments 45-57, wherein the manufacturing of step (f) comprises manufacturing the cells to express at least two sequences from amongst the representative candidate sequences from step (e).
59. The system of any one of embodiments 45-58, wherein the candidate sequence selected in step (h) shares less than 90%, 80%, 70%, 60% 50%, 40%, 30%, or 20% sequence identity with any amino acid sequence in the training data set.
60. The system of any one of embodiments 45-59, wherein the manufactured host cell expressing the selected candidate sequence exhibits improved phenotypic performance compared to a control host cell expressing any amino acid sequence from the training data set.
61. The system of embodiment 60, wherein the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.
62. The system of embodiment 61, wherein the stress factor is selected from pH, temperature, osmotic pressure, substrate concentration, product concentration, and byproduct concentration.
63. The system of any one of embodiments 60-62, wherein the manufactured host cell expressing the selected candidate sequence exhibits at least a 10%, 20%, 30%, 40%, 50%, 60%, 70%, 80%, 90%, or 100% improved phenotypic performance.
64. The system of any one of embodiments 45-63, wherein the training data set comprises amino acid sequences of proteins that have either been:
   i) empirically shown to enable the desired function as the target protein; or
   ii) predicted with a high degree of confidence through other mechanisms to perform the desired function.
65. The system of any one of embodiments 45-64, wherein the first predictive machine learning model and/or the second predictive machine learning model is a hidden Markov model (HMM).
66. A system for identifying distantly related orthologs of a target protein, said system comprising:
   one or more processors; and
   one or more memories storing instructions, that when executed by at least one of the one of more processors, cause the system to:
   a) access a training data set comprising a genetic sequence input variable and a phenotypic performance output variable;
      i) wherein the genetic sequence input variable comprises one or more amino acid sequences of proteins capable of performing the same function as the target protein, and
      ii) wherein the phenotypic performance output variable comprises one or more phenotypic performance features that are associated with the one or more amino acid sequences;
   b) develop a first predictive machine learning model that is populated with the training data set;
   c) apply, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model;
   d) remove from the pool of candidate sequences, any sequence that is predicted to perform a different function than the target protein function by a second predictive machine learning model with a second confidence score if the ratio of the first confidence score to the second confidence score falls beyond a preselected threshold, thereby producing a filtered pool of candidate sequences;
   e) cluster the pool of candidate sequences or the filtered pool of candidate sequences after step (d) and selecting a subset of representative candidate sequences comprising one or more candidate sequences from one or more clusters;
   f) manufacture one or more host cells to each express a sequence from amongst the representative candidate sequences from step (e);
   g) measure the phenotypic performance of the manufactured host cell(s) of step (f), and
   h) select a candidate sequence capable of performing the same function as the target protein, based on the phenotypic performance of the manufactured host cell expressing said candidate sequence, thereby identifying a distantly related ortholog of the target protein.
67. The system of embodiment 66, wherein the metagenomic library comprises amino acid sequences from at least one uncultured microorganism.
68. The system of embodiment 66 or 67 , wherein step (d) comprises analyzing candidate sequences by a plurality of predictive machine learning models to produce a corresponding plurality of control confidence scores.
69. The system of embodiment 68, wherein the best score among the control confidence scores is the second confidence score for purposes of calculating the ratio of the first confidence score to the second confidence score.
70. The system of any one of embodiments 66-69, wherein the confidence score is a bit score or is the log₁₀(e-value).
71. The system of embodiment 70, wherein candidate sequences are removed if the ratio of the first confidence score to the second confidence score is less than 0.7, 0.8, or 0.9.
72. The system of any one of embodiments 66-71, wherein candidate sequences are removed if they are more likely to perform a different function than the target protein function, as predicted by the second predictive machine learning model.
73. The system of any one of embodiments 66-72, wherein the clustering of step (e) is based on sequence similarities between candidate sequences.
74. The system of any one of embodiments 66-73, wherein the one of more processors, cause the system to further add to the training data set of step (a):
   i) at least one of the candidate sequence(s) that were expressed in the host cell(s) of step (f), and
   ii) the phenotypic performance measurement(s) corresponding to the at least one candidate sequence of (i), as measured in step (g), thereby creating an updated training data set.
75. The system of embodiment 74, wherein the one of more processors, cause the system to carry out the following step occurs before step (h): repeat steps (a)-(g) with the updated training data set.
76. The system of any one of embodiments 66-75, wherein the metagenomic library of step (c) comprises amino acid sequences from at least one organism that is different from the organism from where the target protein was originally obtained.
77. The system of any one of embodiments 66-76, wherein the manufacturing of step (f) comprises: replacing an endogenous protein-encoding gene in a host cell, wherein said endogenous protein-coding gene is known to perform the same function as the target protein.
78. The system of embodiment 77, wherein the endogenous protein-coding gene encodes for the target protein.
79. The system of any one of embodiments 66-78, wherein the manufacturing of step (f) comprises manufacturing the cells to express at least two sequences from amongst the representative candidate sequences from step (e).
80. The system of any one of embodiments 66-79, wherein the distantly related ortholog shares less than 90%, 80%, 70%, 60% 50%, 40%, 30%, or 20% sequence identity with the amino acid sequence of the target protein.
81. The system of any one of embodiments 66-80, wherein the manufactured host cell expressing the selected candidate sequence exhibits improved phenotypic performance compared to a control host cell expressing the target protein.
82. The system of embodiment 81, wherein the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.
83. The system of embodiment 82, wherein the stress factor is selected from pH, temperature, osmotic pressure, substrate concentration, product concentration, and byproduct concentration.
84. The system of any one of embodiments 81-83, wherein the manufactured host cell expressing the selected candidate sequence exhibits at least a 10%, 20%, 30%, 40%, 50%, 60%, 70%, 80%, 90%, or 100% improved phenotypic performance.
85. The system of any one of embodiments 66-84, wherein the training data set comprises amino acid sequences of proteins that have either been:
   i) empirically shown to perform the same function as the target protein; or
   ii) predicted with a high degree of confidence through other mechanisms to perform the same function as the target protein.
86. The system of any one of embodiments 66-85, wherein the first predictive machine learning model and/or the second predictive machine learning model is a hidden Markov model (HMM).

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as, an acknowledgement or any form of suggestion that they constitute valid prior art or form part of the common general knowledge in any country in the world, or that they disclose essential matter.

1. A method of identifying distantly related orthologs of a target protein, said method comprising the steps of:
a) accessing a training data set comprising a genetic sequence input variable and a phenotypic performance output variable;
i) wherein the genetic sequence input variable comprises one or more amino acid sequences of proteins capable of performing the same function as the target protein, and
ii) wherein the phenotypic performance output variable comprises one or more phenotypic performance features that are associated with the one or more amino acid sequences;
b) developing a first predictive machine learning model that is populated with the training data set;
c) applying, using a computer processor, the first predictive machine learning model to a metagenomic library containing amino acid sequences from one or more organisms to identify a pool of candidate sequences within the library, wherein said candidate sequences are predicted with respective first confidence scores to perform the same function as the target protein by the first predictive machine learning model,
thereby identifying distantly related orthologs of the target protein.

3. The method of claim 1, wherein the method further comprises the following step:
d) removing from the pool of candidate sequences any sequence that is predicted to perform a different function than the target protein function by a second predictive machine learning model with a second confidence score if the ratio of the first confidence score to the second confidence score falls beyond a preselected threshold, thereby producing a filtered pool of candidate sequences.

4. The method of claim 1, wherein the method further comprises the following step:
d) clustering the pool of candidate sequences and selecting a subset of representative candidate sequences comprising one or more candidate sequences from one or more clusters.

5. The method of claim 1, wherein the method further comprises the following step:
d) manufacturing one or more host cells to each express a sequence from amongst the candidate sequences from step (c).

6. The method of claim 5, wherein the method further comprises the following step:
e) measuring the phenotypic performance of the manufactured host cell(s) of step (d).

7. The method of claim 6, wherein the method further comprises the following step:
f) selecting a candidate sequence capable of performing the same function as the target protein, based on the phenotypic performance of the manufactured host cell expressing said candidate sequence measured in step (e).

8. The method of claim 1, wherein the metagenomic library comprises amino acid sequences from at least one uncultured microorganism.

9. The method of claim 1, wherein a majority of the assembled sequences in the library are from uncultured microorganisms.

10. The method of claim 1, wherein substantially all of the sequences in the library are from uncultured microorganisms.

11. The method of claim 3, wherein step (d) comprises analyzing candidate sequences by a plurality of predictive machine learning models to produce a corresponding plurality of control confidence scores.

12. The method of claim 11, wherein the best score among the control confidence scores is the second confidence score for purposes of calculating the ratio of the first confidence score to the second confidence score.

13. The method of claim 3, wherein the confidence score is a bit score or is the log₁₀(e-value).

14. The method of claim 13, wherein candidate sequences are removed if the ratio of the first confidence score to the second confidence score is less than 0.7, 0.8, or 0.9.

15. The method of claim 3, wherein candidate sequences are removed if they are more likely to perform a different function than the target protein function, as predicted by the second predictive machine learning model.

16. The method of claim 4, wherein the clustering of step (d) is based on sequence similarities between candidate sequences.

17. The method of claim 7, further comprising adding to the training data set of step (a):
i) at least one of the candidate sequence(s) that were expressed in the host cell(s) of step (d), and
ii) the phenotypic performance measurement(s) corresponding to the at least one candidate sequence of (i), as measured in step (e), thereby creating an updated training data set.

18. The method of claim 17, wherein the following step occurs before step (f):
repeating steps (a)-(e) with the updated training data set.

19. The method of claim 1, wherein the metagenomic library of step (c) comprises amino acid sequences from at least one organism that is different from the organism from where the target protein was originally obtained.

20. The method of claim 5, wherein the manufacturing of step (d) comprises: replacing an endogenous protein-encoding gene in a host cell, wherein said endogenous protein-coding gene is known to perform the same function as the target protein.

21. The method of claim 20, wherein the endogenous protein-coding gene encodes for the target protein.

22. The method of claim 5, wherein the manufacturing of step (d) comprises manufacturing the cells to comprise a plurality of sequences from amongst the candidate sequences from step (c).

23. The method of claim 1, wherein the distantly related ortholog shares less than 90%, 80%, 70%, 60% 50%, 40%, 30%, or 20% sequence identity with the amino acid sequence of the target protein.

24. The method of claim 7, wherein the manufactured host cell expressing the selected candidate sequence exhibits improved phenotypic performance compared to a control host cell expressing the target protein.

25. The method of claim 24, wherein the improved phenotypic performance is selected from the group consisting of yield of a product of interest, titer of a product of interest, productivity of a product of interest, increased tolerance to a stress factor, ability to import or export molecules(s) of interest across biological membranes, ability to carry higher metabolic flux towards desired metabolites, and combinations thereof.

26. The method of claim 24, wherein the manufactured host cell expressing the selected candidate sequence exhibits at least a 10%, 20%, 30%, 40%, 50%, 60%, 70%, 80%, 90%, or 100% improved phenotypic performance.

27. The method of claim 1, wherein the training data set comprises amino acid sequences of proteins that have either been:
i) empirically shown to perform the same function as the target protein; or
ii) predicted with a high degree of confidence through other mechanisms to perform the same function as the target protein.

28. The method of claim 1, wherein the first predictive machine learning model is a hidden Markov model (HMM).

29. The method of claim 3, wherein the second predictive machine learning model is a hidden Markov model (HMM).
